(19) United States
(12) Patent Application Publication
(10) Pub. No.: US 2024/0408494 A1
(43) Pub. Date: Dec. 12, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Yuki Nishi, Tokyo (JP); Masato Nishi, Tokyo (JP); Mamoru Takahashi, Tokyo (JP)

(73) Assignee: CYGAMES, INC., Tokyo (JP)

(21) Appl. No.: 18/809,953

(22) Filed: Aug. 20, 2024

Related U.S. Application Data
(63) Continuation of application No. PCT/JP2023/005482, filed on Feb. 16, 2023.

(30) Foreign Application Priority Data
Feb. 22, 2022 (JP) 2022-025478

(51) Int. Cl. A63F 13/58; A63F 13/825

(52) U.S. Cl. CPC A63F 13/58; A63F 13/825

(57) ABSTRACT

A non-transitory computer readable medium stores a program for causing a computer to execute: a process for setting, as a character to be nurtured, a character selected by a player from among at least one character tied to ability information that can be earned by consuming points and initial-consumption-point information indicating a consumption value of the points for earning the ability information; a process for executing a nurturing game, including a process for changing a parameter of the character to be nurtured, a process for granting the points, and a process for allowing earning of the ability information by consuming the granted points on the basis of the initial-consumption-point information; and a process for updating the initial-consumption-point information when a specific condition is satisfied outside the nurturing game so that the consumption value needed to earn the ability information is smaller than before the specific condition is satisfied.

### CROSS REFERENCE TO RELATED APPLICATIONS

This application is a continuation application of International Application No. PCT/JP2023/005482, filed on Feb. 16, 2023, which claims priority to Japanese Patent Application No. 2022-025478, filed on Feb. 22, 2022, the entire contents of which are incorporated by reference herein.

### BACKGROUND ART

### Technical Field

The present invention relates to an information processing program, an information processing method, and an information processing system.

As indicated in, for example, Patent Literature 1, there are well-known nurturing games in which players nurture characters. In the nurturing game indicated in Patent Literature 1, a character to be nurtured, which is a subject in the nurturing game, can earn “knacks” tied to the character to be nurtured.

### CITATION LIST

### Patent Literature

Patent Literature 1: JP 2021-121396 A

### SUMMARY OF INVENTION

### Technical Problem

An object of such a nurturing game is to create a character of higher ability by repeatedly nurturing a character to be nurtured. However, merely repeating a nurturing game can make not much difference in the ability of created characters, discouraging players from playing games.

An object of the present invention is to provide an information processing program, an information processing method, and an information processing system capable of further motivating a player to play a game.

### Solution to Problem

In order to solve the aforementioned problem, an information processing program causes a computer to execute:
a process for setting, as a character to be nurtured, a character selected by a player from among at least one character tied to ability information that can be earned by consuming points and initial-consumption-point information indicating a consumption value of the points for earning the ability information;
a process for executing a nurturing game, said process including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.

In the process for updating the initial-consumption-point information, the updated initial-consumption-point information may be maintained as a status of the character.

The process for executing a nurturing game may include a process for granting a specific item, and the specific condition may be the use of the specific item.

The information processing program may further cause the computer to execute: a process for increasing the ability information that is tied to the character and that can be earned by consuming the points when a predetermined condition different from the specific condition is satisfied outside the nurturing game.

In order to solve the aforementioned problem, an information processing method is a method executed by at least one computer that executes:
a process for setting, as a character to be nurtured, a character selected by a player from among at least one character tied to ability information that can be earned by consuming points and initial-consumption-point information indicating a consumption value of the points for earning the ability information;
a process for executing a nurturing game, said process including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.

In order to solve the aforementioned problem, an information processing system includes at least one computer that executes:
a process for setting, as a character to be nurtured, a character selected by a player from among at least one character tied to ability information that can be earned by consuming points and initial-consumption-point information indicating a consumption value of the points for earning the ability information;
a process for executing a nurturing game, said process including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.

### Effects of Disclosure

According to the present invention, it is possible to further motivate a player to play a game.

### BRIEF DESCRIPTION OF DRAWINGS

FIG. 1 is an illustration showing the schematic configuration of an information processing system.

FIG. 2A is a drawing for illustrating the hardware configuration of a player terminal.

FIG. 2B is a drawing for illustrating the hardware configuration of a server.

FIG. 3A is a drawing for illustrating an example of a home screen.

FIG. 3B is a drawing for illustrating an example of an option setting screen.

FIG. 3C is a drawing for illustrating an example of a profile setting screen.

FIG. 3D is a drawing for illustrating an example of a home setting screen.

FIG. 4 is a drawing for illustrating a general flow of proceeding of a nurturing game.

FIG. 5A is a drawing for illustrating a main character selection screen.

FIG. 5B is a first drawing for illustrating a character details screen.

FIG. 5C is a second drawing for illustrating the character details screen.

FIG. 6A is a drawing for illustrating an ability parameter (initial value) table.

FIG. 6B is a drawing for illustrating an aptitude parameter (initial value) table.

FIG. 6C is a drawing for illustrating a skill table.

FIG. 6D is a drawing for illustrating a dedicated event table.

FIG. 7A is a first drawing for illustrating an inheritance character selection screen.

FIG. 7B is a first drawing for illustrating a nurtured character list screen.

FIG. 7C is a second drawing for illustrating the inheritance character selection screen.

FIG. 7D is a third drawing for illustrating the inheritance character selection screen.

FIG. 8 is a drawing for illustrating an inheritance line of descent.

FIG. 9 is a drawing for illustrating factor information.

FIG. 10A is a drawing for illustrating compatibility determination combinations, and FIG. 10B is a drawing for illustrating compatibility determination features.

FIG. 11A is a drawing for illustrating sort conditions.

FIG. 11B is a drawing for illustrating refining conditions.

FIG. 12 is a first drawing for illustrating a character details dialog.

FIG. 13 is a second drawing for illustrating the character details dialog.

FIG. 14 is a third drawing for illustrating the character details dialog.

FIG. 15 is a drawing for illustrating a skill display dialog.

FIG. 16A is a first drawing for illustrating a support card organization screen.

FIG. 16B is a drawing for illustrating a support card selection screen.

FIG. 16C is a second drawing for illustrating the support card organization screen.

FIG. 17A is a drawing for illustrating a support card table.

FIG. 17B is a drawing for illustrating a support effect table.

FIG. 17C is a drawing for illustrating a possessed skill table.

FIG. 17D is a drawing for illustrating a support event table.

FIG. 18A is a drawing for illustrating a final confirmation screen.

FIG. 18B is a drawing for illustrating a preset selection screen.

FIG. 19 is a drawing for illustrating an elective table.

FIG. 20A is a drawing for illustrating a game screen.

FIG. 20B is a drawing for illustrating a special race screen.

FIG. 21A is a first drawing for illustrating a training screen.

FIG. 21B is a second drawing for illustrating the training screen.

FIG. 21C is a drawing for illustrating a training result report screen.

FIG. 21D is a drawing for illustrating an event screen.

FIG. 22A is a first drawing for illustrating an inheritance event.

FIG. 22B is a second drawing for illustrating the inheritance event.

FIG. 22C is a third drawing for illustrating the inheritance event.

FIG. 22D is a fourth drawing for illustrating the inheritance event.

FIG. 23A is a first drawing for illustrating a skill screen.

FIG. 23B is a second drawing for illustrating the skill screen.

FIG. 24A is a first drawing for illustrating an individual race selection screen.

FIG. 24B is a drawing for illustrating an individual race start screen.

FIG. 24C is a first drawing for illustrating an individual race result screen.

FIG. 24D is a second drawing for illustrating the individual race result screen.

FIG. 25 is a drawing for illustrating an example of an item exchange screen.

FIG. 26 is a drawing for illustrating a general flow of a turn-at-start process.

FIG. 27 is a drawing for illustrating a placement probability table.

FIG. 28A is a drawing for illustrating a training level table.

FIG. 28B is a drawing for illustrating an increase-fixed value (speed) table.

In addition, FIG. 28C is a drawing for illustrating an increase-fixed value table (power).

FIG. 28D is a drawing for illustrating a bonus addition rate table.

FIG. 29 is a drawing for illustrating a second event table.

FIG. 30 is a drawing for illustrating a post-replacement training screen.

FIG. 31 is a drawing for illustrating a general flow of a turn-at-start process.

FIG. 32 is a drawing for illustrating a placement probability table.

FIG. 33 is a drawing for illustrating a bonus earnings table.

FIG. 34A is a drawing for illustrating the reporting of placement of a rival character on the game screen.

FIG. 34B is a drawing for illustrating the reporting of placement of a rival character on the individual race selection screen.

FIG. 35A is a first drawing for illustrating a nurturing completion screen.

FIG. 35B is a second drawing for illustrating the nurturing completion screen.

FIG. 35C is a third drawing for illustrating the nurturing completion screen.

FIG. 36A is a drawing for illustrating a strengthening subject selection screen.

FIG. 36B is a drawing for illustrating a character level strengthening screen.

FIG. 36C is a drawing for illustrating a status level strengthening screen.

FIG. 36D is a drawing for illustrating a hint level strengthening screen.

FIG. 37 is a drawing for illustrating a hint level strengthening confirmation screen.

FIG. 38A is a drawing for illustrating the relationship between possessed skills and hint levels.

FIG. 38B is a drawing for illustrating a hint level strengthening item.

FIG. 39A is a drawing for illustrating character information.

FIG. 39B is a drawing for illustrating skill information of a character.

FIG. 40 is a drawing for illustrating the configuration of a memory in the player terminal and functions of the player terminal as a computer.

FIG. 41 is a drawing for illustrating the configuration of a memory in the server and functions of the server as a computer.

FIG. 42 is a sequence diagram for illustrating processes of the player terminal and the server related to the nurturing game.

FIG. 43 is a flowchart for illustrating a nurturing-stage process in the server.

FIG. 44 is a flowchart for illustrating the turn-at-start process in the server.

FIG. 45 is a flowchart for illustrating the nurturing-stage process in the player terminal.

FIG. 46 is a flowchart for illustrating the turn-at-start process in the player terminal.

FIG. 47 is a flowchart for illustrating a display control process.

FIG. 48 is a flowchart for illustrating an in-turn process in the server.

FIG. 49 is a flowchart for illustrating an individual race execution process.

FIG. 50 is a flowchart for illustrating a reward granting process.

FIG. 51 is a flowchart for illustrating the in-turn process in the player terminal.

FIG. 52 is a flowchart for illustrating the display control process.

FIG. 53 is a sequence diagram for illustrating processes related to strengthening of a character executed in the player terminal and the server.

FIG. 54 is a flowchart for illustrating a strengthening process in the player terminal.

FIG. 55 is a flowchart for illustrating the strengthening process in the server.

### DESCRIPTION OF EMBODIMENTS

An aspect of an embodiment of the present invention will be described below in detail with reference to the accompanying drawings. Numerical values, etc. given in this embodiment are merely examples for facilitating understanding, and do not limit the present invention unless otherwise specifically mentioned. In this description and the drawings, the same reference signs are attached to elements having substantially the same functions and configurations, omitting repeated descriptions thereof, and elements that are not directly related to the present invention are not shown.

### (Overall Configuration of Information Processing System S)

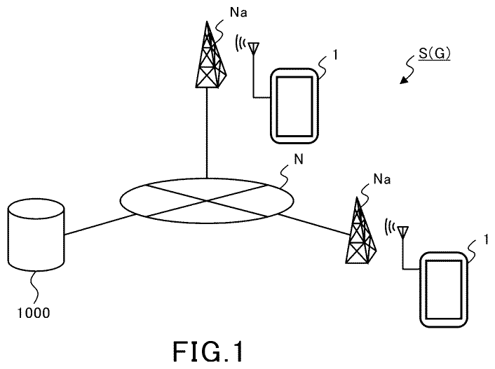

FIG. 1 is an illustration showing the schematic configuration of an information processing system S. The information processing system S is what is called a client-server system, including player terminals 1 functioning as clients (i.e., game terminals), a server 1000, and a communication network N having communication base stations Na.

In the information processing system S according to this embodiment, the player terminals 1 and the server 1000 each function as a game device G. The player terminals 1 and the server 1000 individually have assigned thereto roles for controlling the proceeding of the game such that it is possible to proceed with the game through cooperation between the player terminals 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include smartphones, mobile phones, tablet devices, personal computers, and game devices. This embodiment will be described by way of an example where each of the player terminals 1 is a smartphone.

The server 1000 is communicatively connected to the plurality of player terminals 1. The server 1000 accumulates various kinds of information for each player who plays a game. Furthermore, mainly on the basis of operations input from the player terminals 1, the server 1000 executes processes, such as updating the accumulated information and causing the player terminals 1 to download images and various kinds of information.

The communication base stations Na are connected to the communication network N, and transmit information to and receive information from the player terminals 1 wirelessly. The communication network N is configured of a mobile phone network, the Internet, a local area network (LAN), a dedicated circuit, etc., and realizes wired or wireless communicative connection between the player terminals 1 and the server 1000.

### (Hardware Configuration of Player Terminal 1 and Server 1000)

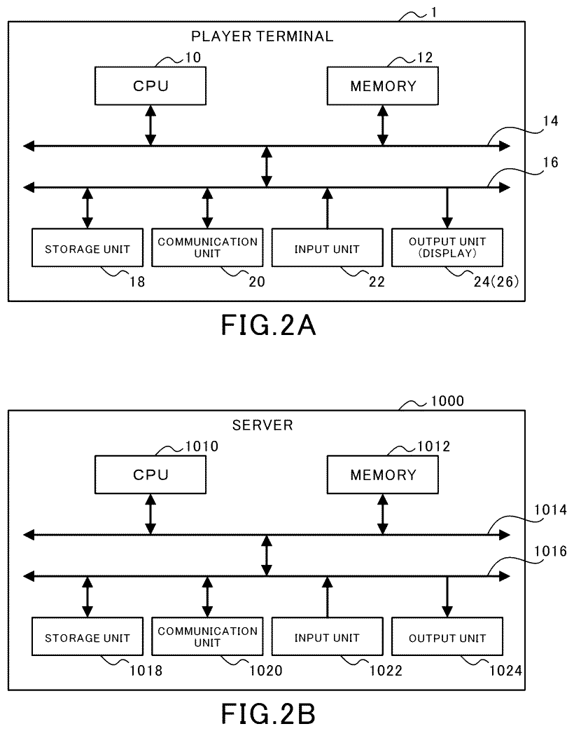

FIG. 2A is a drawing for illustrating the hardware configuration of a player terminal 1. In addition, FIG. 2B is a drawing for illustrating the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24, respectively, of the player terminal 1. Thus, a description of the hardware configuration of the player terminal 1 will be given below, and a description of the server 1000 will be omitted.

The CPU 10 runs programs stored in the memory 12 to control the proceeding of the game. The memory 12 is configured of a read only memory (ROM) or a random access memory (RAM), and stores the programs and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to a communication base station Na wirelessly, and transmits/receives information, such as various kinds of data and programs, to/from the server 1000 via the communication network N. At the player terminal 1, the programs, etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a special controller provided in the player terminal 1 or connected (externally attached) to the player terminal 1. Yet alternatively, the input unit 22 may be configured of an acceleration sensor that detects tilting or movement of the player terminal 1 or a microphone that detects speech of the player. That is, the input unit 22 widely includes devices that enable the player to input his/her intents in distinguishable manners.

The output unit 24 is configured to include a display device and a speaker. The output unit 24 may be a device connected (externally attached) to the player terminal 1. In this embodiment, the player terminal 1 is provided with a display 26 as the output unit 24 and is provided with a touchscreen as the input unit 22, wherein the touchscreen is overlaid on the display 26.

### (Game Content)

Next, a game provided by the information processing system S and a game device G according to this embodiment will be described. A player can possess characters earned by lottery, which is a so-called gacha, and characters distributed by the game administrator. Furthermore, the player can possess support cards earned by lottery and support cards distributed by the game administrator.

Although described below in detail, a nurturing game is provided in the game according to this embodiment. In the nurturing game, the player can nurture a character possessed by the player. In addition, the nurturing game according to this embodiment has gameplay in which the player nurtures a character by having the character run in a race simulating a horse race.

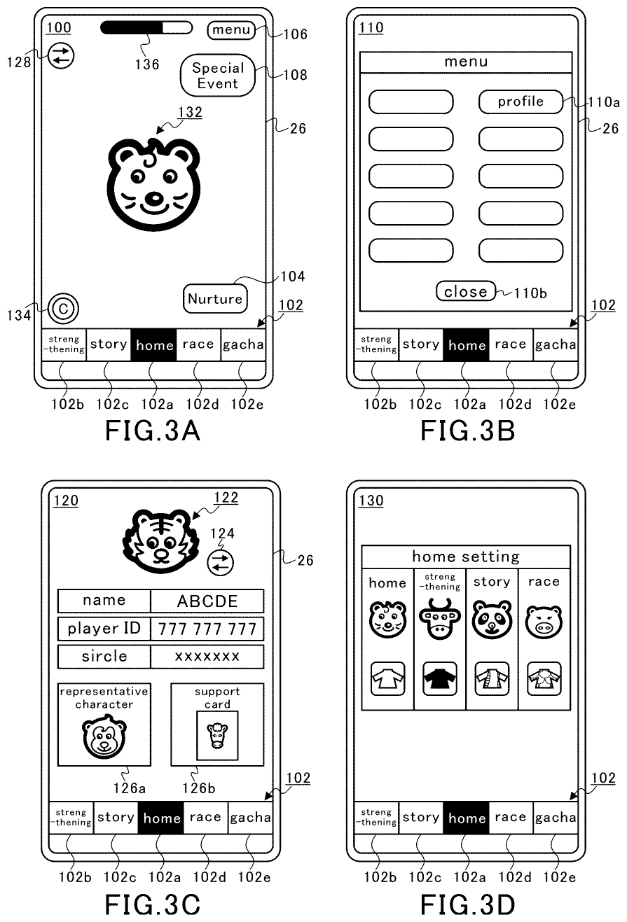

FIG. 3A is a drawing for illustrating an example of a home screen 100. When the game application is started at the player terminal 1, the home screen 100 is displayed on the display 26. In the lower section of the home screen 100, a menu bar 102 is displayed. A plurality of operation sections that can be operated (tapped) by the player are provided in the menu bar 102.

Here, a home screen selection operation section 102a, a strengthening screen selection operation section 102b, a story screen selection operation section 102c, a race game selection operation section 102d, and a gacha screen selection operation section 102e are provided in the menu bar 102. Note that in the menu bar 102, the operation section corresponding to the screen being displayed on the display 26 is highlighted so that the screen being displayed can be identified.

When the home screen selection operation section 102a is tapped, the home screen 100 shown in FIG. 3A is displayed on the display 26.

When the strengthening screen selection operation section 102b is tapped, a strengthening screen (not shown in the figure) is displayed. On the strengthening screen, it is possible to strengthen characters and support cards possessed by the player. The player can increase the levels set for characters and support cards by strengthening the characters and the support cards. Characters and support cards have various kinds of parameters set therefor, so that the parameters increase as the levels increase. As a result of parameters of characters and support cards increasing, the player can nurture a character having more powerful statuses in the nurturing game.

When the story screen selection operation section 102c is tapped, a story screen (not shown in the figure) is displayed. Here, a story image is provided for each of the characters appearing in the game. The player can select a character and a story image to view a story on the story screen.

When the race game selection operation section 102d is tapped, a race game selection screen (not shown in the figure) is displayed. This embodiment provides various race games in which a nurtured character nurtured in the nurturing game (described below) can be made to run. On the race game selection screen, the player can select a race game in which a nurtured character is made to run. Race games include a team competition game in which a team organized with a plurality of nurtured characters is made to compete against a team organized by another player selected by the computer. The team competition game has gameplay in which the player competes against other players for rankings.

When the gacha screen selection operation section 102e is tapped, a gacha screen (not shown in the figure) is displayed. On the gacha screen, the player can draw a so-called gacha lottery, in which a character and a support card can be earned by lottery by consuming in-game currency.

In addition, on the home screen 100, a nurturing game operation section 104 is provided above the menu bar 102. When the nurturing game operation section 104 is tapped, a nurturing game screen is displayed, whereby a nurturing game (described below) is started. The nurturing game is roughly classified into a preparatory stage and a nurturing stage, and the player first selects one of the characters possessed by himself/herself in the preparatory stage to set the selected character as a main character serving as a character to be nurtured.

In the preparatory stage, the player also sets a deck to be used when nurturing the main character. A deck is organized with a plurality of inheritance characters and a plurality of support cards (described below in detail). Therefore, in the nurturing game, the inheritance characters and the support cards organized in the deck are used.

When setting the main character and the deck (inheritance characters and support cards) is completed, the preparatory stage transitions to the nurturing stage, whereby a game for nurturing the main character is started. In the nurturing game, parameters of the main character can be changed. The player can possess the character nurtured in the nurturing game as a nurtured character. As described above, the player can organize nurtured characters possessed by himself/herself into a team for use in a team competition game, etc.

Thus, main objects of the game according to this embodiment are to nurture a nurtured character in a nurturing game and increase the ranking in a team competition game by using nurtured characters.

In addition, in this embodiment, a function for sharing a nurtured character or a support card among players and a function for sharing information among a plurality of players are provided. The player can set a nurtured character and a support card that can be used by other players in nurturing games. More specifically, as shown in FIG. 3A, a setting operation section 106 is provided in the upper right section of the home screen 100. When the setting operation section 106 is tapped, an option setting screen 110 is displayed.

FIG. 3B is a drawing for illustrating an example of the option setting screen 110. The option setting screen 110 is a screen that allows various kinds of information to be confirmed and set. A plurality of operation sections are provided on the option setting screen 110, so that when an operation section is tapped, information corresponding to the operation section can be confirmed and set.

The operation sections on the option setting screen 110 include a profile setting operation section 110a and a close operation section 110b. When the close operation section 110b is tapped, the option setting screen 110 is closed, and the home screen 100 is displayed. When the profile setting operation section 110a is tapped, a profile setting screen 120 is displayed.

FIG. 3C is a drawing for illustrating an example of the profile setting screen 120. On the profile setting screen 120, the player can confirm and set his/her own profile information. The profile information includes a profile character, a player name, a player ID, a circle to which the player belongs, a representative character, and a rental card.

The profile character functions as a character that is displayed when information concerning the player is viewed by another player. For example, the profile character is displayed when a circle function, which is a place for sharing information with other players, is used. On the profile setting screen 120, a currently set profile character image 122 is displayed. A change button 124 is provided near the profile character image 122. When the change button 124 is tapped, a profile character change screen (not shown in the figure) is displayed. On the profile character change screen, the player can change the profile character.

The player name set by the player, the player ID assigned to the player, and the name of the circle to which the player belongs are also displayed on the profile setting screen 120. In addition, a representative character setting operation section 126a and a rental card setting operation section 126b are provided on the profile setting screen 120.

When the representative character setting operation section 126a is tapped, a representative character setting screen (not shown in the figure) is displayed. On the representative character setting screen, the player can set, as a representative character, any one of the nurtured characters nurtured by himself/herself. In the representative character setting operation section 126a, an icon image indicating the currently set representative character is displayed. Although described below in detail, the representative character can be organized as an inheritance character in a deck in a nurturing game played by another player.

When the rental card setting operation section 126b is tapped, a rental card setting screen (not shown in the figure) is displayed. On the rental card setting screen, the player can set, as a rental card, any one of the support cards possessed by himself/herself. In the rental card setting operation section 126b, an icon image indicating the currently set rental card is displayed. Note that, as described above, the support card set as a rental card can be organized by another player in a deck and is used in a nurturing game played by the other player.

Although not described in detail, when a setting of the profile information is changed on the profile setting screen 120, setting change information is transmitted to the server 1000. In the server 1000, profile information for each player is saved.

As shown in FIG. 3A, a setting icon 128 is displayed on the home screen 100. When the setting icon 128 is tapped, a home setting screen 130 is displayed.

FIG. 3D is a drawing for illustrating an example of the home setting screen 130. On the home setting screen 130, the player can set home screen setting characters 132 to be displayed on the home screen 100. The player can set four home screen setting characters 132 to be displayed on the home screen 100.

Although not shown in the figure, when a leftward/rightward flick operation is input on the home screen 100, the screen displayed on the display 26, i.e., the display of the home screen 100 is switched. The four currently set home screen setting characters 132 are displayed on the home screen 100. The home screen setting characters 132 are assigned functions as respective operation sections displayed in the menu bar 102. Therefore, when a home screen setting character 132 displayed on the home screen 100 is tapped, the screen is switched in the same manner as when an operation section in the menu bar 102 is tapped.

On the home setting screen 130, character images corresponding to the four respective home screen setting characters 132 that are currently set, as well as corresponding operation sections, are displayed so as to be identifiable. When a character image displayed on the home setting screen 130 is tapped, a character selection screen (not shown in the figure) is displayed. The player can select a home screen setting character 132 on the character selection screen. Also, the player can set costumes for the home screen setting characters 132 on the home setting screen 130.

As shown in FIG. 3A, a circle icon 134 is displayed on the home screen 100. When the circle icon 134 is tapped, a circle screen is displayed. On the circle screen, the player can exchange information with other players belonging to the same circle.

In addition, various time-limited events are held irregularly in this embodiment. During the holding period of a specific event, which is a time-limited event, a specific event icon 108 is displayed on the home screen 100. When the specific event icon 108 is tapped, a specific event screen is displayed. On the specific event screen, the player can exchange specific event points, which are offered, for example, only during a specific event, for various rewards. Also, in a time-limited event, the player may be granted an additional reward besides a basic reward when he/she wins a particular race (hereinafter, referred to as a “specific race”). The additional reward is, for example, a special item that can increase the initial value of an ability parameter of a specific character or strengthen a unique skill provided to the specific character. Here, the specific character is, for example, one of the characters that run in a particular race in a time-limited event. Without limitation to this, however, the specific character may be any character that can be earned by the player and may also be a character that does not run in a particular race.

Here, the specific race is at least one race that is set in advance according to race type among the races that can be played during a specific event holding period. An additional reward may be granted when the player participates in a specific race, regardless of whether or not the player has won the specific race. The number of times an additional reward (i.e., special item) can be earned in one specific race (one kind of specific race) is limited to a predetermined number in a predetermined time period. For example, the number of times a special item can be earned in one specific race in one day is three. It should be noted, however, that the number of times a special item is earned may be changed depending on the type of the specific race (race category). In addition, the number of earnings of a special item at one time is the sum of the number of base earnings (e.g., three) and the number of bonus earnings (e.g., one or two). The number of bonus earnings can be granted when a specific race is won. An additional reward earned in a specific race is stored in the server 1000 so as to be tied to the player ID.

When the nurturing game operation section 104 is tapped on the home screen 100, the nurturing game screen is displayed, and a nurturing game is started. Note that the player can play a nurturing game by consuming game points. Game points are granted to the player every predetermined time (e.g., 10 minutes) by a predetermined value (e.g., +1). There is an upper limit (e.g., 100) on the number of game points the player can have, and the player can have game points up to the upper limit. In the upper section of the home screen 100, a game point indication bar 136 is provided to visually indicate the percentage of currently possessed game points relative to the upper limit.

The game points are reduced by a predetermined value (e.g., −30) when a nurturing game is started. Therefore, the player cannot start a nurturing game if he/she does not have a required number of game points. It should be noted, however, that the player can possess an item that restores game points and can use the item to restore game points. This item can be granted, for example, as a reward of a nurturing game or team competition game or can be earned by consuming in-game currency. The nurturing game will be described below in detail.

(Nurturing game)

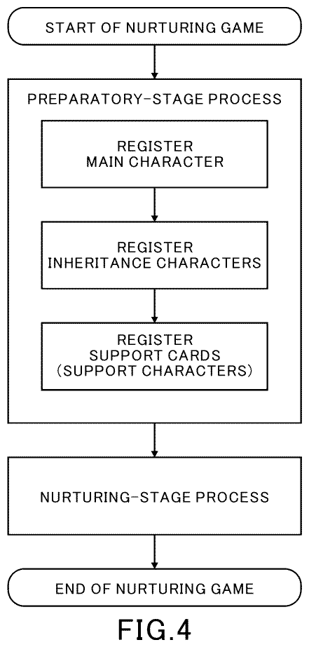

FIG. 4 is a drawing for illustrating a general flow of the nurturing game. The nurturing game is roughly classified into a setting game and a nurturing main game. Although described below in detail, the nurturing main game is a game in which one main character selected from among the characters possessed by the player is nurtured as a character to be nurtured.

In addition, the setting game allows the player to register a main character and a deck (inheritance characters and support cards) and corresponds to the preparatory stage of the nurturing game. Hereafter, the processes executed in the setting game are referred to as a preparatory-stage process, and the processes executed in the nurturing main game are referred to as a nurturing-stage process. Here, for the sake of ease of understanding, the general flow of the preparatory-stage process and the nurturing-stage process will be described first.

### <Preparatory-Stage Process>

In the preparatory-stage process, registration of a main character and registration of a deck (inheritance characters and support cards) are mainly set. Note that support cards are used to assist in nurturing the main character. Each of the support cards always has one character tied thereto, and the characters tied to the support cards that have been registered in the preparatory-stage process assist in nurturing the main character. Hereafter, the character tied to a support card is referred to as a support character.

### <Registration of Main Character>

When the nurturing game operation section 104 is tapped by the player on the home screen 100, a scenario selection screen (not shown in the figure) is displayed. In this embodiment, a plurality of scenarios for the nurturing main game are provided. In each of the scenarios for the nurturing main game, a final goal, goals in the middle of the game, etc. are set, and the player needs to clear the set goals one after another. Each of the scenarios has different goals and different time periods in which those goals are to be achieved. The player can select one of the plurality of scenarios on the scenario selection screen. Here, a case where a predetermined scenario is selected will be described.

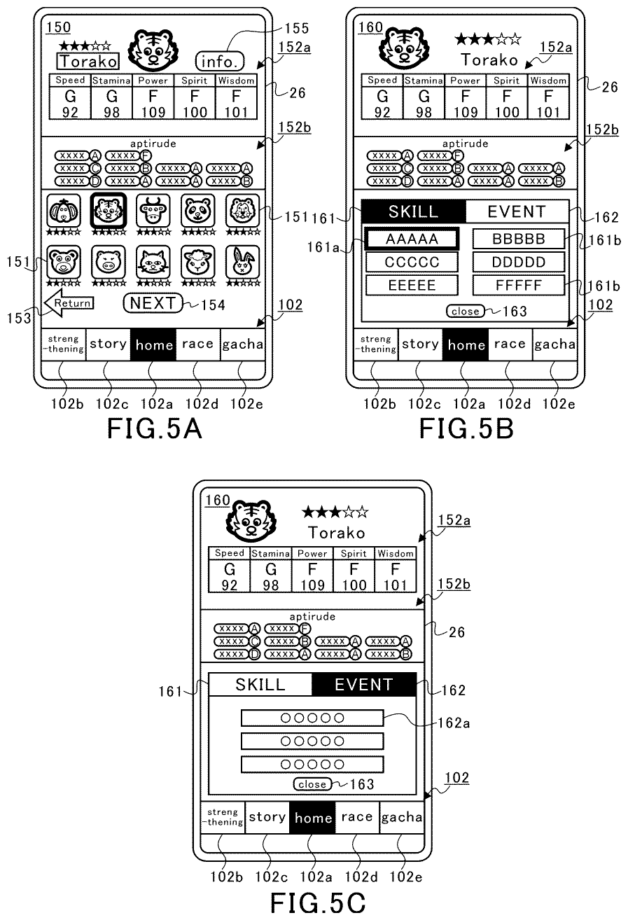

FIG. 5A is a drawing for illustrating a main character selection screen 150. In the center of the main character selection screen 150, a plurality of character icons 151 are displayed, showing a list of the characters possessed by the player. In addition, in the upper section of the main character selection screen 150, an ability parameter display section 152a and an aptitude parameter display section 152b are displayed. A return operation section 153 captioned “Return” and a next operation section 154 captioned “NEXT” are also displayed in the lower section of the main character selection screen 150.

In this embodiment, initial values of ability parameters are set for each character, and the initial values of the ability parameters of the character corresponding to a character icon 151 selected by the player are displayed in numerical values in the ability parameter display section 152a. In this embodiment, the larger the numerical value of an ability parameter, the higher the ability.

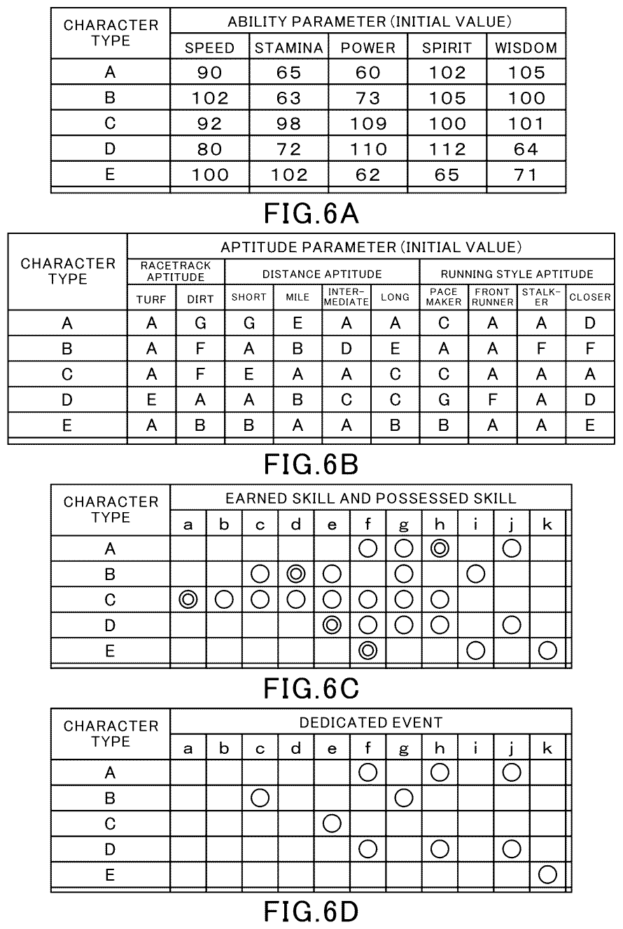

FIG. 6A is a drawing for illustrating an ability parameter (initial value) table. In this embodiment, as shown in FIG. 6A, the initial values of the ability parameters for each character are stored in the ability parameter (initial value) table. Also, on the basis of the initial values of the ability parameters stored in the ability parameter (initial value) table, the initial values of the ability parameters are displayed in the ability parameter display section 152a.

In this embodiment, the initial values of a plurality of kinds of ability parameters indicating the respective abilities are set for each character. More specifically, the ability parameters include: a speed ability parameter captioned “Speed” in the ability parameter display section 152a; a stamina ability parameter captioned “Stamina” in the ability parameter display section 152a; a power ability parameter captioned “Power” in the ability parameter display section 152a; a spirit ability parameter captioned “Spirit” in the ability parameter display section 152a; and a wisdom ability parameter captioned “Wisdom” in the ability parameter display section 152a.

Note that the initial values of the ability parameters for each character are increased via a player operation, etc. For example, each character has five status levels, so that the player can increase the status level of a character by consuming in-game currency or predetermined items. The initial values of the ability parameters of a character increase as the status level of the character increases. FIG. 6A shows initial values in the case where the characters have a predetermined level. Note that the player can increase the values of ability parameters in the nurturing main game. Namely, an object of the nurturing main game is to nurture a character with larger numerical values of the ability parameters.

In addition, aptitude parameters (initial values) are set for each character in this embodiment. Initial values of the aptitude parameters of the character corresponding to the character icon 151 selected by the player are displayed in letters in the aptitude parameter display section 152b, as shown in FIG. 5A.

FIG. 6B is a drawing for illustrating an aptitude parameter (initial value) table. In this embodiment, the initial values of the aptitude parameters for each character are stored in the aptitude parameter (initial value) table, as shown in FIG. 6B. The initial value of each of the aptitude parameters is set as one of the seven stages from letters A to G. Note that the initial value A of an aptitude parameter indicates the highest aptitude, and the initial value G of the aptitude parameter indicates the lowest aptitude. The initial values of the aptitude parameters are displayed in the aptitude parameter display section 152b on the basis of the initial values of the aptitude parameters stored in the aptitude parameter (initial value) table.

In this embodiment, the initial values of a plurality of kinds of aptitude parameters indicating the respective aptitudes are set for each character. More specifically, the aptitude parameters include: aptitude parameters related to a racetrack aptitude (turf track and dirt track); aptitude parameters related to a distance aptitude (short distance, mile, intermediate distance, and long distance); and aptitude parameters related to a running style aptitude (pace maker, front runner, stalker, and closer).

In the nurturing game, the player can allow the main character to run in various races. At this time, the higher the main character's aptitude matching the race content is, the more advantageously the race proceeds.

It is also acceptable that the initial values of the aptitude parameters for each character can be increased by consuming in-game currency. In addition, the value of an aptitude parameter may change in the nurturing main game. In addition, there may be some cases where an aptitude parameter is set as S, which indicates a higher aptitude than A, in the nurturing main game.

FIG. 5B is a first drawing for illustrating a character details screen 160. In addition, FIG. 5C is a second drawing for illustrating the character details screen 160. When a character icon 151 on the main character selection screen 150 is pressed and held, the character details screen 160 is displayed on the display 26. On the character details screen 160, details of the abilities of the character corresponding to the character icon 151 that was pressed and held on the main character selection screen 150 are displayed.

In the center of the character details screen 160, a skill operation section 161 and an event operation section 162 are displayed. As shown in FIG. 5B, when the character details screen 160 is displayed, the skill operation section 161 is initially highlighted, and skills provided for the character are displayed. A skill is an ability that may be invoked when a predetermined condition is satisfied while an individual race (described below) is being executed. When a skill is invoked, the race proceeds advantageously to each character.

FIG. 6C is a drawing for illustrating a skill table. As shown in FIG. 6C, skills for each of the characters possessed by the player are stored in the skill table. Also, skills are displayed on the character details screen 160, as shown in FIG. 5B, on the basis of the skills stored in the skill table. Note that merely possessing a skill does not allow the skill to be invoked-a skill can be invoked only after it has been earned. Hereinafter, a skill that is ready to be invoked by a character is referred to as an earned skill.

One earned skill is set for a character from the beginning of the nurturing main game. In addition, a plurality of possessed skills are set for the character, besides the one earned skill. A possessed skill is a skill that can be earned by consuming skill points (described below) after the start of the nurturing main game. That is, a possessed skill can become an earned skill in exchange for skill points.

In this embodiment, the skill indicated with a double circle in the skill table shown in FIG. 6C is displayed as the earned skill on the character details screen 160 in FIG. 5B. In addition, the skills indicated with a circle in the skill table shown in FIG. 6C are displayed as the possessed skills on the character details screen 160 in FIG. 5B. In this embodiment, the earned skill is highlighted so that it can be easily distinguished from the possessed skills, as shown on the character details screen 160 in FIG. 5B.

Although FIG. 5B is shown by way of an example where one earned skill and seven possessed skills are displayed in an earned-skill display field 161a and possessed-skill display fields 161b, respectively, as skills provided for each character, the present invention is not limited to this example. For example, the number of earned skills and the number of possessed skills may differ for each character. Also, for example, the number of earned skills or possessed skills for each character may increase with an increase in the level of the character, consumption of in-game currency or items, etc.

In addition, when the player taps the event operation section 162 on the character details screen 160, the content of the character details screen 160 is switched to display dedicated-event display fields 162a indicating dedicated events provided for the character, as shown in FIG. 5C. In this case, the event operation section 162 is highlighted, as shown in FIG. 5C. A dedicated event occurs when a predetermined condition is satisfied in the nurturing main game, and displays a story related to a character appearing in the nurturing game or changes the value of an ability parameter.

FIG. 6D is a drawing for illustrating a dedicated event table. As shown in FIG. 6D, dedicated events for each of the characters possessed by the player are stored in the dedicated event table. Also, on the basis of the dedicated events stored in the dedicated event table, the dedicated events are displayed on the character details screen 160, as shown in FIG. 5C. Note that the dedicated events may include a hint event that enables possession or earning of a skill, an ability event that increases or decreases the numerical values of ability parameters of the character, etc.

Regarding the dedicated events displayed on the character details screen 160 shown in FIG. 5C, all of the dedicated events may be allowed to occur during execution of the nurturing main game, at least some of the dedicated events may be allowed to occur during execution of the nurturing main game, or none of the dedicated events may be allowed to occur during execution of the nurturing main game if the predetermined condition is not satisfied. Also, for example, the number of dedicated events provided for each character may increase with an increase in the level of the character, consumption of in-game currency or items, etc. It is also acceptable that when a predetermined condition is satisfied, a dedicated event that is not displayed as a dedicated event is executed during the nurturing main game.

In addition, as shown in FIGS. 5B and 5C, a close operation section 163 captioned “close” is displayed in the lower section of the character details screen 160. When the close operation section 163 on the character details screen 160 is tapped, the character details screen 160 disappears, and the main character selection screen 150 is displayed on the display 26.

In addition, when the return operation section 153 is tapped on the main character selection screen 150 shown in FIG. 5A, the home screen 100 shown in FIG. 3A is displayed on the display 26. A nurturing information display button 155 is also provided on the main character selection screen 150. When the nurturing information display button 155 is tapped, a nurturing information display screen (not shown in the figure) is displayed. On the nurturing information display screen, the player can confirm information concerning the character selected on the main character selection screen 150.

A clearance goal tab is provided on the nurturing information display screen. Here, an object of the nurturing game is to create a more powerful nurtured character by nurturing a character selected as a main character to be nurtured from among the characters possessed by the player. Although described below in detail, a nurturing main game is composed of a plurality of turns, and the player needs to make the main character do training and run in a race in each of the turns.

Also, each of the characters has a plurality of clearance goals set therefor. When the clearance goal tab is tapped, the clearance goals set in the currently selected character are listed on the nurturing information display screen. In each of the turns, a race that allows the main character to run therein is defined in advance.

Also, when the main character to be nurtured is made to run in a race, the main character can earn fans, victory points, and special currencies. In each of the races, the number of base earnings of fans, victory points, and special currencies are defined for each finish place, and the higher the finish place, the larger the number of earned fans and the larger the numerical values of the victory points and the special currencies. Races also have difficulty levels set therefor, and the higher the difficulty level of a race, the more fans, victory points, and special currencies the player can earn in the race. For example, some races are called high-stakes races, having GI, GII, and GIII grades. The grade becomes higher in the order of GIII, GII, and GI. The higher the grade of a race, the higher the difficulty level of the race, and the more fans, victory points, and special currencies the player can earn in the race.

Here, the number of fans the player can earn by participating in a race is calculated by adding the number of bonus earnings to the number of base earnings defined for each finish place. More specifically, a correction value is decided on the basis of a race result, and the number of base earnings is multiplied by the correction value to calculate the number of bonus earnings. The sum of this number of bonus earnings and the number of base earnings is the number of fans earned by the main character. In the case where the race result indicates, for example, the first place, the larger the difference between the main character and the character that has won the second place, the larger the correction value. Also, in the case where the race result indicates one of the second to fifth places, the smaller the difference between the main character and the character that has won the first place, the larger the correction value.

In addition, the main character invokes a skill at a predetermined probability during a race. At this time, the larger the number of invoked skills, the larger the correction value. Thus, a condition for adding the number of fans is defined in each of the races, and the number of earned fans increases depending on various race results other than the finish place and a midway state of the race. It should be noted, however, that the number of fans earned by the main character is at least the number of base earnings corresponding to the finish place.

Note that a certain number of fans is specified as a race-participating condition in some races. If the number of fans earned by the main character is less than the number of fans specified as a race-participating condition, the player cannot allow the main character to run in the race. The higher the difficulty level of a race, the larger the number of fans required to allow the main character to run in the race.

Thus, each of the characters has a plurality of clearance goals set therefor. The player can continue the nurturing main game until the last turn by achieving the clearance goals. On the other hand, if the player fails to achieve a clearance goal, the nurturing main game ends at the turn.

Thus, the player can select a main character while confirming various items of information concerning each of the characters on the main character selection screen 150 shown in FIG. 5A. Also, when the next operation section 154 is tapped on the main character selection screen 150, the currently selected character is set as a main character, and an inheritance character selection screen 170 is displayed on the display 26.

### <Registration of Inheritance Characters>

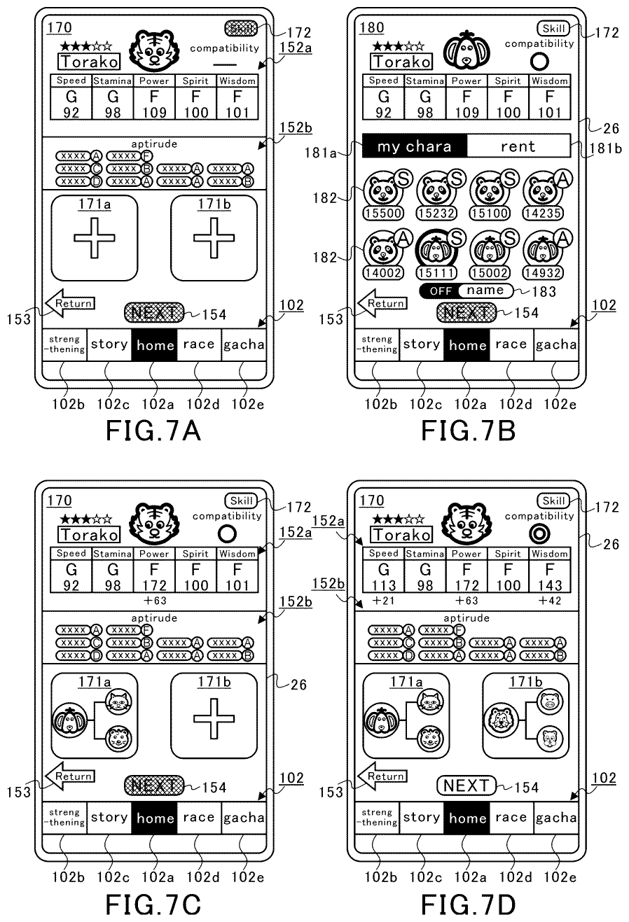

FIG. 7A is a first drawing for illustrating the inheritance character selection screen 170. FIG. 7B is a first drawing for illustrating a nurtured character list screen 180. FIG. 7C is a second drawing for illustrating the inheritance character selection screen 170. FIG. 7D is a third drawing for illustrating the inheritance character selection screen 170. The inheritance character selection screen 170 is a screen for the player to register inheritance characters.

An inheritance character is a character from which the main character inherits ability values, skills, etc. The player can select two inheritance characters from among the nurtured characters possessed by himself/herself, as well as from among the representative characters of other players extracted according to a predetermined extraction condition, such as the representative characters of friends typified by followers, thereby organizing and registering the selected inheritance characters in a deck. Note that only one representative character of another player can be organized as an inheritance character in the deck in one nurturing game.

The ability parameter display section 152a, the aptitude parameter display section 152b, a first inheritance character selection region 171a, and a second inheritance character selection region 171b are provided on the inheritance character selection screen 170. When the screen transitions from the main character selection screen 150 to the inheritance character selection screen 170, the first inheritance character selection region 171a and the second inheritance character selection region 171b are displayed blank, as shown in FIG. 7A.

When the first inheritance character selection region 171a or the second inheritance character selection region 171b is tapped, the nurtured character list screen 180 shown in FIG. 7B is displayed. A my character tab 181a and a rental tab 181b are provided on the nurtured character list screen 180. In addition, a nurtured character list display region is provided below the my character tab 181a and the rental tab 181b. Nurtured character icons 182 are displayed in the nurtured character list display region.

While the my character tab 181a is selected, the nurtured character icons 182 corresponding to the nurtured characters possessed by the player himself/herself are displayed, as shown in FIG. 7B. Also, although not shown in the figure, the nurtured character icons 182 corresponding to the representative characters of friends, i.e., nurtured characters that have been nurtured by the friends, are displayed while the rental tab 181b is selected.

In addition, when a nurtured character icon 182 is tapped, the nurtured character corresponding to the nurtured character icon 182 is temporarily selected. When the nurtured character icon 182 is tapped, the inheritance character selection screen 170 is also displayed, as shown in FIG. 7C. At this time, for example, if the nurtured character list screen 180 is displayed as a result of the first inheritance character selection region 171a being tapped and a nurtured character icon 182 is tapped on the nurtured character list screen 180, then an image indicating the nurtured character that has been temporarily selected is displayed in the first inheritance character selection region 171a.

In this state, for example, if the nurtured character list screen 180 is displayed as a result of the second inheritance character selection region 171b being tapped and a nurtured character icon 182 is tapped on the nurtured character list screen 180, then an image indicating the nurtured character that has been temporarily selected is displayed in the second inheritance character selection region 171b, as shown in FIG. 7D.

In addition, information concerning the inheritance characters used when a nurtured character was nurtured is stored so as to be tied to the nurtured character. In the first inheritance character selection region 171a, information concerning the inheritance characters used when the nurtured character was nurtured is displayed.

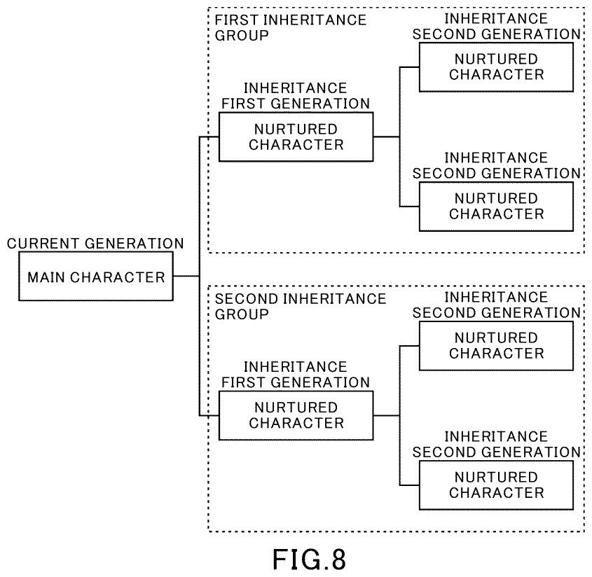

FIG. 8 is a drawing for illustrating an inheritance line of descent. In a nurturing game, various effects are produced on the basis of factor information possessed by the inheritance characters, such as an increase in the values of ability parameters and aptitude parameters of the main character. Here, two inheritance characters are set for one main character, and these inheritance characters are nurtured characters created before. Therefore, when a nurtured character set as an inheritance character was created, the nurtured character also had two inheritance characters set therefor.

As shown in FIG. 8, the main character to be nurtured in the nurturing main game that will be started is assumed to be the current generation. In addition, two nurtured characters set as inheritance characters for this main character are assumed to be the inheritance first generation. Furthermore, when nurturing of each of the nurtured characters of the inheritance first generation was started, two nurtured characters were set as inheritance characters. The two nurtured characters set as inheritance characters when each of the nurtured characters of the inheritance first generation was created are assumed to be the inheritance second generation.

In this case, the nurtured characters of the inheritance first generation and the inheritance second generation produce effects on the main character of the current generation, as shown in FIG. 8. As described above, because two inheritance characters (inheritance first generation) are set for one main character, a total of six nurtured characters produce effects on the one main character.

For example, a first inheritance group is composed of one of the two nurtured characters of the inheritance first generation and the two nurtured characters of the inheritance second generation serving as the inheritance characters of this nurtured character. Similarly, a second inheritance group is composed of the other of the two nurtured characters of the inheritance first generation and the two nurtured characters of the inheritance second generation serving as the inheritance characters of this nurtured character.

As shown in FIG. 7D, the first inheritance character selection region 171a contains icons corresponding to the one nurtured character of the inheritance first generation and the two nurtured characters of the inheritance second generation, respectively, that constitute the first inheritance group. Similarly, the second inheritance character selection region 171b contains icons corresponding to the one nurtured character of the inheritance first generation and the two nurtured characters of the inheritance second generation, respectively, that constitute the second inheritance group.

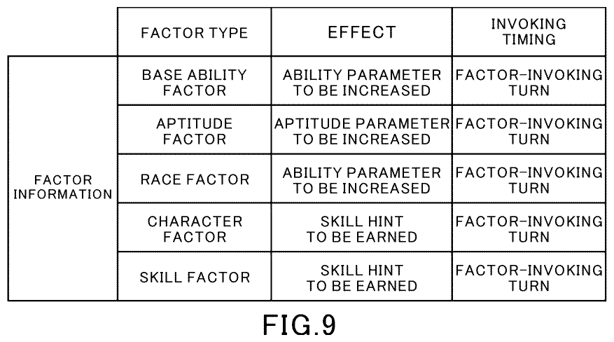

FIG. 9 is a drawing for illustrating factor information. Although described below in detail, when the nurturing game is completed, the main character to be nurtured is registered as a nurtured character, and at this time, factor information is stored so as to be tied to the nurtured character. More specifically, when nurturing of the nurtured character is completed, factors to be earned by the nurtured character are decided by lottery. Also, factor information indicating the factors won by lottery is tied to the nurtured character. In other words, when the nurturing game is completed, the nurtured character can earn the factors won by lottery.

It should be noted, however, that the factors earned by the nurtured character do not affect the abilities themselves of the nurtured character. For example, the nurtured character can be made to run in a race game, such as the team competition game. At this time, in the race, simulation, i.e., computation for deciding the finish places and race proceeding is executed on the basis of the ability parameters, aptitude parameters, earned skills, etc. of all nurtured characters running in the race. Factors possessed by the nurtured characters are not used for computation, and even if a nurtured character has many factors, the race does not proceed advantageously to the nurtured character.

Factors possessed by a nurtured character affect only the main character to be nurtured when the nurtured character is set as an inheritance character. Factors that can be earned by a nurtured character are classified into a plurality of types. FIG. 9 shows factor types: a base ability factor, an aptitude factor, a race factor, a character factor, and a skill factor. One of a plurality of stages is set for each of the factors. Here, three stages of factor level, including level 1, level 2, and level 3, are provided as factor stages.

Note that the factor level is decided by lottery. At this time, after factors to be earned by the nurtured character are decided, a factor level may be decided by lottery for each of the earned factors. Alternatively, a winning rate may be set for each of the combination patterns of factors and factor levels, so that any of the combination patterns can be decided on the basis of the set winning rate. In this case, factors to be earned and factor levels are decided simultaneously.

The factor level has level 3 as the most effective level and level 1 as the least effective level. In a lottery for deciding a factor level, level 3 is set to have the lowest winning probability, and level 1 is set to have the highest winning probability. It should be noted, however, that the winning probability of a factor to be earned and the winning probability of a factor level may change depending on the result of the nurturing game. In this case, a factor level may be decided so that, for example, the higher an ability parameter and an evaluation score of the nurtured character, the higher the factor level.

The base ability factor increases an ability parameter of the main character. The base ability factor has five factors: a speed factor, a stamina factor, a power factor, a spirit factor, and a wisdom factor. A nurtured character always earns one of the five base ability factors. The five base ability factors correspond to the five ability parameters: speed, stamina, power, spirit, and wisdom, respectively. If a nurtured character of the inheritance first generation or the inheritance second generation has, for example, a speed factor, the speed ability parameter of the main character increases.

At this time, the increase value of the speed ability parameter differs depending on the factor level of the speed factor. For example, the speed ability parameter of the main character increases by “7” if the factor level of the speed factor is level 1, the ability parameter increases by “13” if the factor level of the speed factor is level 2, and the ability parameter increases by “21” if the factor level of the speed factor is level 3. Therefore, if a total of six nurtured characters, including the two nurtured characters of the inheritance first generation and the four nurtured characters of the inheritance second generation, have a speed factor of level 3, the speed ability parameter of the main character increases by a maximum of 126 (increase value 21×six characters).

It should be noted, however, that each of the factors has an invoking timing and an invoking condition set therefor. Therefore, even if an inheritance character has a factor, no effects are produced on the main character if the invoking condition is not satisfied at the invoking timing.

As described above, a nurturing main game is composed of a plurality of turns, and predetermined turns among those turns are set as factor-invoking turns. Suppose that three turns of the nurturing main game, e.g., the first turn, the 30th turn, and the 54th turn, are set as factor-invoking turns. In these factor-invoking turns, it is decided whether or not to invoke each of the factors, and when it is decided to invoke a factor, the invoking condition for that factor is satisfied, thus producing an effect corresponding to the factor.

Note that whether or not to invoke a base ability factor is decided by lottery. At this time, the probability of winning a lottery for deciding whether or not to invoke a base ability factor, i.e., the probability of invoking the base ability factor (hereinafter, referred to as an invoking probability) may differ among the three factor-invoking turns. Here, in the first turn, the invoking probability of a base ability factor is set to 100%, regardless of the factor level. In addition, in the 30th turn and the 54th turn, the invoking probability of a base ability factor differs depending on the factor level. As an example, in the 30th turn and the 54th turn, the invoking probability of a base ability factor of level 3 is set to 100%, the invoking probability of a base ability factor of level 2 is set to 90%, and the invoking probability of a base ability factor of level 1 is set to 80%.

On the inheritance character selection screen 170, an increase value by which an ability parameter increases in the first turn is displayed. For example, one inheritance character constituting the first inheritance group is temporarily selected in FIG. 7C. In this case, the kind of an ability parameter that increases in the first turn due to the one inheritance character that is temporarily selected, as well as an increase value of the ability parameter, is displayed. Here, “+63” is displayed below the power ability parameter, indicating that the power ability parameter increases by 63 points in the first turn. In addition, the ability parameter display section 152a shows a value resulting from the increase value in the first turn being added.

In addition, two inheritance characters constituting the first inheritance group and the second inheritance group are temporarily selected in FIG. 7D. In this case, the kinds of ability parameters that increase in the first turn due to the two inheritance characters that are temporarily selected, as well as increase values of the ability parameters, are displayed. Here, “+21”, “+63”, and “+42” are displayed below the speed, power, and wisdom ability parameters, respectively, indicating that the speed, power, and wisdom ability parameters increase by 21 points, 63 points, and 42 points, respectively, in the first turn.

Note that on the inheritance character selection screen 170, an increase value of the ability parameter that increases due to the inheritance character constituting the first inheritance group and increase values of the ability parameters that increase due to the inheritance character constituting the second inheritance group are displayed identifiably. For example, in FIG. 7D, the “+63” indication displayed below the power ability parameter and the “+21” and “+42” indications displayed below the speed ability parameter and the wisdom ability parameter are differentiated by color.

The aptitude factor shown in FIG. 9 increases an aptitude parameter of the main character. The aptitude factor has six factors: a turf factor, a dirt factor, a short distance factor, a mile factor, an intermediate distance factor, and a long distance factor. A nurtured character always earns one of the six aptitude factors. The six aptitude factors correspond to a turf aptitude, a dirt aptitude, a short distance aptitude, a mile aptitude, an intermediate distance aptitude, and a long distance aptitude, respectively. If the nurtured characters of the inheritance first generation or the inheritance second generation include a nurtured character having, for example, a turf factor, the aptitude parameter of the turf aptitude of the main character increases.

It should be noted, however, that each of the aptitude factors also has an invoking timing and an invoking condition set therefor, and it is decided whether or not to invoke each of the aptitude factors in the same factor-invoking turns as those for the base ability factor. When it is decided to invoke an aptitude factor, the corresponding aptitude parameter increases by one stage. As an example, the invoking probability of the aptitude factor is set to 100% in the first turn, regardless of the factor level.

Suppose that, for example, the aptitude factors of the three nurtured characters belonging to the first inheritance group are the turf factor, the short distance factor, and the mile factor, respectively, and that the aptitude factors of the three nurtured characters belonging to the second inheritance group are the turf factor, the short distance factor, and the intermediate distance factor, respectively. In this case, the turf aptitude and the short distance aptitude of the main character each increase by two stages, and the mile aptitude and the intermediate distance aptitude each increase by one stage.

Also, suppose that, for example, all the aptitude factors of the three nurtured characters belonging to the first inheritance group are the turf factor and that all the aptitude factors of the three nurtured characters belonging to the second inheritance group are the short distance factor. In this case, the turf aptitude and the short distance aptitude of the main character each increase by three stages. As still another example, suppose that all the aptitude factors of the three nurtured characters belonging to the first inheritance group are the turf factor and that the aptitude factors of the three nurtured characters belonging to the second inheritance group are the turf factor, the short distance factor, and the mile factor, respectively. In this case, the turf aptitude of the main character increases in four stages, and the short distance aptitude and the mile aptitude each increase in one stage.

It should be noted, however, that a limit is set on the increase values of aptitude parameters in the first turn. More specifically, the upper limits of all aptitude parameters are set to A in the first turn. Therefore, in the case where the initial value of the turf aptitude of the main character is A, the turf aptitude does not increase in the first turn even if an inheritance character has the turf factor.

In contrast, in the 30th turn and the 54th turn, a lottery for deciding whether or not to invoke each of the aptitude factors is drawn on the basis of the factor level thereof. As an example, in the 30th turn and the 54th turn, the invoking probability of an aptitude factor of level 3 is set to 5%, the invoking probability of an aptitude factor of level 2 is set to 3%, and the invoking probability of an aptitude factor of level 1 is set to 1%. In the 30th turn or the 54th turn, if it is decided to invoke an aptitude factor by lottery, the aptitude parameter corresponding to the aptitude factor increases. Note that in the 30th turn and the 54th turn, the upper limit of each of the aptitudes is lifted from A to S. Therefore, in the 30th turn and the 54th turn, the value of each of the aptitude parameters can be increased up to S by invoking the aptitude factor.

Note that the values of the aptitude parameters that have increased in the first turn are displayed in the aptitude parameter display section 152b of the inheritance character selection screen 170.

The race factor increases an ability parameter of the main character. A race factor is provided for each of the races with a high difficulty level (hereinafter, referred to as a factor-applicable race), such as GI, among the races of the nurturing main game in which the main character can run. When the nurturing game is completed, a lottery for deciding whether or not to earn a race factor is drawn for each of the factor-applicable races in which the main character won the first place. The nurtured character can earn a race factor by winning this lottery.

Note that a factor level is provided for each of the race factors, and a factor level is decided by lottery for each of the race factors that have been decided to be earned. Here, there are no upper limits on the number of race factors that can be earned by one nurtured character, so that one nurtured character can earn a plurality of race factors.

Each of the race factors has set therefor in advance an ability parameter that is increased when the race factor is invoked and the increase value thereof. For example, race factors include a race factor for increasing the speed ability parameter and a race factor for increasing the power ability parameter. At this time, the higher the factor level, the larger the increase value of the ability parameter.

In addition, each of the race factors also has an invoking timing and an invoking condition set therefor, and it is decided whether or not to invoke each of the race factors in the factor-invoking turns. When it is decided to invoke a race factor, the ability parameter corresponding to the race factor increases. Note that the factor-invoking turns for invoking a race factor are limited to the 30th turn and the 54th turn. In addition, the invoking probability of a race factor in a factor-invoking turn differs depending on the factor level, and the higher the factor level, the higher the invoking probability.

The character factor is a factor specific to a character. For example, only in the case where a character that has been strengthened up to a predetermined level is nurtured as the main character, the character factor set in the character is always granted to the nurtured character when the nurturing game is completed. Note that because only one character factor is set for one character, one nurtured character can earn up to one character factor. Also, when a nurtured character is created on the basis of a character that has not been strengthened to the predetermined level, the nurtured character cannot earn the character factor.

In addition, a character factor can be invoked in a factor-invoking turn set in advance and is invoked when a lottery drawn in the factor-invoking turn is won. When a character factor is invoked, a hint event set for the character factor occurs, allowing the player to earn a hint for a skill, as described above.

The skill factor is granted on the basis of earned skills earned by the nurtured character. More specifically, when the nurturing game is completed, a lottery for deciding whether or not to earn a skill factor is drawn for each of the earned skills earned by the nurtured character. A skill factor is granted to the nurtured character when this lottery is won. In short, the nurtured character can earn some or all of the skill factors corresponding to the earned skills. Note that when it is decided that a skill factor is to be earned, the factor level of that skill factor is decided by lottery.

In addition, a skill factor can be invoked in a factor-invoking turn set in advance and is invoked when a lottery drawn in the factor-invoking turn is won. At this time, the higher the factor level, the higher the winning probability. When a skill factor is invoked, a hint event set for the skill factor occurs, allowing the player to earn a hint for a skill. Because of this, the main character can earn a skill similar to an earned skill earned by an inheritance character, etc.

Thus, skill factors are earned within the range of earned skills earned by the nurtured character. Therefore, the larger the number of earned skills earned by a nurtured character, the higher the probability that the nurtured character earns a skill factor. It should be noted, however, that because whether or not to earn a skill factor is decided by lottery, no skill factors may be earned in some cases, irrespective of many earned skills.

Here, the present embodiment has been described by way of an example where the nurtured character earns a skill factor apart from an earned skill. However, instead of providing skill factors, a skill that can be earned by the main character may be decided on the basis of earned skills possessed by the nurtured characters serving as inheritance characters.

As described above, ability parameters of the main character greatly change depending on the inheritance characters organized in the deck. In addition, a nurtured character with a high ability is not necessarily suitable as an inheritance character because whether or not to earn a factor is decided by lottery, regardless of the high ability of the nurtured character itself. On the other hand, even if a nurtured character itself does not have a high ability, the nurtured character may function as an effective inheritance character by earning many factors with a high factor level. Thus, allowing an inheritance character to be organized in a deck brings about pleasure in that not only is a powerful nurtured character nurtured but also a nurtured character effective as an inheritance character is nurtured.

Furthermore, in this embodiment, compatibility among the main character, the nurtured characters of the inheritance first generation, and the nurtured characters of the inheritance second generation is determined. Also, in the case of a combination of characters with good compatibility, the factor invoking condition becomes favorable.

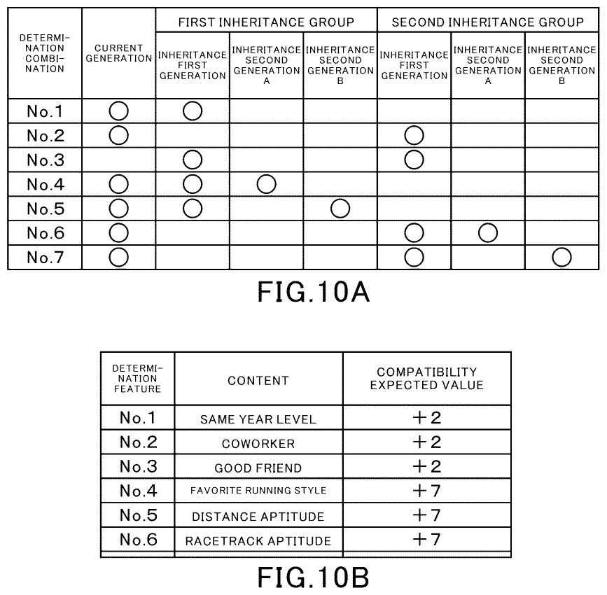

FIG. 10A is a drawing for illustrating compatibility determination combinations, and FIG. 10B is a drawing for illustrating compatibility determination features. As shown in FIG. 10A, seven determination combinations from No. 1 to No. 7 are provided in this embodiment. The first determination combination (No. 1) is the combination of the main character of the current generation and the nurtured character of the inheritance first generation in the first inheritance group. The second determination combination (No. 2) is the combination of the main character of the current generation and the nurtured character of the inheritance first generation in the second inheritance group.

The third determination combination (No. 3) is the combination of the nurtured character of the inheritance first generation in the first inheritance group and the nurtured character of the inheritance first generation in the second inheritance group. The fourth determination combination (No. 4) is the combination of the main character of the current generation, the nurtured character of the inheritance first generation in the first inheritance group, and one (nurtured character A) of the nurtured characters of the inheritance second generation in the first inheritance group. The fifth determination combination (No. 5) is the combination of the main character of the current generation, the nurtured character of the inheritance first generation in the first inheritance group, and the other (nurtured character B) of the nurtured characters of the inheritance second generation in the first inheritance group.

The sixth determination combination (No. 6) is the combination of the main character of the current generation, the nurtured character of the inheritance first generation in the second inheritance group, and one (nurtured character A) of the nurtured characters of the inheritance second generation in the second inheritance group. The seventh determination combination (No. 7) is the combination of the main character of the current generation, the nurtured character of the inheritance first generation in the second inheritance group, and the other (nurtured character B) of the nurtured characters of the inheritance second generation in the second inheritance group.

It is determined whether or not a condition is satisfied for each of the aforementioned determination combinations with respect to each of a plurality of determination features. FIG. 10B shows an example of determination features. In this embodiment, the game world is set up such that the characters that can be selected as a main character are students, and each character does training at school.

Also, each character has pre-defined settings of year level, coworker, and good friend, as shown in FIG. 10B. The determination features include content, for example, as to whether the two or three characters constituting a determination combination are in the same year level, are coworkers, and are good friends. The determination features also include content as to whether the characters constituting a determination combination have in common a favorite running style, a favorite distance aptitude, and a favorite racetrack aptitude.

Also, a compatibility expected value is tied to each of the determination features, so that the compatibility expected values of the determination features that are satisfied among the characters constituting a determination combination are accumulated. Although the compatibility expected value differs depending on the determination feature here, the compatibility expected value may be common to all determination features.

For example, in order to determine compatibility, first it is determined whether or not each of the determination features is satisfied between the characters belonging to the first determination combination, i.e., between the main character of the current generation and the nurtured character of the inheritance first generation in the first inheritance group. At this time, compatibility expected values tied to the satisfied determination features are accumulated and counted. In this manner, the compatibility expected values are counted sequentially from the first determination combination to the seventh determination combination, and invoking probabilities of factors are corrected on the basis of the finally calculated compatibility expected value. That is, the larger the compatibility expected value is, the higher the invoking probabilities of all factors are, and the smaller the compatibility expected value is, the lower the invoking probabilities of all factors are.

Note that the invoking probabilities may be calculated by using the calculated compatibility expected value as a correction value. In addition, for example, a correction value for correcting the invoking probabilities of factors may be set for each compatibility level, so that the compatibility level is decided by the calculated compatibility expected value.

Thus, because the invoking probabilities of factors differ depending on the compatibility between the main character and an inheritance character or the compatibility between inheritance characters, the combination of two inheritance characters greatly affects nurturing of the main character. That is, the compatibility between characters can be an important determination consideration in selecting an inheritance character.

In a state in which an inheritance character is selected, a compatibility mark indicating the level of compatibility is displayed in the upper right section of the inheritance character selection screen 170 and the nurtured character list screen 180, as shown in FIGS. 7B, 7C, and 7D. Here, the compatibility level based on the currently selected character is indicated with three compatibility marks: a double circle, a circle, and a triangle. Note that in a state in which no inheritance characters are selected, no compatibility marks are displayed, as shown in FIG. 7A.

In addition, a display switch button 183 is provided on the nurtured character list screen 180, as shown in FIG. 7B. When the display switch button 183 is operated, a display condition setting screen (not shown in the figure) is displayed. On the display condition setting screen, the player can make a setting for reordering or refining the nurtured character icons 182 displayed on the nurtured character list screen 180, i.e., the nurtured characters that can be selected as inheritance characters.

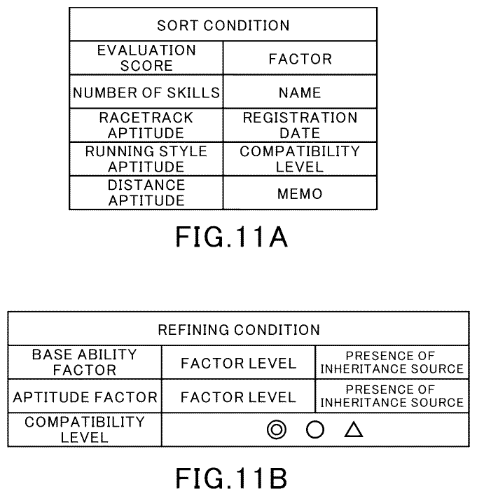

FIG. 11A is a drawing for illustrating sort conditions. FIG. 11B is a drawing for illustrating refining conditions. The player can select and set a sort condition shown in FIG. 11A on the display condition setting screen. Here, any of the evaluation score, factor, number of skills, name, racetrack aptitude, registration date, running style aptitude, compatibility level, distance aptitude, and memo can be selected and set as a sort condition. When a sort condition is set, the nurtured character list screen 180 is displayed. At this time, on the nurtured character list screen 180, the order in which the nurtured character icons 182 are displayed is changed according to the sort condition.

On the display condition setting screen, the player can also select and set a refining condition shown in FIG. 11B. Here, the base ability factor, aptitude factor, and compatibility level are provided as refining conditions. Note that when the base ability factor or the aptitude factor is set as a refining condition, only the nurtured characters having the factor selected by the player are displayed on the nurtured character list screen 180.

At this time, the player can set a factor level. When the nurtured characters are refined with the factor level set to, for example, level 3, only the nurtured characters having factors that are identical to the factor selected by the player and that have a factor level of level 3 are displayed on the nurtured character list screen 180. Note that the player can refine the nurtured characters by selecting whether the nurtured character itself has the factor or inheritance characters of the nurtured character have the factor.

In addition, the player can refine the nurtured characters by compatibility level. Here, the player can refine nurtured characters with the compatibility indicated by a double circle, nurtured characters with the compatibility indicated by a circle, and nurtured characters with the compatibility indicated by a triangle. In this manner, sorting and refining are possible with various conditions, thereby enhancing convenience to the player.

Furthermore, when a nurtured character icon 182 is pressed and held on the nurtured character list screen 180 shown in FIG. 7B, detailed information concerning the nurtured character corresponding to the nurtured character icon 182 is displayed.

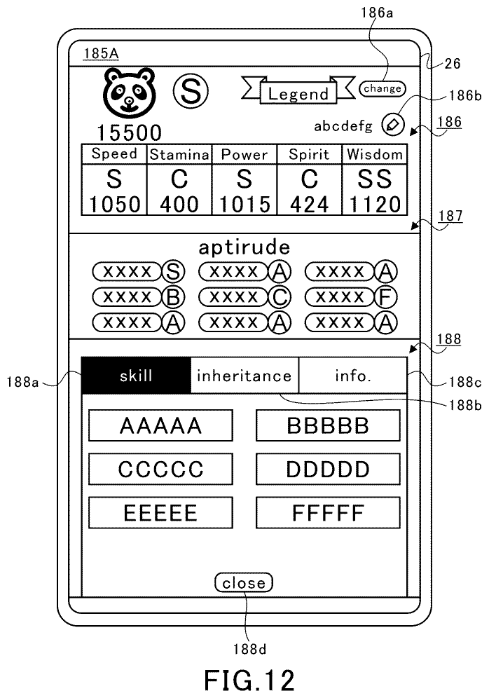

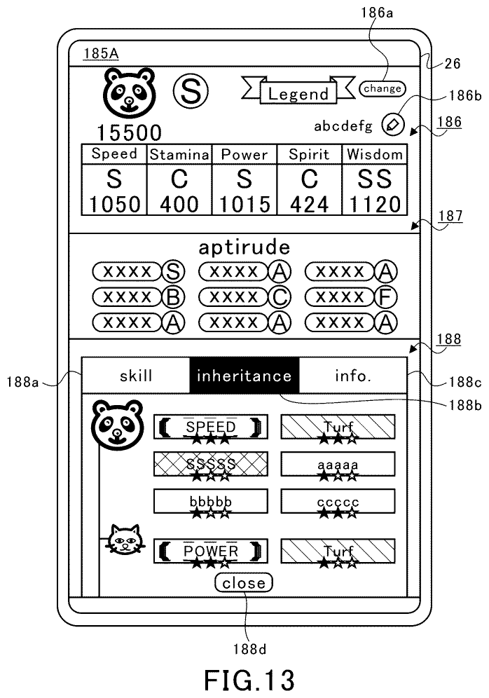

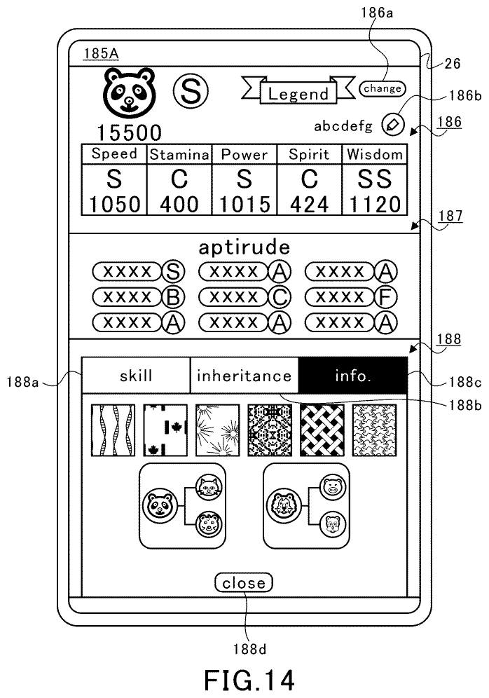

FIG. 12 is a first drawing for illustrating a character details dialog 185A. FIG. 13 is a second drawing for illustrating the character details dialog 185A. FIG. 14 is a third drawing for illustrating the character details dialog 185A. Detailed information concerning the nurtured character is displayed in the character details dialog 185A. An ability parameter display field 186 indicating the ability parameters of the nurtured character is displayed in the upper section of the character details dialog 185A.

In the upper left section of the ability parameter display field 186, an icon indicating the character on which the nurtured character is based, as well as an evaluation score and a nurturing rank of the nurtured character, is displayed. Also, in the upper right section of the ability parameter display field 186, a nickname change button 186a and a memo input button 186b are provided. When the nickname change button 186a is tapped, a nickname list screen (not shown in the figure) is displayed. The nicknames earned by the nurtured character are listed on the nickname list screen. Note that many nicknames are provided in the nurturing main game, and an earning condition is set for all nicknames.

In the nurturing main game, a nickname satisfying the earning condition thereof is granted to the nurtured character. The player can select any one of the nicknames earned by the nurtured character and set it for the nurtured character. The player can change the nickname set for the nurtured character on the nickname list screen. The currently set nickname (Legend, here) is displayed to the left of the nickname change button 186a.

Note that examples of the earning condition of a nickname include: the main character earning a predetermined number of fans; an ability parameter or an aptitude parameter having a predetermined value or larger; a predetermined skill being earned; the number of wins in a race reaching a predetermined number; and a predetermined finish place (e.g., first place) being won in a particular race.

In addition, when the memo input button 186b is tapped, a character input screen (not shown in the figure) is displayed. On the character input screen, up to nine characters can be input in, for example, hiragana, katakana, numeric character, Roman letters. The characters input on the character input screen are stored as a memo so as to be tied to the nurtured character. If a memo is stored in the nurtured character, the memo (abcdefg, here) is displayed to the left of the memo input button 186b.

Note that the sort conditions of the nurtured character icons 182 on the nurtured character list screen 180 include the aforementioned memo. Therefore, by registering a memo so as to be tied to a nurtured character, the player can more easily find nurtured characters for use as inheritance characters.

In addition, an aptitude information display field 187 is displayed below the ability parameter display field 186. In the aptitude information display field 187, aptitude parameters related to the racetrack aptitudes (turf and dirt), aptitude parameters related to the distance aptitudes (short distance, mile, intermediate distance, and long distance), and aptitude parameters related to the running style aptitudes (pace maker, front runner, stalker, and closer) are displayed.

A various-kinds-of-information display field 188 is displayed below the aptitude information display field 187. A skill display tab 188a, an inheritance information display tab 188b, a nurturing information display tab 188c, and a close operation section 188d are provided in the various-kinds-of-information display field 188. When the skill display tab 188a is tapped, the earned skills of the nurtured character are displayed in the various-kinds-of-information display field 188, as shown in FIG. 12. In addition, when the inheritance information display tab 188b is tapped, inheritance information concerning the nurtured character is displayed, as shown in FIG. 13.

Note that the various-kinds-of-information display field 188 shows inheritance information on the basis of the nurtured character that can be set as an inheritance character and the inheritance characters used to nurture the nurtured characters. The inheritance information includes information concerning the inheritance characters used to nurture the nurtured character, factor information possessed by the nurtured character, and factor information possessed by the inheritance characters. Here, inheritance information is listed for each of the nurtured characters.

More specifically, factor information tied to the nurtured character and factor information tied to the inheritance characters of the nurtured character are displayed for each of the characters. Therefore, the player can confirm factor information possessed by each of the three characters by scrolling the various-kinds-of-information display field 188 in the up/down direction.

In the various-kinds-of-information display field 188, base ability factors, aptitude factors, and character factors are displayed in different colors. For example, the base ability factors are displayed in blue, the aptitude factors are displayed in red, and the character factors are displayed in green. Note that in the various-kinds-of-information display field 188, the race factors and the skill factors are displayed in white. In addition, stars indicating the factor level are displayed so as to be superimposed on the factor information.

Also, when the nurturing information display tab 188c is tapped, nurturing information concerning the nurtured character is displayed, as shown in FIG. 14. Note that the nurturing information includes support card types used to nurture the nurtured character, the characters of the inheritance first generation and the inheritance second generation, individual race records in the nurturing game, and furthermore the evaluation score.

Thus, the player can confirm various items of information concerning the nurtured character in the character details dialog 185A. Therefore, it becomes easier for the player to grasp information tied to the inheritance characters organized in the deck, thereby enhancing convenience to the player.

Note that when the close operation section 188d is tapped on the character details dialog 185A, the character details dialog 185A is closed, and the nurtured character list screen 180 is displayed on the display 26. In addition, as shown in FIGS. 7A, 7B, 7C, and 7D, a skill display button 172 is provided in the upper right section of the inheritance character selection screen 170 and the nurtured character list screen 180. When the skill display button 172 is tapped, the skills that may be earned due to the nurtured character temporarily selected as an inheritance character are listed.

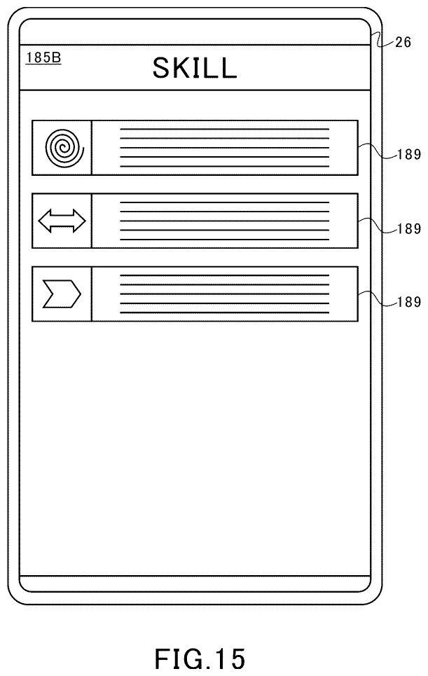

FIG. 15 is a drawing for illustrating a skill display dialog 185B. In the skill display dialog 185B, skill description display fields 189 indicating icons corresponding to skills and content of the skills are displayed. The skills listed in these skill description display fields 189 constitute all skills that may be earned by the main character when the currently selected nurtured character is used as an inheritance character.

Namely, the skill display dialog 185B lists information concerning skills tied to the character factor or skill factors possessed by the nurtured character. As shown in FIG. 7C, when the skill display button 172 is tapped in a state in which one nurtured character is selected as an inheritance character, the skills tied to the character factor and race factors possessed by this one nurtured character (inheritance character) are displayed in the skill display dialog 185B.

On the other hand, when the skill display button 172 is tapped in a state in which two nurtured characters are selected as inheritance characters, as shown in FIG. 7D, the skills tied to the character factor and race factors possessed by each of the two nurtured characters (inheritance characters) are displayed on the skill display dialog 185B.

As described above, in this embodiment, the character details dialog 185A lists inheritance information (factor information) for each of the nurtured characters that can be set as inheritance characters. The skill display dialog 185B also lists information (skills) tied to the inheritance information (factor information). At this time, the character details dialog 185A and the skill display dialog 185B are displayed on the basis of the nurtured character that can be set as an inheritance character and the inheritance characters used to create the nurtured character. Display of the character details dialog 185A and the skill display dialog 185B enhances convenience to the player.

Here, the present embodiment has been described by way of an example where skills that can be earned as a result of factors being invoked are displayed in the skill display dialog 185B. It should be noted, however, that factor information that allows a hint for a skill to be earned, instead of information concerning skills, may be displayed in the skill display dialog 185B. In any case, it is a good idea to classify inheritance information (factor information) into a plurality of types (factor types) and display inheritance information classified as predetermined types (character factor and race factors) or information tied to the inheritance information (information concerning skills) in the skill display dialog 185B. Thus, it can be said that an extracted portion of the inheritance information is displayed in the skill display dialog 185B.

Also, when two nurtured characters are temporarily selected, the next operation section 154 provided on the inheritance character selection screen 170 is enabled. When the enabled next operation section 154 is tapped, the temporarily selected nurtured characters are temporarily registered in the deck as inheritance characters, and a support card organization screen 190 (described below) is displayed.

Note that on the inheritance character selection screen 170, the player needs to select two nurtured characters as inheritance characters. If two inheritance characters are not temporarily selected, the next operation section 154 is grayed out, as shown in FIGS. 7A and 7C, disabling a player operation from being accepted. In addition, the return operation section 153 is provided on the inheritance character selection screen 170, so that when the return operation section 153 is tapped, the main character selection screen 150 is displayed.

### <Registration of Support Cards>

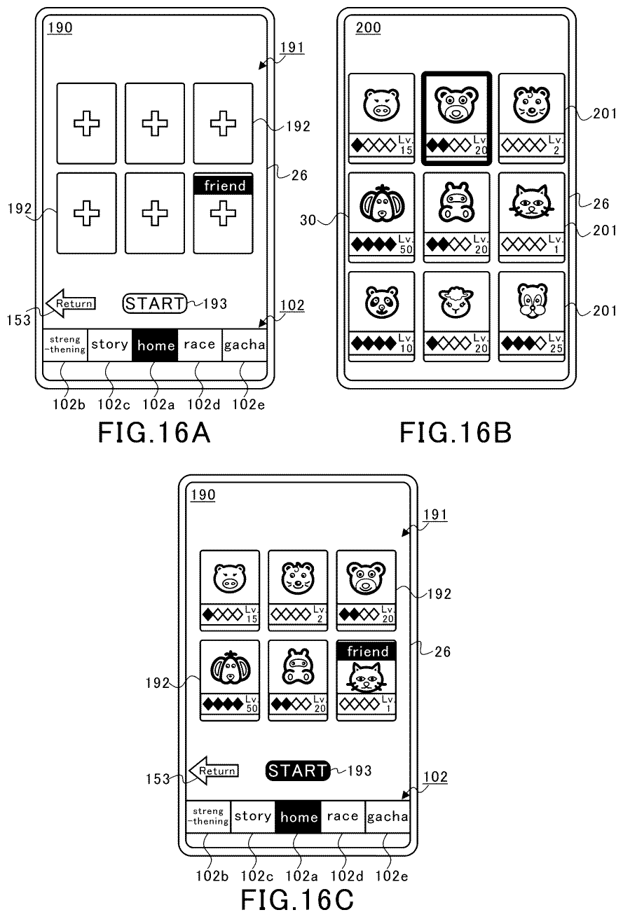

FIG. 16A is a first drawing for illustrating the support card organization screen 190. When two inheritance characters are registered on the inheritance character selection screen 170, the support card organization screen 190 shown in FIG. 16A is displayed. A support card display region 191 is provided in the center of the support card organization screen 190. The support card display region 191 includes a plurality of support card display frames 192. In addition, the return operation section 153 captioned “Return” and a start operation section 193 captioned “START” are displayed in the lower section of the support card organization screen 190.

The plurality of (six here) support card display frames 192 are displayed in the support card display region 191. The same number of support card display frames 192 as the number of support cards that can be set by the player are displayed. Note that in the initial display of the support card organization screen 190, the support card display frames 192 are displayed blank.

In this embodiment, the player can set six kinds of support cards in the deck. Note that some (e.g., five) of the six kinds of support cards that can be set by the player can be selected from among the support cards possessed by the player. In addition, some other (e.g., one) of the six kinds of support cards that can be set by the player can be selected from among the support cards that are set as rental cards by other players such as friends.

FIG. 16B is a drawing for illustrating a support card selection screen 200. When a support card display frame 192 (excluding the support card display frame 192 shown in the lower right section) is tapped on the support card organization screen 190 in FIG. 16A, the support card selection screen 200 shown in FIG. 16B is displayed on the display 26. Card icons 201 corresponding to the support cards possessed by the player are listed on the support card selection screen 200. The player can select a support card by tapping a card icon 201 displayed on the support card selection screen 200.

Although not shown in the figure, when the support card display frame 192 displayed in the lower right section of the support card organization screen 190 is tapped, support cards set as rental cards by friends or players extracted on the basis of a predetermined condition, such as a lottery, are displayed on the support card selection screen 200. At this time, the player can select one of the support cards of the friends by tapping a support card displayed on the support card selection screen 200. Thus, in the nurturing game, the player can use a support card possessed by another player.

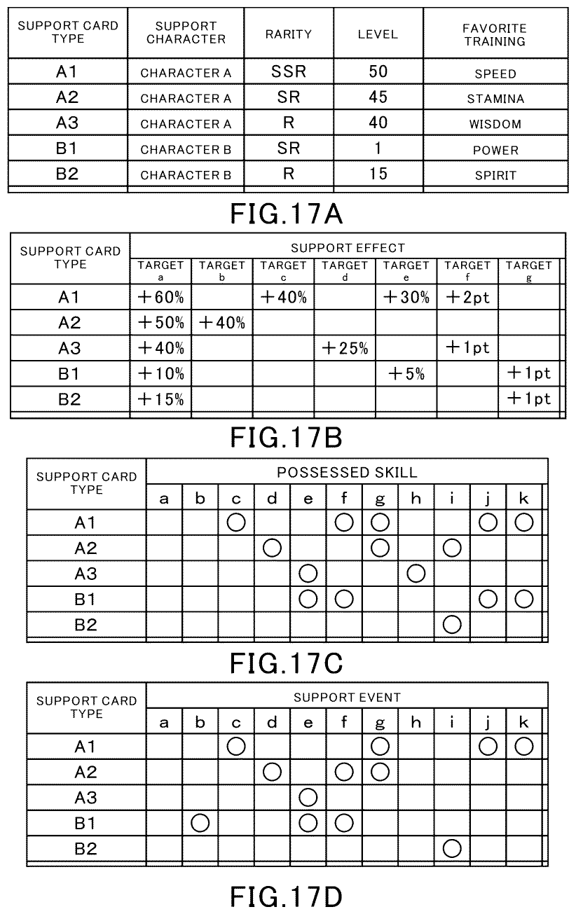

FIG. 17A is a drawing for illustrating a support card table. As shown in FIG. 17A, the support card table stores the kind of support character (i.e., character ID), rarity, level, and favorite training for each of the support card types (i.e., support card IDs) possessed by the player. There is a one-to-one correspondence between the support characters and the support card types. That is, one character ID is always tied to a support card ID. In other words, one support character is always associated with one support card.

In this embodiment, a rarity is set for each of the support cards. There are three stages of rarity: R (rare), SR (super rare), and SSR (super special rare). Note that the rarity is set so that R is the lowest rarity and SSR is the highest rarity. In this embodiment, support cards with higher rarity tend to have more profound support effects, as described below. In addition, in this embodiment, support cards with higher rarity tend to have a larger number of possessed skills and support events described below.

There are 50 levels of support card, from level 1 to level 50. The level of a support card can be increased by the player, and the level increased by the player is stored for each of the support cards. Note that the level of a support card can be increased by using in-game currency or items. Note that the maximum level of a support card is limited according to rarity.

For example, the maximum level of a support card with rarity R is defined as 20, the maximum level of a support card with rarity SR is defined as 25, and the maximum level of a support card with rarity SSR is defined as 30.

Note that the maximum level of a support card can be increased in a stepwise manner when a predetermined condition is satisfied. For example, it is also acceptable that a support card with rarity R can have the maximum level thereof increased to 40, a support card with rarity SR can have the maximum level thereof increased to 45, and a support card with rarity SSR can have the maximum level thereof increased to 50.

FIG. 17B is a drawing for illustrating a support effect table. As shown in FIG. 17B, support effects for each of the support card types possessed by the player are stored in the support effect table.

Support effects work to increase various kinds of statuses in the nurturing main game. A plurality of support effect targets are provided in a support card. Examples of support effect targets include physical strength, speed, stamina, power, spirit, wisdom, etc.

FIG. 17C is a drawing for illustrating a possessed skill table. In the possessed skill table, possessed skills are set for each of the support cards possessed by the player, as shown in FIG. 17C. In this embodiment, each of the support cards has possessed skills set therefor, just as the character set as the main character by the player has possessed skills. The possessed skills set for each of the support cards can be earned by the main character selected by the player when a hint event occurs during the nurturing main game.

FIG. 17D is a drawing for illustrating a support event table. As shown in FIG. 17D, support events that can occur for each of the support cards possessed by the player are stored in the support event table. A support event is an event that may occur during the execution of the nurturing main game. When a support event occurs, the values of various kinds of statuses in the nurturing main game may increase or decrease.

For example, a support event that will occur may be decided according to the turn number, or alternatively, a support event that will occur may be decided by a predetermined lottery. In addition, a plurality of support events that will occur may be selected in one turn. In any case, it suffices if a support event that will occur is decided by a predetermined decision method that has been set in advance.

Note that support events may include a first hint event that can occur when a turn is started in the nurturing game, a second hint event that can occur after the execution of training (described below) in the nurturing game, a first ability event that can occur when a turn is started in the nurturing game, a second ability event that can occur after the execution of training in the nurturing game, etc.

The first hint event and the second hint event are events that enable a skill to be possessed or earned. In addition, the first ability event and the second ability event are events that increase or decrease the numerical values of ability parameters of the character. Hereinafter, the first hint event and the first ability event are collectively referred to as a first event, and the second hint event and the second ability event are collectively referred to as a second event.

FIG. 16C is a second drawing for illustrating the support card organization screen 190. In this embodiment, when all six support cards are selected, the start operation section 193 becomes enabled, as shown in FIG. 16C. On the other hand, when not all six support cards have been selected, the start operation section 193 is disabled, as shown in FIG. 16A.

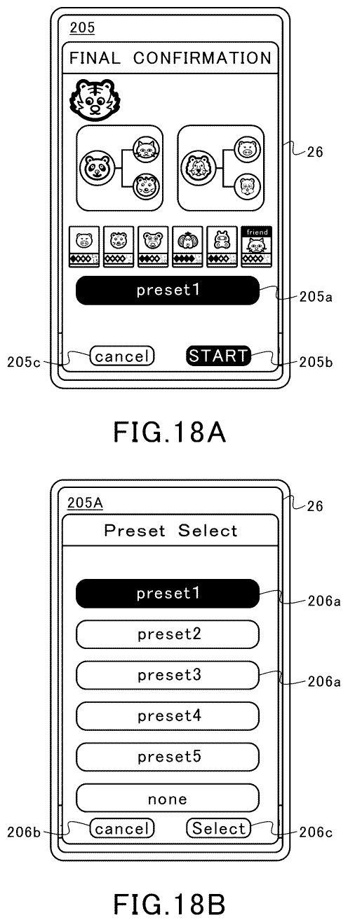

Note that when the return operation section 153 is operated on the support card organization screen 190, the inheritance character selection screen 170 shown in FIG. 7D is displayed on the display 26. Also, as shown in FIG. 16C, when the start operation section 193 is tapped on the support card organization screen 190, the support cards being selected are temporarily registered, and a final confirmation screen 205 (FIG. 18A) is displayed.

FIG. 18A is a drawing for illustrating the final confirmation screen 205. FIG. 18B is a drawing for illustrating a preset selection screen 205A. The main character selected by the player, the nurtured characters constituting the first inheritance group, the nurtured characters constituting the second inheritance group, and the support cards are displayed on the final confirmation screen 205. A preset display section 205a is also displayed on the final confirmation screen 205. The number of the currently selected preset is indicated in the preset display section 205a.

Here, a preset is reservation information for a race in which the main character is made to run in the nurturing main game. The player can select any race from among all races and generate a preset. The player can save a plurality of presets and can select one of the saved presets on the final confirmation screen 205. More specifically, when the preset display section 205a is tapped, the preset selection screen 205A shown in FIG. 18B is displayed.

On the preset selection screen 205A, preset reading buttons 206a corresponding to the saved presets are displayed. The player can set a preset by tapping any one of the preset reading buttons 206a and then tapping a select operation section 206c. Note that when the select operation section 206c is tapped, the preset selection screen 205A is closed, and the final confirmation screen 205 is displayed. In addition, when a cancel operation section 206b on the preset selection screen 205A is tapped, the preset selection screen 205A is displayed without changing the preset.

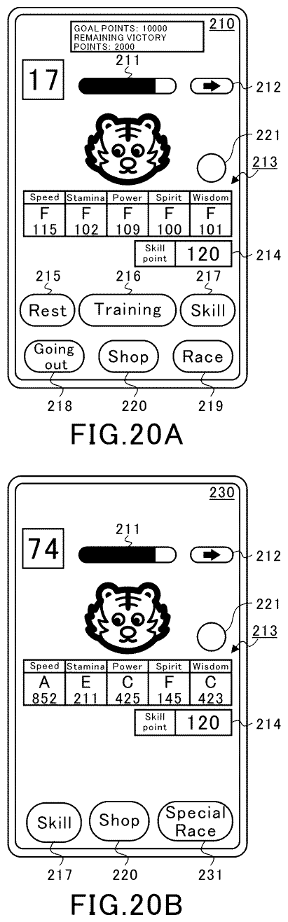

Note that when a cancel operation section 205c is tapped on the final confirmation screen 205, the support card organization screen 190 is displayed. On the other hand, when a start operation section 205b is tapped, a game screen 210 (FIG. 20A) is displayed on the display 26.

Note that this embodiment is restricted so that the character type set as the main character and the character type set as a support character are not the same when the support cards are registered.

As described above, when the main character, inheritance characters, and support cards are registered, the preparatory-stage process ends.

### <Nurturing-Stage Process>

After the preparatory-stage process is completed, the nurturing-stage process starts. In the nurturing-stage process, the main character can be nurtured. Note that for the sake of ease of understanding, the basic flow of the nurturing main game is described first.

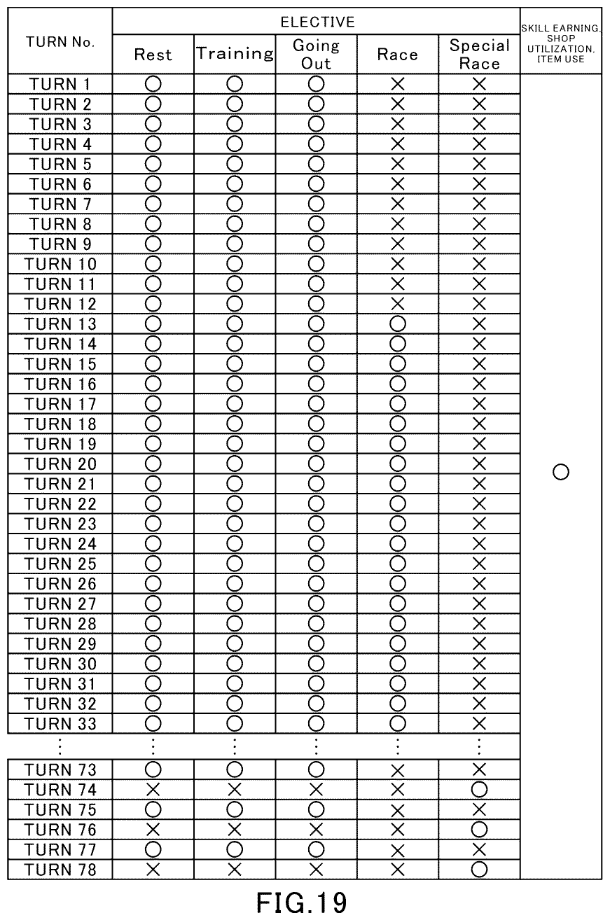

FIG. 19 is a drawing for illustrating an elective table. Note that here, an elective table is provided for each type of the main character. It should be noted, however, that a common elective table may be provided regardless of the type of the main character. As shown in FIG. 19, the nurturing game is composed of turns 1 through 78, and has gameplay in which various kinds of parameters are updated according to the results of selections made by the player in each of the turns. In addition, according to the elective table, the electives that can be selected by the player are set in advance for each of the turns.

FIG. 20A is a drawing for illustrating the game screen 210. FIG. 20B is a drawing for illustrating a special race screen 230. Upon transition to the nurturing-stage process, the game screen 210 shown in FIG. 20A is displayed on the display 26. In the upper section of the game screen 210, a physical strength display section 211 and a physical condition display section 212 are displayed. The main character has a “physical strength” parameter. The “physical strength” parameter is mainly used to calculate a failure rate, which is the probability of failure in training, as described below. The physical strength display section 211 is displayed so that the current remaining amount of “physical strength” of the main character can be visually grasped with respect to the upper limit of “physical strength”.

In addition, the main character also has a “physical condition” parameter. The physical condition display section 212 is displayed so that the current “physical condition” of the main character can be visually grasped at a plurality of stages (five stages: very bad shape, bad shape, normal, good shape, and great shape). The higher the “physical condition” parameter, the more advantageous to the main character the proceeding of the race, and the larger the increase values of ability parameters due to training.

In addition, as shown in FIG. 20A, the image of the main character, a status display section 213, and a skill point display section 214 are displayed in the center of the game screen 210. In the status display section 213, the current statuses of the main character are indicated in numerical values and a plurality of ranks (16 ranks: G+, F, F+, E, E+, D, D+, C, C+, B, B+, A, A+, S, SS, and SS+). More specifically, the numerical values and ranks of the following ability parameters are displayed in this embodiment: “Speed”, “Stamina”, “Power”, “Spirit”, and “Wisdom”. In addition, the remaining amount of skill points possessed by the main character in the nurturing game is indicated numerically in the skill point display section 214.

Also, as shown in FIG. 20A, in the lower section of the game screen 210, a rest operation section 215 captioned “Rest”, a training operation section 216 captioned “Training”, a skill operation section 217 captioned “Skill”, an outing operation section 218 captioned “Going Out”, an individual race operation section 219 captioned “Race”, and a shop operation section 220 captioned “Shop” are displayed. In addition, the current turn number is also displayed in the upper section of the game screen 210. An item operation section 221 is also displayed in the center section of the game screen 210.

As shown in FIG. 19, the player can select, in each of the turns, any of the electives including “Rest” (rest operation section 215), “Training” (training operation section 216), “Going Out” (outing operation section 218), “Race” (individual race operation section 219), and “Special race” (special race operation section 231, described below). At this time, the electives that can be selected in each of the turns are set in advance, as shown in FIG. 19.

When the elective “Rest” is selected, the physical strength is recovered, and when the elective “Going Out” is selected, the physical condition increases. In addition, when the elective “Training” is selected, training (described below) can be executed, when the elective “Race” is selected, the main character can be made to run in an individual race, and when the elective “Special race” is selected, the main character can be made to run in a special race (described below). When these electives “Rest”, “Training”, “Going Out”, “Race”, and “Special race” are selected and game results are derived, the current turn ends and transitions to the next turn.

In this embodiment, some turns are set so as not to allow the selection of the electives corresponding to the rest operation section 215, training operation section 216, outing operation section 218, and individual race operation section 219, as seen in turn 74, turn 76, and turn 78 in FIG. 19. In these turns, the special race screen 230 is displayed on the display 26, as shown in FIG. 20B.

The special race operation section 231 captioned “Special race”, the skill operation section 217, the shop operation section 220, and the item operation section 221 are displayed on the special race screen 230, so that the player can select any of these operation sections. When the special race operation section 231 is selected, a special race, which differs from an individual race that is executed when the individual race operation section 219 is selected, is executed. A total of three special races are executed, one in each of the 74th turn, 76th turn, and 78th turn, and a championship is decided on the basis of the cumulative total value of victory points (described below).

On the other hand, the skill operation section 217, the shop operation section 220, and the item operation section 221 are always enabled in all turns. Although described below in detail, these turns do not end even if a skill is earned, a shop is used, and an item is used by operating the skill operation section 217, the shop operation section 220, and the item operation section 221, respectively.

In this embodiment, when an individual race or a special race is executed, the main character can earn victory points and special currencies according to the finish place in the race. The number of earnings of victory points and special currencies for each finish place are defined in each of the races. The higher the finish place, the larger the numerical values of the victory points and the special currencies to be earned.

In addition, the higher the difficulty level of a race, the more victory points and special currencies the main character can earn in the race. For example, in the grades GI, GII, and GIII, the higher the grade of a race, the more victory points and special currencies the main character can earn in the race.

In the nurturing game of this embodiment, goal points defined in advance are set for each specified turn segment. As described above, in this embodiment, a nurturing game is composed of the first turn through the 78th turn. Here, the first turn through the 24th turn are referred to as an initial turn segment, the 25th turn through the 48th turn are referred to as a mid-turn segment, the 49th turn through the 72th turn are referred to as a late turn segment, and the 73th turn through the 78th turn are referred to as an ending turn segment.

Goal points are set in each of the initial turn segment, mid-turn segment, and late turn segment. The goal points set in the turn segments may be the same or different. The player can proceed with the nurturing game to the ending turn segment by sequentially achieving the goal points in each of the turn segments by earning the cumulative total value of victory points.

Also, goal points are set on the basis of aptitude parameters related to the racetrack aptitude and aptitude parameters related to the distance aptitude of the main character to be nurtured. For example, the goal points of a main character having a turf aptitude parameter higher than the dirt aptitude parameter are set to be higher than the goal points of a main character having a dirt aptitude parameter higher than the turf aptitude parameter. In addition, goal points that differ depending on, for example, the highest of the short distance, mile, intermediate distance, and long distance aptitude parameters may be set. Also, goal points that differ depending on the combination of aptitude parameters related to the racetrack aptitude and the distance aptitude may be set. Thus, the goal points set for each main character may differ in some cases depending on aptitude parameters related to the racetrack aptitude and the distance aptitude. Note that the goal points may be set on the basis of aptitude parameters related to the running style aptitude, in addition to the racetrack aptitude and the distance aptitude, of the main character.

In the upper section of the game screen 210 shown in FIG. 20A, goal points in the current turn segment and remaining victory points indicating the victory points that need to be earned until the goal points are reached are displayed. As a result of the goal points and the remaining victory points being displayed, the player can grasp victory points to be earned in the current turn segment.

Note that the victory points earned by the player are reset in each of the initial turn segment, the mid-turn segment, and the late turn segment. It should be noted, however, that the victory points earned by the player may be sequentially accumulated without being reset in each of the turn segments.

When the goal points are achieved in all of the initial turn segment, the mid-turn segment, and the late turn segment, the player can proceed to the nurturing game in the ending turn segment. In the ending turn segment, a total of three special races (first race, second race, and third race) are executed, and a championship is decided on the basis of the cumulative total value of victory points according to race results.

The further the special race proceeds, the larger the victory points that can be earned. More specifically, among all the three races, the value of victory points that can be earned when the first place is won in the second race is larger than the value of victory points that can be earned when the first place is won in the first race, and the value of victory points that can be earned when the first place is won in the third race is larger than the value of victory points that can be earned when the first place is won in the second race.

In addition, so-called non-player characters (hereinafter, referred to as NPCs) that run in all the three races to compete with the main character are NPCs having the same character ID. It should be noted, however, that the further the special race proceeds, the higher the set parameters of the NPCs. For example, the ability parameters of the NPCs are increased by increasing the correction value to be added to the ability parameters of the NPCs in the order of the first race, the second race, and the third race. Note that in the ending turn segment, even if the place in a special race is a predetermined place or lower (e.g., second place or lower), the special race can be continued without ending the nurturing game.

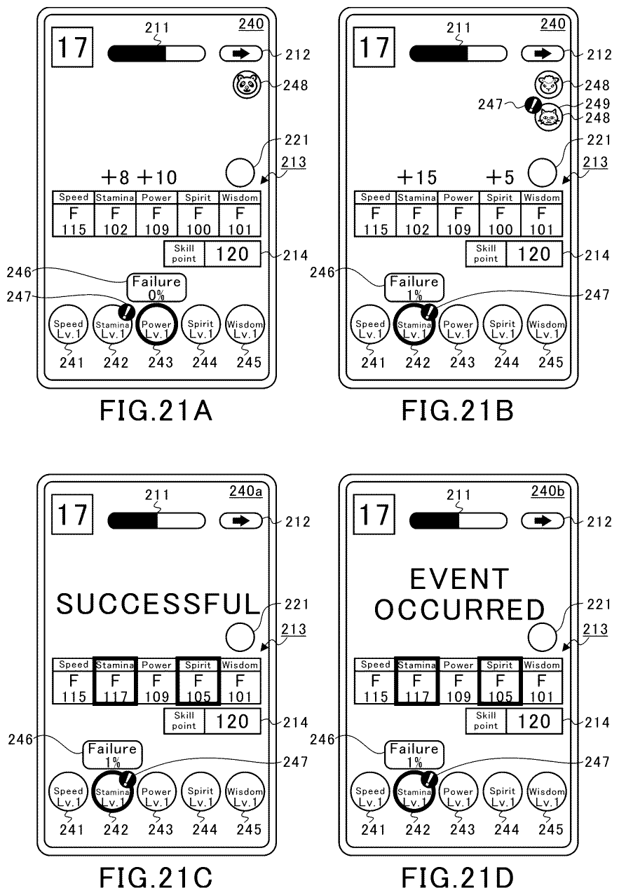

FIG. 21A is a first drawing for illustrating a training screen 240. FIG. 21B is a second drawing for illustrating the training screen 240. When the training operation section 216 on the game screen 210 is operated, the training screen 240 is displayed on the display 26.

As shown in FIG. 21A, training courses are displayed in the lower section of the training screen 240. Here, a speed operation section 241 captioned “Speed”, a stamina operation section 242 captioned “Stamina”, a power operation section 243 captioned “Power”, a spirit operation section 244 captioned “Spirit”, and a wisdom operation section 245 captioned “Wisdom” are displayed.

When the player taps one of the operation sections 241 to 245 once, the training course corresponding to the tapped one of the operation sections 241 to 245 is temporarily selected, and the one of the operation sections 241 to 245 corresponding to the temporarily selected training course is highlighted. FIG. 21A shows that the power operation section 243 is temporarily selected. In addition, FIG. 21B shows that the stamina operation section 242 is temporarily selected.

Training levels for the training courses are also displayed on the respective operation sections 241 to 245. A training level is a parameter that increases on the basis of the number of times the training course is selected, and the higher the training level, the greater the increase values of ability parameters when the training is executed. A training level is initially set to level 1 and increases to a maximum of level 5.

In addition, a failure rate display section 246 captioned “Failure” is displayed on the temporarily selected one of the operation sections 241 to 245. The failure rate numerically displayed in the failure rate display section 246 is set to increase inversely proportionally to the remaining amount of physical strength displayed in the physical strength display section 211.

In addition, the status display section 213 displays the values by which the ability parameters are increased when the training corresponding to the temporarily selected one of the operation sections 241 to 245 is successfully executed. For example, in the example shown in FIG. 21A, the power operation section 243 is temporarily selected, and “+8” and “+10” are displayed for “Stamina” and “Power”, respectively, in the status display section 213. In addition, in the example shown in FIG. 21B, the stamina operation section 242 is temporarily selected, and “+15” and “+5” are displayed for “Stamina” and “Spirit”, respectively, in the status display section 213.

In addition, an event report indicator 247 is displayed in any of the operation sections 241 to 245 corresponding to a training course in which a predetermined event occurs when the training is successfully executed. Note that the event report indicator 247 can be displayed in different manners depending on the event type.

In addition, as shown in FIG. 21B, in the upper right section of the training screen 240, placement character icons 248 of the characters placed in training are displayed for the training course corresponding to the temporarily selected one of the operation sections 241 to 245. Also, in the case where a predetermined event occurs corresponding to the character displayed on a placement character icon 248 when the training is successful, an event report indicator 247 is displayed on the corresponding placement character icon 248. Hereinafter, a placement character icon 248 on which the event report indicator 247 is displayed is referred to as an event placement character icon 249. Note that hereinafter, training in which a character is placed is referred to as joint training.

In this embodiment, a character placed in training is a support character. When training in which a support character is placed is executed, a second event tied to the placed support character may occur in some cases. In the case where this second event occurs, the event report indicator 247 is displayed on the placement character icon 248. When training in which a support character is placed is successful, a parameter increase value of the main character is larger than when training in which no support characters are placed is successful.

Note that, without limitation to this, a character placed in training may be a character other than the support characters corresponding to support cards registered by the player in the preparatory-stage process. For example, a character placed in training may be a character randomly selected by lottery from among all the support characters implemented in the game. In this case, a character icon 248 indicating a character other than the support characters registered by the player is displayed on the training screen 240. In addition, when training in which a character icon 248 is displayed is executed, an event tied to a character other than the support characters registered by the player may occur. Here, the probability that an event tied to a character not registered by the player occurs is lower than the probability that an event tied to a support character registered by the player occurs. Also in this case, an event report indicator 247 may be displayed on the character icon 248 displayed on the training screen 240.

FIG. 21C is a drawing for illustrating a training result report screen 240a. When temporarily selected one of the operation sections 241 to 245 is tapped again, the training corresponding to the tapped one of the operation sections 241 to 245 is executed. When the training is executed, the training result report screen 240a is displayed on the display 26 to report success or failure in the training. Here, the word “success” is displayed to inform the player of success in the training.

Also at this time, on the basis of the success in the training, the ability parameters in the status display section 213 are updated and displayed. Namely, the ability parameters (ability information) that belong to the main character and that correspond to the training course (nurturing type) selected by the player are updated.

Here, the values of the ability parameters that are displayed in the status display section 213 in FIG. 21A or FIG. 21B and that will add to the ability parameters when the training is successful are added. In addition, the display in the physical strength display section 211 is also updated according to the training course executed. When the speed, stamina, power, or spirit training is successfully executed, the physical strength is decreased. On the other hand, when the wisdom training is successfully executed, the physical strength is recovered.

In addition, if the training fails, a predetermined penalty is given. Specific penalties include a decrease in physical strength, a decrease in the numerical value of an ability parameter, a decrease in physical condition, etc. For example, a penalty given when the failure rate is high can be more disadvantageous (e.g., a greater decrease in the numerical value of the physical strength, a greater decrease in the numerical value of an ability parameter, or a greater decrease in the stage of the physical condition) than a penalty given when the failure rate is low.

Content of a penalty may also be decided depending on the training course. For example, a failure in speed training may result in a decrease in the value of the speed ability parameter, and a failure in power training may result in a decrease in the value of the power ability parameter. Also, for some of the training courses (e.g., wisdom), no penalty may be given even if the training fails.

FIG. 21D is a drawing for illustrating an event screen 240b. When the display of the training result report screen 240a ends, the event screen 240b may be displayed on the display 26. Various events are executed on the event screen 240b. Note that in some cases, a plurality of events may occur in one turn.

For example, when a first hint event or a second hint event occurs, a hint for a skill is obtained. Once a skill is hinted, the player can earn the skill by consuming skill points. A plurality of kinds of skills are provided, and a predetermined ability may be invoked for each of the skills. Each of the skills has an invoking condition and an effect defined therefor, so that when an invoking condition is satisfied, an effect defined in advance is invoked. In some cases, a skill may be invoked during the execution of an individual race, as described below.

Events include, apart from a first hint event and a second hint event for possessing skills: an event for recovering the physical strength; an event for decreasing the physical strength; a first ability event and a second ability event for increasing or reducing ability parameters; an event for increasing the physical condition; an event for decreasing the physical condition; etc. Although described below in detail, events include an event the occurrence turn of which is defined in advance and an event that occurs when a predetermined lottery is won. There are also an event occurring at the time a turn is started and an event occurring before a turn ends. When all events that have occurred are completed, the game screen 210 related to the next turn is displayed.

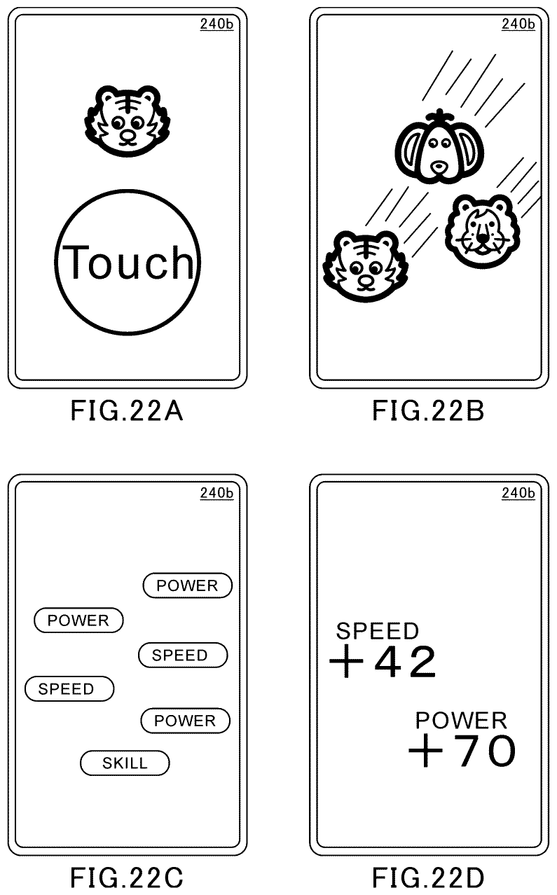

FIG. 22A is a first drawing for illustrating an inheritance event. FIG. 22B is a second drawing for illustrating an inheritance event. FIG. 22C is a third drawing for illustrating an inheritance event. FIG. 22D is a fourth drawing for illustrating an inheritance event. In the aforementioned factor-invoking turns, an inheritance event occurs when a turn is started. Note that this inheritance event is a scenario-common event (described below) and always occurs in the same turns, regardless of the scenario selected by the player. Although the first turn, the 30th turn, and the 54th turn are set as factor-invoking turns in this embodiment, a case where an inheritance event occurs in the 30th turn will be described here.

When the 30th turn is started, first the main character and an operation section captioned “Touch” are displayed on the event screen 240b, as shown in FIG. 22A. When the operation section displayed on the event screen 240b is tapped, an animation image containing the main character and the two inheritance characters is displayed, as shown in FIG. 22B. Also, when the operation section is tapped, a lottery for deciding whether or not to invoke each of all the factors possessed by a total of six nurtured characters of the inheritance first generation and the inheritance second generation is drawn.

Then, the factors that have been decided to be invoked as a result of winning the lotteries for deciding whether or not to invoke the respective factors are displayed, as shown in FIG. 22C, and thereafter, the kinds of ability parameters or aptitude parameters that increase as a result of factors being invoked, as well as increase values thereof, are displayed, as shown in FIG. 22D, whereby the parameters are updated. When the inheritance event ends, the game screen 210 shown in FIG. 20A is displayed, allowing the player to select any of the electives. At this time, the increase values of the ability parameters and the aptitude parameters displayed due to the inheritance event are add in the status display section 213.

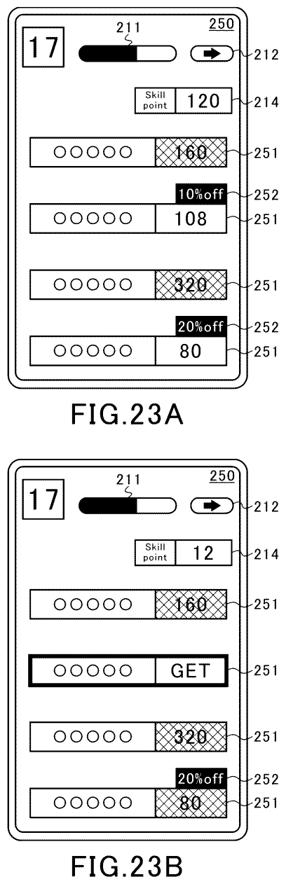

FIG. 23A is a first drawing for illustrating a skill screen 250. FIG. 23B is a second drawing for illustrating the skill screen 250. When the skill operation section 217 on the game screen 210 is operated, the skill screen 250 shown in FIG. 23A is displayed on the display 26.

Skill display fields 251 are displayed on the skill screen 250. An earned skill, a possessed skill that is set in advance in the main character, a possessed skill that has been possessed due to the occurrence, etc. of various kinds of events, and so on are displayed in the skill display fields 251. In addition, when a first hint event or a second hint event occurs for a possessed skill, skill points consumed to earn this skill are discounted. Here, for a possessed skill that has been hinted, the skill points required to earn the possessed skill are displayed in terms of a discounted value. At this time, a discount rate display icon 252, which indicates the discount rate, is also displayed in the skill display field 251.

In addition, skills displayed on the skill screen 250 are also indicated with the respective skill invoking conditions and the respective effects that are produced when the skills are invoked.

In addition, the physical strength display section 211, the physical condition display section 212, and the skill point display section 214 are displayed in the upper section of the skill screen 250. The current turn number is also displayed in the upper section of the skill screen 250.

When a possessed skill is earned by consuming skill points on the basis of a player operation, “GET” is displayed on the earned skill to report that the skill has been earned, as shown in FIG. 23B, thereby causing the display to be updated as a result of the consumed skill points being subtracted from the skill points displayed in the skill point display section 214.

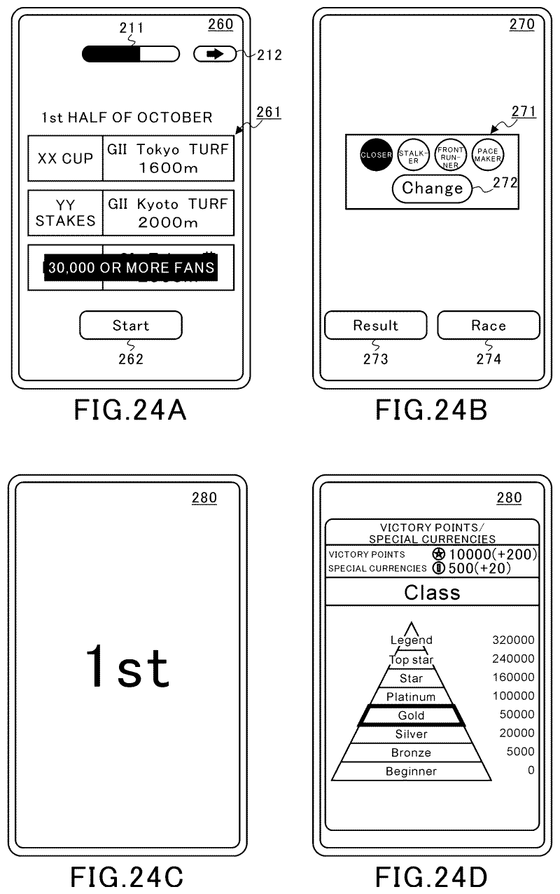

FIG. 24A is a first drawing for illustrating an individual race selection screen 260. When the individual race operation section 219 on the game screen 210 is operated, the individual race selection screen 260 shown in FIG. 24A is displayed. An individual race has gameplay in which the main character races against NPCs.

In the upper section of the individual race selection screen 260, the physical strength display section 211 and the physical condition display section 212 are displayed. Also, an individual race selection operation section 261 for selecting a race category in which the main character is made to run is displayed in the center of the individual race selection screen 260. If a plurality of individual race selection operation sections (sub-commands) 261 are displayed on the individual race selection screen 260, individual races different from one another are set in the plurality of individual race selection operation sections 261. In addition, in the lower section of the individual race selection screen 260, a start operation section 262 captioned “Start” is displayed. Note that races that can be selected with the individual race selection operation sections 261 on the individual race selection screen 260 are set in advance for each of the turns.

In addition, each of the races has a race-participating condition set therefor in advance, so that the player is allowed to cause the main character to run only in races satisfying the respective race-participating conditions thereof. As described above, earning a certain number of fans is specified as a race-participating condition in some races. A race-participating condition is displayed in the individual race selection operation section 261 for a race that does not satisfy the specified number of fans, as shown in FIG. 24A, thereby informing the player that the race cannot be selected. Also, in a turn having a target race as a clearance goal set therein, the individual race selection screen 260 is displayed such that only the target race can be selected.

FIG. 24B is a drawing for illustrating an individual race start screen 270. When the start operation section 262 is operated while the race category of an individual race in which the main character will run is selected in the individual race selection operation section 261, the individual race start screen 270 shown in FIG. 24B is displayed. A strategy display section 271 is displayed in the center of the individual race start screen 270. In the strategy display section 271, not only is the currently selected strategy (closer, stalker, front runner, or pace maker) highlighted but also a change operation section 272 captioned “Change” is displayed. When the change operation section 272 is operated, a strategy change screen (not shown in the figure) is displayed on the display 26. The player can change the strategy in the individual race to any strategy via an operation on the strategy change screen.

A result operation section 273 captioned “Result” and a race operation section 274 captioned “Race” are also displayed in the lower section of the individual race start screen 270.

When the race operation section 274 is operated, a race screen (not shown in the figure) is displayed on the display 26. On the display 26, a video showing the proceeding of the race (hereinafter, also referred to as a race video) appears.

FIG. 24C is a first drawing for illustrating an individual race result screen 280. FIG. 24D is a second drawing for illustrating the individual race result screen 280. When playback of the aforementioned race video is completed and when the result operation section 273 is operated, the individual race result screen 280 is displayed on the display 26. On the individual race result screen 280, the finish place of the main character in the individual race is displayed, as shown in FIG. 24C. On the individual race result screen 280, the current class of the main character is also displayed, as shown in FIG. 24D.

In this embodiment, the main character is categorized into classes according to the number of earned fans. Each of the classes has a range of the number of fans set therefor, and here, the main character is categorized as one of eight classes according to the number of fans. The number of fans, victory points, and special currencies earned in this individual race are displayed on the individual race result screen 280. In addition, a total number of fans obtained by adding the number of newly earned fans to the number of fans that were earned before is displayed on the individual race result screen 280. Also, the current class corresponding to the total number of fans is identifiably displayed. In addition, a total number of victory points obtained by adding the number of newly earned victory points to the number of victory points that were earned before and a total number of special currencies obtained by adding the newly earned special currencies to the special currencies that were earned before are numerically displayed on the individual race result screen 280.

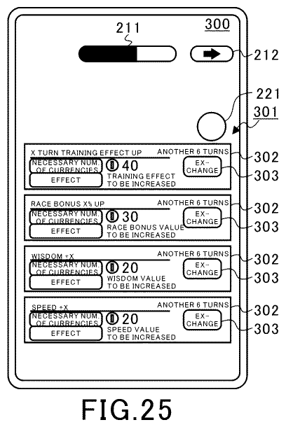

FIG. 25 is a drawing for illustrating an example of an item exchange screen 300. For example, when the shop operation section 220 on the game screen 210 shown in FIG. 20A is tapped, the item exchange screen 300 shown in FIG. 25 is displayed. By consuming special currency earned by the player on the item exchange screen 300, the player can exchange special currency for a predetermined item displayed on the item exchange screen 300. Note that on the game screen 210 shown in FIG. 20A, the total number of special currencies possessed by the player may be superimposed in the lower section of the shop operation section 220.

As shown in FIG. 25, the item operation section 221 and an item exchange list 301 are displayed on the item exchange screen 300. At least one item exchange tab 302 is displayed in the item exchange list 301.

In the item exchange tab 302, the name of an item (item name) that can be obtained by the player in exchange, an effect of the item, the number of special currencies needed to obtain the item in exchange, indication of exchange deadline, and an item exchange operation section 303 are displayed. An exchange deadline is indicated on each of the item exchange tabs 302 in the form of, for example, the number of remaining turns from the current turn to the turn in which the player can obtain the item in exchange. On the item exchange screen 300, items are replaced at regular intervals (predetermined turns). The exchange deadline for an item is the number of turns remaining before this item is replaced. Also, in item exchange, a sale may be held at a certain rate by drawing a lottery in each of the turns during the nurturing game. The period during which a sale continues is, for example, from the turn in which the sale has occurred to the turn in which the next replacement of the item is performed. During a sale period, the number of special currencies required to obtain the item in exchange is smaller than outside the sale period.

Examples of items that can be obtained by the player in exchange include: a parameter change item; a status granting item; a training level change item; a skill-hint earning item; a character re-placement item; a training effect change item; a physical strength consumption item; a failure rate change item; and an event parameter change item.

A parameter change item is an item for changing parameters of the main character. For example, a parameter change item increases, by a predetermined value, the values of applicable parameters of the main character among speed, stamina, power, spirit, wisdom, physical strength, physical strength upper limit, physical condition, skill points, and the number of fans.

A status granting item is an item for granting a status to the main character. For example, a status granting item grants an advantageous status or a disadvantageous status to the main character. Examples of an advantageous status include a status for increasing the amount of increase in various kinds of parameters of the main character, a status for decreasing the consumption of skill points needed to earn a skill, etc. In addition, examples of a disadvantageous status include a status for causing an event that decreases, etc. various kinds of parameters of the main character to occur, a status for inhibiting an increase in various kinds of parameters, etc.

A training level change item is an item for changing the training level of each of the training courses. For example, a training level change item increases, by a predetermined value, the training levels of applicable training courses among speed, stamina, power, spirit, and wisdom.

A skill-hint earning item is an item for allowing the main character to possess or earn a skill by causing a skill event to occur. For example, a skill-hint earning item allows the main character to possess or earn various skills shown in FIG. 6C.

A character re-placement item is an item for re-placing, into other training, a character placed in predetermined training, as shown in FIGS. 21A and 21B. Re-placement of a character will be described below.

A training effect change item is an item for changing a training effect resulting from training during a certain time period. More specifically, a training effect change item increases, by a predetermined value, an increase-fixed value (described below) of an ability parameter of the main character resulting from training during a certain time period. For example, during turn X, a training effect change item increases, by X %, an increase-fixed value of an ability parameter resulting from applicable training among the training courses (speed, power, spirit, stamina, and wisdom).

A physical strength consumption item is an item for increasing a training effect by increasing the consumption of the physical strength in training. More specifically, a physical strength consumption item increases, by a predetermined value, an increase-fixed value (described below) of an ability parameter of the main character resulting from training. A physical strength consumption item can increase a training increase effect when used in combination with a training effect change item.

A failure rate change item is an item for changing the failure rate of an applicable training course. For example, a failure rate change item decreases, by a predetermined value, the failure rate of applicable training among the training courses (speed, power, spirit, stamina, and wisdom).

An event parameter change item is an item for changing a parameter change value of the main character that is granted when an event occurs after a race. For example, an event parameter change item increases, by a predetermined value, applicable parameter change values among speed, stamina, power, spirit, wisdom, physical strength, physical strength upper limit, physical condition, skill points, and the number of fans of the main character.

Examples of a training effect change item, an event parameter change item, and a parameter change item are displayed in the item exchange list 301 shown in FIG. 25. When the item exchange operation section 303 of each of the item exchange tabs 302 is tapped, a subtraction process for subtracting the necessary number of special currencies indicated on the item exchange tab 302 from the cumulative total value of special currencies earned by the player and a granting process for granting the player the item indicated on the item exchange tab 302 are executed. At least some of the items that can be obtained in exchange on the item exchange tabs 302 are finite items the number of exchanges (i.e., number of purchases) of which is limited to a predetermined number or less. When the number of granted finite items reaches the upper limit, the player cannot obtain the finite item in exchange even though he/she has special currency.

In addition, when the item operation section 221 is tapped, an item use screen (not shown in the figure) is displayed on the display 26. On the item use screen, the items possessed by the player are listed. The list of items includes items obtained in exchange on the item exchange screen 300. Namely, items granted to the player in exchange for special currency are displayed on the item use screen. Note that items obtained in various kinds of events may be displayed on the item use screen. The player can use various kinds of items by tapping an item displayed on the item use screen.

In this embodiment, by operating the item operation section 221, the player can use various items (parameter change item, status granting item, training level change item, skill-hint earning item, character re-placement item, training effect change item, physical strength consumption item, failure rate change item, and event parameter change item) that were obtained in exchange for special currency on the respective screens. When each of the items is used, an icon indicating an effect currently produced as a result of the item being used may be displayed on the training screen 240 shown in, for example, FIG. 21A. At this time, the effect-produced turn number in which an effect is produced as a result of the item being used may be additionally displayed in the lower section of the icon. Note that each of the items has an exchangeable time period set therefor, as shown in FIG. 25. The player can exchange each of the items for special currency in an exchangeable time period set for each item. Note that each of the items does not need to have an exchangeable time period set therefor.

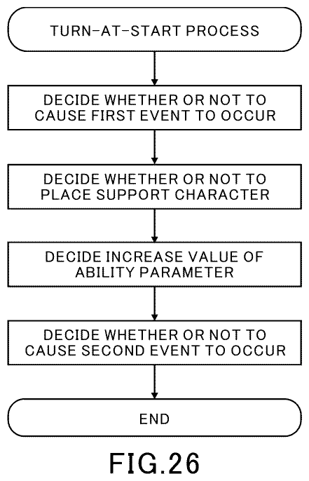

FIG. 26 is a drawing for illustrating the general flow of a turn-at-start process. The nurturing-stage process includes the turn-at-start process, which is executed at the start of each of the turns of the nurturing game. Details of the turn-at-start process are described below. Here, the general flow of the turn-at-start process will be described instead.

During the nurturing main game, a process for deciding whether or not to cause various events to occur is executed in each of the turns. Events are roughly classified into three types: a scenario event, the aforementioned dedicated event provided for each main character, and a support event. Note that scenario events, dedicated events, and support events that can occur during the nurturing main game are defined in advance for each scenario.

A scenario event is an event set for each scenario of the nurturing main game. In this embodiment, a plurality of scenarios are provided, and the player can select a scenario. A scenario event occurs for each of the scenarios selected by the player. In other words, scenario events that occur in the nurturing main game are decided on the basis of the scenario selected by the player.

Note that scenario events may include a scenario-specific event and a scenario-common event. A scenario-specific event is an event that is tied to only one scenario. For example, a scenario-specific event tied to the first scenario will occur only if the first scenario is selected, and will not occur if any other scenario is selected.

Also, a scenario-common event is an event that commonly occurs in a plurality of scenarios. Therefore, a scenario-common event occurs both when the first scenario is selected and when the second scenario is selected.

Here, it is assumed that a scenario-specific event and a scenario-common event are provided as a scenario event. It should be noted, however, that only one of the scenario-specific event and the scenario-common event may be provided.

A dedicated event is an event that is set in advance for each character, as described above. In the nurturing main game, there occur dedicated events of the character that has been registered by the player as the main character in the setting game, i.e., in the preparatory-stage process.

A support event is an event that is set in advance for each support card, as described above. In the nurturing main game, there occur support events that are tied to the support cards registered by the player in the setting game. Support events include a first event that can occur at the time a turn starts and a second event that can occur after the execution of training. Whether or not a first event occurs is decided on the basis of a randomly acquired random number and a first event table when a turn is started.

Whether or not a second event occurs is decided on the basis of a randomly acquired random number and a second event table after the execution of a process for deciding a support character to be placed in training. Note that only in the case where a support character is placed in training, it is decided whether or not a second event occurs in relation to the placed support character.

This embodiment assumes that a first event is selected by lottery from among the support events tied to the support cards registered in the deck by the player in the preparatory-stage process. Without limitation to this, however, it may be possible to select a support event tied to a support card selected by lottery from among all support cards implemented in the game. In this case, it is preferable that the probability of selecting a support event tied to a support card registered in the deck is set higher than the probability of selecting a support card event tied to a support card not registered in the deck.

Thus, whether or not a scenario event occurs, etc., is decided on the basis of the scenario. In addition, whether or not a dedicated event and a support event occur, etc. is decided on the basis of the main character and support cards, respectively. These event types are categorized according to information that is referenced when it is decided whether or not the event occurs, etc.

In contrast, in this embodiment, each event is categorized into one of the six event classifications according to the content produced by the occurrence of the event. Here, each event is categorized into one of the following event classifications: a first hint event, a second hint event, a first ability event, a second ability event, an aptitude event, and a story event.

As described above, a first hint event and a second hint event are an event that enables a skill to be possessed or earned. In addition, a first ability event and a second ability event are an event that increases or decreases ability parameters of the main character. An aptitude event is an event that increases or decreases aptitude parameters of the main character. A story event is an event that displays a story related to a character appearing in the nurturing game. In addition to displaying a story, some story events change ability parameters or aptitude parameters.

Here, scenario events include a first hint event, a second hint event, a first ability event, a second ability event, an aptitude event, and a story event. In addition, dedicated events and support events include a first hint event, a second hint event, a first ability event, and a second ability event. Note that dedicated events may include a story event.

In this embodiment, the turn-at-start process includes, in addition to a process for deciding a scenario event and a process for deciding a dedicated event, a “process for deciding whether or not to cause a first event to occur”, a “process for deciding whether or not to place a support character”, a “process for deciding an increase value of an ability parameter”, and a “process for deciding whether or not to cause a second event to occur”, as shown in FIG. 26. The processes are executed in the order of the process for deciding a scenario event, the process for deciding a dedicated event, the “process for deciding whether or not to cause a first event to occur”, the “process for deciding whether or not to place a support character”, the “process for deciding an increase value of an ability parameter”, and the “process for deciding whether or not to cause a second event to occur”. Although various other processes are executed in the turn-at-start process, the processes shown in FIG. 26 will be described in order here.

### <Process for Deciding Whether or not to Cause First Event to Occur>

A first event is selected by lottery from among the support events (first events) tied to the support cards registered by the player in the preparatory-stage process. More specifically, when a turn is started, a random number is randomly acquired, and whether or not to cause a first event to occur and the content of the first event are decided on the basis of the acquired random number and the first event table. The selection ratio of whether a first event is made to “occur” or “not to occur” is set in the first event table. In this embodiment, first events include four types of events: event a, event b, event c, and event d. For example, in the first event table, the probability of causing each of the events (events a to d) to “occur” is set to 20%, and the probability of causing a first event “not to occur” is set to 20%. Note that the selection ratio of first events may be set individually for each of the support cards, namely, support characters.

### <Process for Deciding Whether or not to Place Support Character>

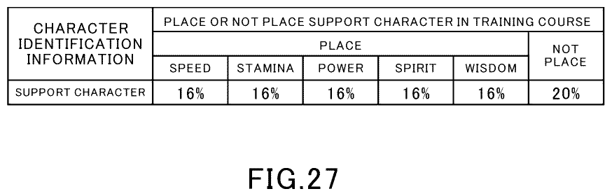

FIG. 27 is a drawing for illustrating a placement probability table. As shown in FIG. 27, the selection ratio of whether or not to place a support character in a training course (“place” or “not place” a support character in any of the training courses) is set in the placement probability table. In this embodiment, whether or not to place each of the support characters corresponding to all the support cards registered by the player in the preparatory-stage process is decided on the basis of the placement probability table shown in FIG. 27. More specifically, when a turn is started, a random number is randomly acquired, and whether or not to place each of the support characters in a training course is decided on the basis of the acquired random number and the placement probability table. Without limitation to this, however, the process for deciding whether or not to place each of the support characters in a training course may be applied to the support characters selected by lottery from among the support characters corresponding to all support cards implemented in the game.

More specifically, in this embodiment, the probability of “placing” a support character in any of the speed, stamina, power, spirit, and wisdom training courses is 16%, and the probability of “not placing” a support character in any of the training courses is 20%, as shown in FIG. 27. Note that a plurality of kinds of favorite training are set in a support character, as shown in FIG. 17A. Thus, for example, the selection ratio of placing a support character in each of the training courses may be set so as to be higher in the case where the support character is placed in a training course corresponding to its favorite training than in the case where the support character is placed in a training course corresponding to training other than its favorite training. When a lottery is to be drawn, a lottery table in which a selection ratio for the lottery is defined may be pre-stored, or alternatively, a lottery table may be generated each time a lottery is drawn.

Note that a training course in which a support character is placed is decided, the support character decided to be placed and the decided training course may be stored in the server 1000 so as to be tied to each other. More specifically, tying information in which the training ID indicating the type of the training course is tied to the character ID of the support character or the support card ID of the support card tied to the support character may be stored in the server 1000.

### <Process for Deciding Increase Value of Ability Parameter>

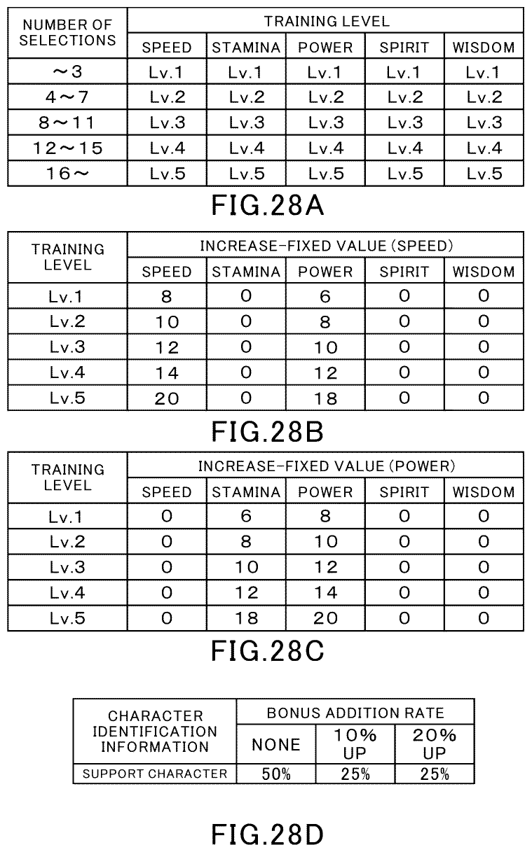

FIG. 28A is a drawing for illustrating a training level table. As shown in FIG. 28A, the training level of each of the training courses is set to increase according to the number of times the training course is selected. More specifically, each of the training levels related to “Speed”, “Stamina”, “Power”, “Spirit”, and “Wisdom” is set to “level 1” if the number of times the training is selected is three or less, each of the training levels is set to “level 2” if the number of times the training is selected is four to seven, each of the training levels is set to “level 3” if the number of times the training is selected is eight to 11, each of the training levels is set to “level 4” if the number of times the training is selected is 12 to 15, and each of the training levels is set to “level 5” if the number of times the training is selected is 16 or more.

In this embodiment, when the training selected by the player is successfully executed, the values of predetermined ability parameters are increased according to the executed training course.

More specifically, in this embodiment, when “Speed” training is successfully executed, the values of the “Speed” and “Power” ability parameters are increased.

In addition, when “Stamina” training is successfully executed, the values of the “Stamina” and “Spirit” ability parameters are increased.

Furthermore, when “Power” training is successfully executed, the values of the “Stamina” and “Power” ability parameters are increased.

Also, when “Spirit” training is successfully executed, the values of the “Speed”, “Power”, and “Spirit” ability parameters are increased.

In addition, when “Wisdom” training is successfully executed, the values of the “Speed” and “Wisdom” ability parameters are increased.

In this embodiment, the value of an ability parameter that increases when training is successful is calculated by adding, to an increase-fixed value that is decided in accordance with the executed training course and the training level, a value obtained by multiplying the increase-fixed value by a bonus addition rate described below. FIG. 28B is a drawing for illustrating an increase-fixed value (speed) table. In addition, FIG. 28C is a drawing for illustrating an increase-fixed value table (power). Namely, FIG. 28B shows increase-fixed values in the case where the training course is “Speed”. Also, FIG. 28C shows increase-fixed values in the case where the training course is “Power”.

As shown in FIG. 28B and FIG. 28C, increase-fixed values decided corresponding to the executed training course and training level are stored in the increase-fixed value tables. In addition, in this embodiment, the higher the training level, the greater the increases in the ability parameters, as shown in FIG. 28B and FIG. 28C.

Although not described here, there are also increase-fixed value tables used when “Stamina”, “Spirit”, and “Wisdom” are selected as training courses.

In addition to the aforementioned increase-fixed values, bonus addition rates are decided for each of the training courses on the basis of the placed support characters.

FIG. 28D is a drawing for illustrating a bonus addition rate table. In this embodiment, a bonus addition rate is decided on the basis of the support character decided to be placed in each of the training courses.

More specifically, the selection ratio among the bonus addition rates of a 0% increase (none), a 10% increase, and a 20% increase is stored for each of the support characters in the bonus addition rate table, as shown in FIG. 28D.

For the bonus addition rate, “none” is selected with a probability of 50%, a “10% increase” is selected with a probability of 25%, and a “20% increase” is selected with a probability of 25%.

Also, a bonus addition value is derived by multiplying the increase-fixed value decided on the basis of the increase-fixed value table by the bonus addition rate. The value obtained by adding the bonus addition value to the increase-fixed value is decided to be the amount of increase in the value of the corresponding ability parameter in the case of successful training. Note that for training in which a plurality of support characters are placed, the bonus addition values for the respective placed support characters are added to the increase-fixed value. In this way, the amounts of increase in ability parameters of the main character in the case of successful training are decided for all training types.

### <Process for Deciding Whether or not to Cause Second Event to Occur>

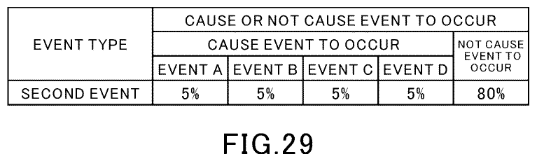

FIG. 29 is a drawing for illustrating a second event table. A second event is selected by lottery from among the support events (second events) tied to the support cards corresponding to the support characters placed in each of the training courses. More specifically, after the “process for deciding whether or not to place a support character”, a random number is randomly acquired, and whether or not to cause a second event to occur is decided on the basis of the acquired random number and the second event table. The selection ratio of whether a second event is made to “occur” or “not to occur” is set in the second event table.

For example, as shown in FIG. 29, second events include four types of events: event A, event B, event C, and event D. For example, in the second event table, the probability of causing each of the events (events A to D) to “occur” is set to 5%, and the probability of causing a second event “not to occur” is set to 80%. Note that the selection ratio of second events may be set individually for each of the support cards, namely, support characters.

In this embodiment, after the “process for deciding whether or not to place a support character”, a process for deciding whether or not to cause a second event to occur is executed for all support characters placed in each of the training courses. Then, on the basis of a decision as to the occurrence of a second event, an event report indicator 247 is displayed on the training screen 240. When the player selects training in which a character whose second event is decided to occur is placed, the second event occurs after the execution of training. For example, when the speed training is executed in the case where the occurrence of a second hint event of a support character placed in the speed training is decided, the second hint event always occurs after the execution of the training. However, when training other than the speed training is executed, this second hint event does not occur after the execution of the training. At this time, if the occurrence of second events has been decided for at least two characters, which of the second events is made to occur is decided by lottery or on the basis of priorities, etc. of the support events set in advance. For example, which of the plurality of second events is made to occur is decided at equal probabilities. Without limitation to this, however, weightings may be set according to the type of second event, so that which of the plurality of second events is made to occur can be decided according to the set weightings. Note that if the occurrence of second events has been decided for at least two characters, all of the decided second events may be made to occur.

Here, for example, when the occurrence of a second event is decided here, occurrence information indicating whether or not to cause a support event to occur may be stored in the server 1000 so as to be tied to the support card or the support character tied to the second event. More specifically, tying information in which occurrence information is tied to the character ID of the support character or the support card ID of the support card tied to the support character may be stored in the server 1000.

When the aforementioned “process for deciding whether or not to cause a first event to occur”, “process for deciding whether or not to place a support character”, “process for deciding an increase value of an ability parameter”, and “process for deciding whether or not to cause a second event to occur” are executed and the training operation section 216 is then operated, the training screen 240 shown in, for example, FIG. 21B is displayed on the display 26.

As described above, two kinds of placement character icons 248 that have been placed in the stamina training course through the “process for deciding whether or not to place a support character” are displayed on the training screen 240 shown in FIG. 21B.

In addition, on the training screen 240, increase values of ability parameters decided through the “process for deciding an increase value of an ability parameter” are displayed in the status display section 213. Also, an event report indicator 247 for reporting a second event decided through the “process for deciding whether or not to cause a second event to occur” is also displayed on the training screen 240.

At this time, when the item operation section 221 is tapped and a character re-placement item is used, a “process for deciding a training course in which a support character is re-placed” is executed.

<Process for Deciding Training Course in which Support Character is Re-Placed>

In the “process for deciding a training course in which a support character is re-placed”, it is decided by lottery in which of the “Speed”, “Stamina”, “Power”, “Spirit”, and “Wisdom” training courses to place a support character that has been decided to be placed in training through the “process for deciding whether or not to place a support character”.

Here, when a character re-placement item is used, a lottery for selecting one random number is redrawn, and placement of each of the support characters in a training course is decided again on the basis of the redrawn random number and the placement probability table shown in FIG. 27. That is, a lottery for placing each of the support characters in a training course is redrawn. At this time, if the placement position of a support character in a training course after the lottery is redrawn is the same as the placement position of the support character in a training course before the lottery is redrawn (i.e., placement position decided through the “process for deciding whether or not to place a support character”), a lottery for selecting a random number is redrawn again. Then, on the basis of the random number redrawn again and the placement table shown in FIG. 27, the placement of the support character in a training course is decided again. This process is repeated until the placement position of the support character in a training course after the lottery is redrawn is different from the placement position of the support character in a training course before the lottery is redrawn (i.e., placement position decided through the “process for deciding whether or not to place a support character”). Alternatively, a dedicated re-placement table may be used such that the training course in which the support character is re-placed results in a different training course, thereby ensuring that the support character is not re-placed in the same training course. By doing so, the placement of each of the support characters in a training course after the “process for deciding a training course in which a support character is re-placed” will be different from the placement of the support character in a training course decided through the “process for deciding whether or not to place a support character”.

In addition, when a character re-placement item is used, a lottery for selecting whether or not to cause a second event to occur is redrawn on the basis of the random number selected by lottery through the “process for deciding whether or not to cause a second event to occur” and the second event table. Here, because a lottery is redrawn on the basis of the same random number as the one used in the “process for deciding whether or not to cause a second event to occur” and the same second event table, the second event for which a lottery is redrawn after the character re-placement item is used has the same result as the second event the occurrence of which has been decided through the “process for deciding whether or not to cause a second event to occur”.

That is, even if the placement of each of the support characters in a training course is changed, whether or not a second event occurs and the type of a second event the occurrence of which has been decided are maintained unchanged. Although a lottery for a second event is redrawn using the same random number in this embodiment, the second event decided through the “process for deciding whether or not to cause a second event to occur” may be used as-is without redrawing a lottery. Note that a lottery for placing each of the support characters in a training course and a lottery for selecting whether or not to cause a second event to occur are redrawn each time a character re-placement item is used.

Note that in a lottery redrawing process executed when a character re-placement item is used, a lottery for tying between the character ID of a support character or the support card ID of the support card tied to the support character and the training ID indicating the type of the training course may be redrawn. At this time, tying information in which the character ID of the support character or the support card ID of the support card tied to the support character is tied to occurrence information indicating whether or not a support event occurs may be maintained.

A lottery may be redrawn such that the training courses have, for example, an equal chance of winning. Alternatively, a lottery may be redrawn such that the training courses have different chances of winning with respective probabilities set therefor. In addition, a lottery may be redrawn such that, for example, a support character is more readily placed in its favorite training (see FIG. 17A). When a lottery is to be drawn, a lottery table in which a selection ratio for the lottery is defined may be pre-stored, or alternatively, a lottery table may be generated each time a lottery is drawn.

After the execution of the “process for deciding a training course in which a support character is re-placed”, a post-replacement training screen 310 is displayed on the display 26.

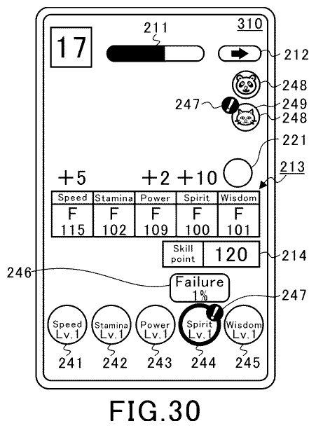

FIG. 30 is a drawing for illustrating the post-replacement training screen 310. As shown in FIG. 30, two kinds of placement character icons 248 that have been placed in the spirit training course through the “process for deciding a training course in which a support character is re-placed”are displayed on the post-replacement training screen 310.

One of the two kinds of placement character icons 248 is an event placement character icon 249 indicated with an event report indicator 247. The event placement character icon 249 shown in FIG. 30 is the same as the event placement character icon 249 shown in FIG. 21B.

That is, the event placement character icon 249 shown in FIG. 21B has been re-placed from the stamina training course to the spirit training course, as shown in FIG. 30, through the “process for deciding a training course in which a support character is re-placed”.

Here, as described above, the second event for which a lottery is redrawn after the character re-placement item is used has the same result as the second event the occurrence of which has been decided through the “process for deciding whether or not to cause a second event to occur”. As a result, as shown in FIG. 30, the post-replacement training screen 310 displays an event placement character icon 249 including the event report indicator 247 for reporting a second event that has been decided through the “process for deciding whether or not to cause a second event to occur” before the execution of the “process for deciding a training course in which a support character is re-placed”.

This makes it easier to cause a second event to occur in a training course desired by the player because only the training course in which a support character is placed is changed while the occurrence of a second event of the support card is maintained, whereby convenience of the nurturing game can be enhanced.

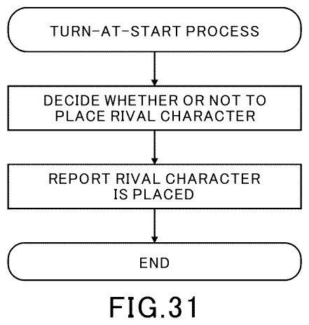

In addition, the turn-at-start process in this embodiment includes a “process for deciding whether or not to place a rival character” and a “process for reporting placement of a rival character” shown in FIG. 31. FIG. 31 is a drawing for illustrating the general flow of the turn-at-start process. A rival character is an NPC that appears in an individual race and competes with the main character for a win in the individual race.

A rival character is constituted from a character having the same character ID as a normal NPC that appears in a normal individual race in which no rival characters appear (hereinafter, referred to as a normal NPC). It should be noted, however, that a rival character is a character having higher parameters than a normal NPC. For example, a rival character has ability parameters a predetermined number times (e.g., 1.1 times) the values of ability parameters of a normal NPC having the same character ID. For this reason, an individual race in which a rival character appears has basic gameplay in which the rival character and the main character compete for a place (first place).

### <Process for Deciding Whether or not to Place Rival Character>

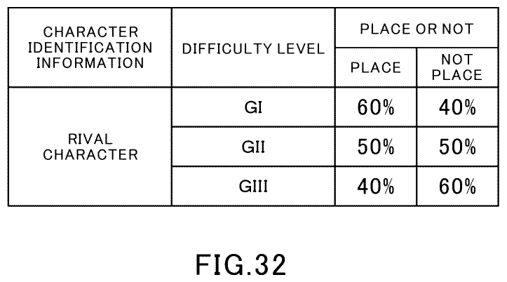

FIG. 32 is a drawing for illustrating a placement probability table. As shown in FIG. 32, the selection ratio of whether or not to place (“place” or “not place”) a rival character is set in the placement probability table. In this embodiment, whether or not to place a rival character is decided on the basis of the placement probability table shown in FIG. 32.

In this embodiment, the placement of a rival character is performed in the case where the individual races that appear in the current turn include a race in which the current aptitude parameters pertaining to the racetrack aptitude and the distance aptitude of the main character are equal to or larger than a predetermined value (e.g., C or higher). Therefore, in the “process for deciding whether or not to place a rival character”, first it is determined whether or not the individual races (race categories) that appear in the current turn include a race in which the current aptitude parameters pertaining to the racetrack aptitude and the distance aptitude of the main character are equal to or larger than a predetermined value (hereinafter referred to as a “suitable race”).

As shown in FIG. 32, in this embodiment, the selection ratio of a rival character differs depending on the difficulty level of the suitable race. More specifically, as shown in FIG. 32, when the difficulty level (grade) of the suitable race is GI, a rival character “being placed” is selected at a probability of 60%, and a rival character “not being placed” is selected at a probability of 40%.

In addition, when the difficulty level (grade) of the suitable race is GII, a rival character “being placed” is selected at a probability of 50%, and a rival character “not being placed” is selected at a probability of 50%. Also, when the difficulty level (grade) of the suitable race is GIII, a rival character “being placed” is selected at a probability of 40%, and a rival character “not being placed” is selected at a probability of 60%. It should be noted, however, that the selection ratio of a rival character does not need to differ depending on the difficulty level of the suitable race. For example, the selection ratios of a rival character may be uniform regardless of the difficulty level of the suitable race.

When the placement of a rival character is decided, the type (character ID) of the rival character to be placed is randomly selected by lottery. At this time, one character is randomly selected by lottery as a rival character from among the characters whose aptitude parameters related to the racetrack aptitude and the distance aptitude are equal to or larger than a predetermined value (e.g., C or higher) with respect to the racetrack, such as turf and dirt, and the distance, such as short distance, mile, intermediate distance, and long distance, set in the suitable race. It should be noted, however, that if there are multiple suitable races in a turn, rival characters are randomly selected by lottery such that the same rival character (character ID) is not selected in duplicate among the multiple suitable races. In addition, the random selection of a rival character by lottery is performed excluding the main character to be nurtured.

Here, parameters of the rival character may be changed according to the difficulty level of the suitable race. For example, the rival character may have higher parameters as the difficulty level of the suitable race increases. Alternatively, the parameters of the rival character may be constant values regardless of the difficulty level of the suitable race.

The parameters of the rival character are set higher as the turn in the nurturing game proceeds. More specifically, the parameters of the rival character may be set higher in the order of the initial turn segment, mid-turn segment, and late turn segment. More specifically, ability parameters of the rival character are 1.1 times the ability parameters of a normal NPC with the same character ID in the initial turn segment, ability parameters of the rival character are 1.3 times the ability parameters of a normal NPC with the same character ID in the mid-turn segment, and ability parameters of the rival character are 1.5 times the ability parameters of a normal NPC with the same character ID in the late turn segment.

When the main character runs in the suitable race, a basic reward is granted to the player. In addition to the basic reward, an additional reward is granted to the player when the main character wins against the rival character in the suitable race. However, an additional reward may be granted when the main character runs in a suitable race, regardless of whether he/she wins against or loses to the rival character. A basic reward is a reward that can be obtained by the player regardless of whether the main character wins against or loses to the rival character. An additional reward is granted to the main character to be nurtured separately from the basic reward and is, for example, a skill hint related to the racetrack of the suitable race, a skill hint related to the distance of the suitable race, and a skill hint related to the running style of the main character. An additional reward may also be a reward that displays a predetermined event on the display 26. In the predetermined event, the rival character is displayed, for example. Additional rewards also include a skill hint and a parameter that are tied to the main character to be nurtured. This skill hint may be decided on the basis of parameters, such as the racetrack aptitude, distance aptitude, running-style aptitude, etc., of the main character to be nurtured.

Note that this embodiment has been described by way of an example where an event is displayed and a skill hint or a parameter is granted as an additional reward. However, without limitation to this, additional rewards may include a special item that can increase the initial value of an ability parameter of a specific character or strengthen a unique skill provided to a specific character. Here, the specific character is, for example, a character having the same character ID as the rival character. Note that the specific character may be the main character or any character that runs in the suitable race. Without limitation to this, however, the specific character can be any character that can be earned by the player and may also be a character that does not run in the suitable race. In addition, one kind of special item is granted to the player as an additional reward for one suitable race.

In this embodiment, there is no limit to the number of granted additional rewards that can be earned in a suitable race, but for example, the number of times a special item can be earned in one suitable race in a predetermined time period may be limited to a predetermined number. For example, the number of times a special item can be earned in one suitable race in a day may be limited to three. It should be noted, however, that the number of times a special item can be earned may be changed according to the type of the suitable race (race category). In this case, the additional rewards earned via the suitable race are stored in the server 1000 so as to be tied to the player ID.

In addition, the number of special items earned at a time is the number of base earnings (e.g., three) plus the number of bonus earnings. The number of bonus earnings can be granted when the main character wins against the rival character.

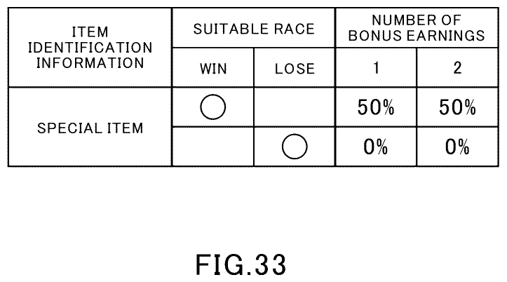

FIG. 33 is a drawing for illustrating a bonus earnings table. In this embodiment, the number of bonus earnings is decided on the basis of the bonus earnings table. More specifically, as shown in FIG. 33, whether or not a bonus is earned and the selection ratio of the number of bonus earnings for a special item are set in the bonus earnings table.

As shown in FIG. 33, a special item is set so that the number of bonus earnings changes on the basis of the win or loss at the suitable race (i.e., winning against or losing to the rival character). More specifically, the number of bonus earnings is 0 when the main character loses to the rival character. On the other hand, if the main character wins against the rival character, “1” is selected with a probability of 50%, and “2” is selected with a probability of 50%, as the number of bonus earnings.

### <Process for Reporting Placement of Rival Character>

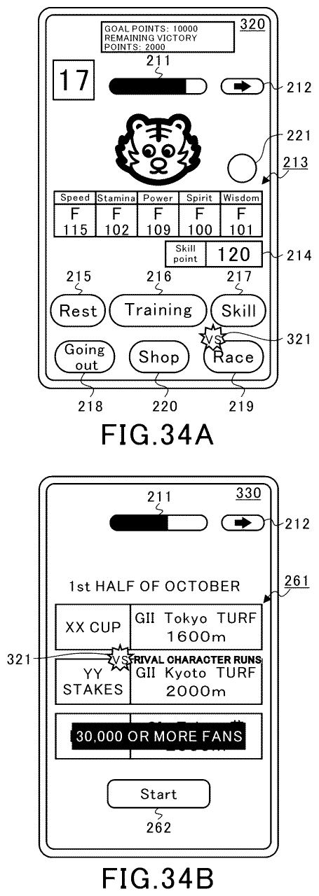

FIG. 34A is a drawing for illustrating the reporting of placement of a rival character on a game screen 320. FIG. 34B is a drawing for illustrating the reporting of placement of a rival character on an individual race selection screen 330.

When the placement of a rival character is decided through the “process for deciding whether or not to place a rival character”, a rival character report indicator 321 is superimposed in the individual race operation section 219 of the game screen 320, as shown in FIG. 34A.

When the individual race operation section 219 indicated with the rival character report indicator 321 is tapped, the individual race selection screen 330 shown in FIG. 34B is displayed on the display 26. Among the race categories in the individual race selection operation sections 261 displayed on the individual race selection screen 330, the race categories (suitable races) in which a decision has been made to place a rival character have a rival character report indicator 321 captioned “rival character running” superimposed thereon.

By confirming the rival character report indicator 321, the player can select whether to play a game for nurturing the main character to be nurtured or to earn an additional reward by competing with the rival character, thereby improving the pleasure of the nurturing game. Although this embodiment has been described by way of an example where the rival character report indicator 321 shown in FIGS. 34A and 34B is displayed on the display 26 when the placement of a rival character is decided, the present invention is not limited to this embodiment. The rival character report indicator 321 may include, for example, text or an image that allows the kind of the rival character to be identified.

In this embodiment, a bonus event occurs if the main character achieves a predetermined condition when the last turn of each of the initial turn segment, mid-turn segment, and late turn segment is ended. The predetermined conditions include, for example, the victory points exceeding the goal points by a certain amount, the first place in a race of a predetermined difficulty level (e.g., GI) being won a predetermined number of times or more, the main character winning against the rival character a predetermined number of times or more, etc.

Bonus events include a low bonus event and a high bonus event, and the type of bonus event that occurs changes according to the achievement of a predetermined condition. A low bonus event is, for example, an event that levels up a unique skill set for the main character. A high bonus event is, for example, an event that increases a parameter of the main character by a predetermined value and skill points by a predetermined value, in addition to an event that levels up a unique skill set for the main character.

In this embodiment, a low bonus event occurs when only a basic condition among the predetermined conditions is achieved, and a high bonus event occurs when a specific condition, in addition to the basic condition, among the predetermined conditions is achieved. The content of a high bonus event changes on the basis of the type of turn segment.

For example, if the type of turn segment is the initial turn segment, a high bonus event that will occur levels up a unique skill set for the main character, increases, by a predetermined value (e.g., +10), one kind of parameter randomly selected from among the parameters of the main character, and increases skill points by a predetermined value (e.g., +20).

Also, if the type of turn segment is the mid-turn segment, a high bonus event that will occur levels up a unique skill set for the main character, increases, by a predetermined value (e.g., +5), all parameters of the main character, and increases skill points by a predetermined value (e.g., +30).

Also, if the type of turn segment is the late turn segment, a high bonus event that will occur levels up a unique skill set for the main character, increases, by a predetermined value (e.g., +10), all parameters of the main character, and increases skill points by a predetermined value (e.g., +30).

In this embodiment, apart from a bonus event that occurs at the end of a turn segment described above, a bonus event also occurs when the main character achieves a special condition. The special condition is, for example, the main character winning the first place in a specific race among the individual races. More specifically, the special condition includes winning the first place a predetermined number of times in an individual race in which a specific racetrack and a specific distance are set, winning the first place a predetermined number of times in an individual race in a specific region, winning the first place in a particular race among GI races with a high difficulty level, etc. A bonus event is, for example, an event that increases parameters of the main character by a predetermined value.

In the aforementioned nurturing main game, the nurturing game ends when all turns are completed. If, in the course of the nurturing main game, the player fails to achieve the goals set for each character or the goal points set for each of the specified turn segments, the nurturing game ends at that point.

Here, when the nurturing game ends, the main character nurtured in the nurturing game is stored as a nurtured character. More precisely, information concerning the nurtured character that has been nurtured in the nurturing game (hereinafter, referred to as “nurtured character information”) is stored so as to be tied to the player ID. Note that the nurtured character information is stored in both the player terminal 1 and the server 1000. Nurtured character information stored so as to be tied to the player ID includes ability parameters, aptitude parameters, earned skills, inheritance information, etc.

In addition, when the nurturing game ends, an evaluation score of the nurtured character that has been nurtured is calculated. Here, an evaluation score is calculated on the basis of the ability parameters, aptitude parameters, earned skills, individual race records, etc. as of the end of the nurturing game. Note that the method of calculating the evaluation score, in other words, a calculation formula for obtaining the evaluation score, is prepared in advance, and the evaluation score is calculated on the basis of the predetermined calculation formula. The method and calculation formula for calculating the evaluation score are not particularly limited. For example, an evaluation score may be calculated on the basis of only parameters that affect the result of a race in a team competition game or another race game when the nurtured character runs in the race, such as ability parameters, aptitude parameters, earned skills, etc. as of the end of the nurturing game.

In addition, a nurturing rank is set for the nurtured character on the basis of the evaluation score. The nurturing rank is an indicator of the strength of the nurtured character, and each nurturing rank is tied to a range of evaluation scores. For example, a nurtured character with an evaluation score between 13000 and 14499 is assigned an “A+” nurturing rank, and a nurtured character with an evaluation score between 14500 and 15499 is assigned an “S” nurturing rank. In this way, it is easier to understand the general strength of a nurtured character as a result of a nurturing rank being assigned on the basis of the evaluation score. Note that the evaluation score and the nurturing rank are also included in the nurtured character information.

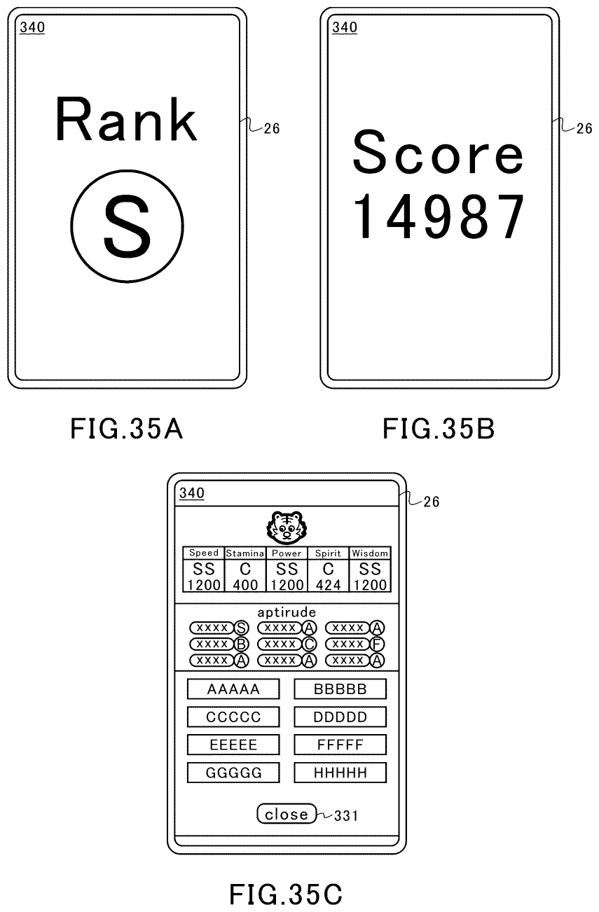

FIG. 35A is a first drawing for illustrating a nurturing completion screen 340. FIG. 35B is a second drawing for illustrating the nurturing completion screen 340. FIG. 35C is a third drawing for illustrating the nurturing completion screen 340. When the nurturing game is completed, the nurturing completion screen 340 is displayed on the display 26, as shown in FIG. 35A. On the nurturing completion screen 340, the nurturing rank of the nurtured character that has been nurtured is first displayed, followed by the display of the evaluation score as shown in FIG. 35B.

In addition, a predetermined amount of time after the display of the evaluation score, the ability parameters, aptitude parameters, and earned skills of the nurtured character are displayed on the nurturing completion screen 340, as shown in FIG. 35C. At this time, a close operation section 331 is provided on the nurturing completion screen 340. When the close operation section 331 is tapped, the nurturing completion screen 340 is hidden, and the home screen 100 is displayed on the display 26.

When the nurturing game is completed, a lottery is drawn for factors to be earned by the main character, and the factor information is stored so as to be tied to the nurtured character. Although not shown in the figure, the player can display the factor information earned by the nurtured character on the nurturing completion screen 340.

As described above, in the nurturing game, a nurtured character with ability parameters, aptitude parameters, earned skills, etc. is created. In the nurturing game, the placement of support characters, the occurrence of various events, etc. are decided by lottery, so that even if the same character is used as the main character, nurtured characters with different parameters are created. In particular, in this embodiment, it is possible to create nurtured characters with various abilities from the same main character by using different support cards in the nurturing game.

However, because character properties, such as the distance aptitude, are set for each character, optimal support cards for nurturing the character are generally fixed. That is, it is difficult to significantly change the support cards used to nurture each character as a main character. As a result, there is a risk of discouraging the player from repeatedly nurturing the same character.

Given this situation, in this embodiment, the player's motivation to play the game is improved by making it possible to strengthen characters outside the nurturing game. A character strengthening function will be described below.

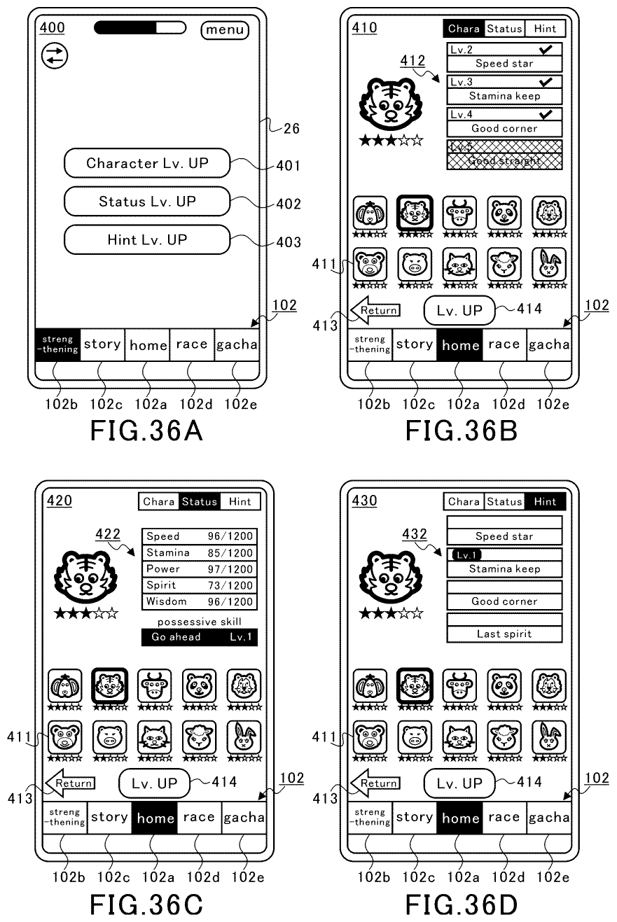

FIG. 36A is a drawing for illustrating a strengthening subject selection screen 400. FIG. 36B is a drawing for illustrating a character level strengthening screen 410. FIG. 36C is a drawing for illustrating a status level strengthening screen 420. FIG. 36D is a drawing for illustrating a hint level strengthening screen 430. When the strengthening screen selection operation section 102b in the menu bar 102 is tapped outside the nurturing game, the strengthening subject selection screen 400 shown in FIG. 36A is displayed on the display 26.

A character level selection tab 401, a status level selection tab 402, and a hint level selection tab 403 are provided on the strengthening subject selection screen 400. When the character level selection tab 401 is tapped, the character level strengthening screen 410 is displayed. In addition, when the status level selection tab 402 is tapped, the status level strengthening screen 420 is displayed. In addition, when the hint level selection tab 403 is tapped, the hint level strengthening screen 430 is displayed.

The character level strengthening screen 410 shown in FIG. 36B is a screen for strengthening the character levels of characters possessed by the player. On the character level strengthening screen 410, character icons 411 corresponding to the characters possessed by the player are listed. When any one of the character icons 411 is tapped, the character corresponding to the tapped character icon 411 is temporarily selected.

Possessed-skill display fields 412 are provided on the character level strengthening screen 410. Possessed skills of the temporarily selected character are displayed in the possessed-skill display fields 412. Here, in this embodiment, a character level is provided as a parameter of a character that can be a main character. Five levels from level 1 to 5 are provided as the character level, so that the player can strengthen (increase) the character level to a maximum of level 5 by using character level strengthening items.

In addition, possessed skills according to the character level are provided in each of the characters. As described above, possessed skills can be earned skills by consuming skill points during the nurturing game. Four possessed skills according to the character level are provided in each of the characters, and a release level is set for each of these four possessed skills. More specifically, any of character levels 2 to 5 is set as a release level in each of the four possessed skills.

A plurality of possessed skills released from the beginning, irrespective of the character level, as well as possessed skills released according to the character level, are provided in each of the characters. The player can release a possessed skill tied to the character level by strengthening the character level.

For example, when the character level is strengthened to level 2, the possessed skill with a release level set to level 2 among the possessed skills of that character is released. Similarly, when the character level is strengthened to level 3, the possessed skill with a release level set to level 3 is released. In this manner, when the character level is strengthened to level 5, all of the four possessed skills of the character are released. Thus, possessed skills of the character are increased by strengthening the character level. Therefore, if the player plays a nurturing game by setting a character with a strengthened character level as a main character, the skills that can be earned increase.

Note that, in a nurturing game, events occur only for released possessed skills among the possessed skills tied to the character. As a result of an event occurring, the player can change the released possessed skill to an earned skill. Because no events occur for unreleased possessed skills among the possessed skills tied to the character, the player in principle cannot earn unreleased possessed skills.

It should be noted, however, that possessed skills are also tied to support cards, as described above. Some of the possessed skills that are tied to a character and that are released according to the character level are also tied to a support card. Thus, in the case of a possessed skill tied to both a character and a support card, even if the character level does not reach the release level of the possessed skill, the player can earn that possessed skill when a support card event occurs.

FIG. 36B shows a temporarily selected character with a character level of level 4. In the case where the character level is level 4, three possessed skills are released as shown in FIG. 36B, and the possessed skill with a release level set to level 5 is not released. In the possessed-skill display fields 412, the released possessed skills are checked with a check mark, and the unreleased possessed skill is grayed out.

A return operation section 413 and a decision operation section 414 are provided in the lower section of the character level strengthening screen 410. When the return operation section 413 is tapped on the character level strengthening screen 410, the strengthening subject selection screen 400 is displayed. When the decision operation section 414 is tapped on the character level strengthening screen 410, a character level strengthening confirmation screen (not shown in the figure) is displayed.

Although a detailed description will be omitted, the kinds and the number of character level strengthening items needed to strengthen the character level of the temporarily selected character, as well as the current number of possessed character level strengthening items, are displayed on the character level strengthening confirmation screen. If the player possesses required character level strengthening items, a strengthening operation made by the player is accepted, and the character level is strengthened.

The status level strengthening screen 420 shown in FIG. 36C is a screen for strengthening the status levels of characters possessed by the player. Similarly to the character level strengthening screen 410, the character icons 411 corresponding to the characters possessed by the player are listed on the status level strengthening screen 420. Ability parameter display fields 422 are provided on the status level strengthening screen 420. The initial values of the ability parameters of the temporarily selected character are displayed in the ability parameter display fields 422.

Here, in this embodiment, a status level is provided as a parameter of a character that can be a main character. Five levels from level 1 to 5 are provided as the status level, so that the player can strengthen the status level to a maximum of level 5 by using status level strengthening items.

As described above, one earned skill is provided in each of the characters. Three skill levels are provided for the one earned skill possessed by a character, and the skill level of the earned skill increases as the status level increases. For example, the skill level of the earned skill is 1 if the status level is 1 to 3, the skill level of the earned skill is 2 if the status level is 4, and the skill level of the earned skill is 3 if the status level is 5. The higher the skill level, the more profound the effect when the earned skill is invoked.

In addition, the higher the status level of a character, the larger the initial values of the ability parameters. Therefore, the more the status level is strengthened, the easier it is to create a nurtured character with higher abilities. The initial values of ability parameters corresponding to the current status level are displayed in the ability parameter display fields 422.

Note that the return operation section 413 and the decision operation section 414 are provided in the lower section of the status level strengthening screen 420. When the return operation section 413 is tapped on the status level strengthening screen 420, the strengthening subject selection screen 400 is displayed. When the decision operation section 414 is tapped on the status level strengthening screen 420, a status level strengthening confirmation screen (not shown in the figure) is displayed.

Although a detailed description will be omitted, the kinds and the number of status level strengthening items needed to strengthen the status level of the temporarily selected character, as well as the current number of possessed status level strengthening items, are displayed on the status level strengthening confirmation screen. If the player possesses required status level strengthening items, a strengthening operation made by the player is accepted, and the status level of the character is strengthened.

The hint level strengthening screen 430 shown in FIG. 36D is a screen for strengthening the hint levels of possessed skills of the character. On the hint level strengthening screen 430, character icons 411 corresponding to the characters possessed by the player are listed. When any one of the character icons 411 is tapped, the character corresponding to the tapped character icon 411 is temporarily selected.

Skill hint level display fields 432 are provided on the hint level strengthening screen 430. Possessed skills of the temporarily selected character are displayed in the skill hint level display field 432. Here, in this embodiment, a hint level is tied to a possessed skill possessed by the character as a parameter. Four levels from level 0 to 3 are provided as the hint level, so that the player can strengthen the hint level of each of the possessed skills to a maximum of level 3 by using hint level strengthening items.

It should be noted, however, that possessed skills the hint levels of which can be strengthened are limited to released possessed skills. Possessed skills released from the beginning, as well as possessed skills released by strengthening the character level, are displayed in the skill hint level display fields 432. Note that unreleased possessed skills may be displayed in the skill hint level display fields 432. In this case, it is preferable that released possessed skills and unreleased possessed skills should be identifiably displayed.

In addition, although the hint level can be strengthened for all released possessed skills here, it may also be possible to strengthen the hint levels only for the possessed skills released according to the character level. Alternatively, it may be possible to strengthen the hint levels only for some of the possessed skills of the character.

Skill points needed to earn each of the possessed skills during the nurturing game are set for the possessed skill. A discount rate of skill points needed to earn a possessed skill is set in the hint level, and the higher the hint level, the higher the discount rate. That is, the higher the hint level of a possessed skill, the smaller the skill points needed to earn the possessed skill.

Note that the initial value of the hint level is level 0. In the skill hint level display fields 432, icons that allow a hint level to be identified are displayed for possessed skills with a hint level of level 1 or higher.

The return operation section 413 and the decision operation section 414 are provided in the lower section of the hint level strengthening screen 430. When the return operation section 413 is tapped on the hint level strengthening screen 430, the strengthening subject selection screen 400 is displayed. When the decision operation section 414 is tapped on the hint level strengthening screen 430, a hint level strengthening confirmation screen 430A is displayed.

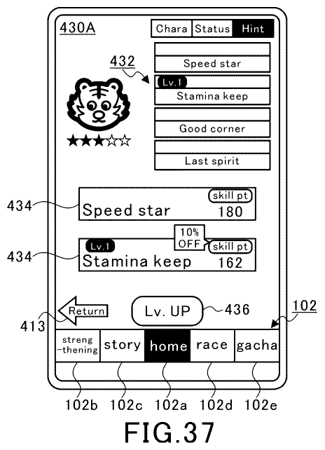

FIG. 37 is a drawing for illustrating the hint level strengthening confirmation screen 430A. On the hint level strengthening confirmation screen 430A, possessed skill icons 434, instead of the character icons 411 displayed on the hint level strengthening screen 430, are displayed. A possessed skill icon 434 is provided for each of the released possessed skills of the temporarily selected character. By performing a swipe operation in the up/down direction in the region in which the possessed skill icons 434 are displayed, the player can confirm the possessed skill icons 434 corresponding to all released possessed skills.

In each of the possessed skill icons 434, the name of the possessed skill and skill points needed to earn the possessed skill in the nurturing game are displayed. In addition, the current hint level and the discount rate are displayed together on the possessed skill icons 434 corresponding to possessed skills with a hint level of level 1 or higher at the current stage.

By tapping a possessed skill icon 434, the player can select a possessed skill the skill hint of which is to be strengthened. When a decision operation section 436 provided in the lower section of the hint level strengthening confirmation screen 430A is tapped after any of the possessed skill icons 434 has been tapped, a final confirmation screen (not shown in the figure) is displayed. Although a detailed description will be omitted, the kinds and the number of hint level strengthening items needed to strengthen the hint level of the selected possessed skill, as well as the current number of possessed hint level strengthening items, are displayed on the final confirmation screen. If the player possesses required hint level strengthening items, a strengthening operation made by the player is accepted, and the hint level of the possessed skill is strengthened.

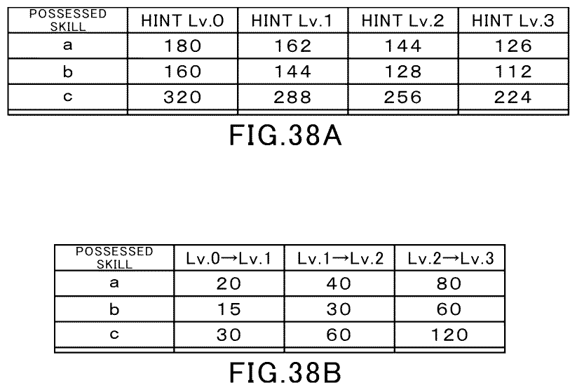

FIG. 38A is a drawing for illustrating the relationship between possessed skills and hint levels. FIG. 38B is a drawing for illustrating a hint level strengthening item. As shown in FIG. 38A, skill points needed to earn a possessed skill set in a character are set in the possessed skill. For example, if the hint level of possessed skill a is level 0, skill points needed to earn the possessed skill are 180. In addition, as the hint level of possessed skill a increases by one level, the skill points needed to earn possessed skill a become smaller, like 162, 144, and 126.

Thus, the skill points needed to earn a possessed skill are discounted by 10% each time the hint level increases by one level. It is assumed here that skill points required at each of the hint levels are stored so as to be tied to each of the possessed skills. It should be noted, however, that the initial value of each of the possessed skills (skill points needed when the skill hint is level 0) and the discount rate for each of the hint levels may be stored separately. In this case, it suffices if skill points are calculated by multiplying the initial value of the possessed skill by the discount rate.

Also, as shown in FIG. 38B, each of the possessed skills has set therefor hint level strengthening items needed to strengthen the hint level for each of the hint levels. Here, the higher the hint level, the larger the number of required hint level strengthening items. It should be noted, however, that the relationship between a hint level and the number of hint level strengthening items is merely an example and can be set as appropriate.

Note that a character level strengthening item, a status level strengthening item, and a hint level strengthening item are all granted to the player as a reward while the nurturing game is being played or when the nurturing game is completed. That is, the player can earn strengthening items by playing a nurturing game. This motivates the player to play a nurturing game repeatedly. It should be noted, however, that strengthening items may be granted to the player for free, for example, on a regular basis, while a time-limited event is being held, etc. Alternatively, the player may be able to earn strengthening items in exchange for predetermined in-game currency or other items.

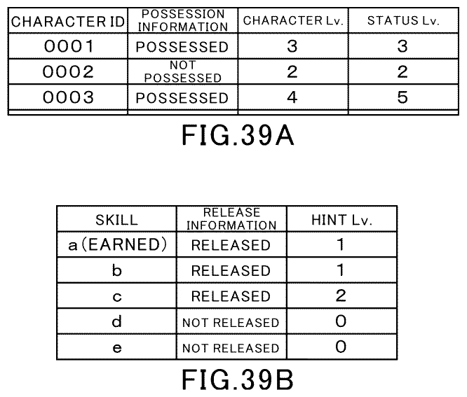

FIG. 39A is a drawing for illustrating character information. Player information concerning each player is stored in the player terminal 1 and the server 1000. The player information includes information concerning nurtured characters nurtured by the player and information concerning characters that can be a main character. A character ID is provided in each of the characters that can be possessed by the player.

In the player information stored in the player terminal 1 and the server 1000, possession information is tied to each character ID. The possession information is information for identifying whether or not the character is possessed. For example, information indicating possession is tied to each of character IDs 0001 and 0003, and, information indicating non-possession is tied to character ID 0002.

Also, a character level and a status level are stored so as to be tied to each of the character IDs. The player can strengthen the character levels and the status levels of only the possessed characters. Note that initial values of the character level and the status level are set in each of the characters. Here, the initial values of the character level and the status level are either 1 or 2.

FIG. 39B is a drawing for illustrating skill information of a character. The player information includes skill information of each character. FIG. 39B shows skill information tied to, for example, character ID 0001. Release information and a hint level for each of the types (more specifically, skill IDs) of skills (earned skill and possessed skill) possessed by a character are stored so as to be tied to the character ID.

Release information is information indicating whether or not the earned skills and the possessed skill possessed by the character are released. Each of the earned skills always has tied thereto information indicating that the earned skill is released. In addition, each of the skills in which the character level has not reached the release level has tied thereto information indicating the skill is not released. On the other hand, when the character level reaches the release level, the release information is updated with information indicating that the skill is released. In addition, each of the possessed skills released from the beginning has also tied thereto information indicating that the possessed skill is released.

Also, the skill information includes a hint level, and when the player strengthens the hint level, the hint level stored so as to be tied to the character ID is updated. Note that the player can strengthen the hint levels of only released possessed skills. Therefore, the hint levels of unreleased possessed skills are set to level 0.

Next, functional configurations of the player terminal 1 and the server 1000 for executing the aforementioned nurturing game will be described.

### (Functional Configuration of Player Terminal 1)

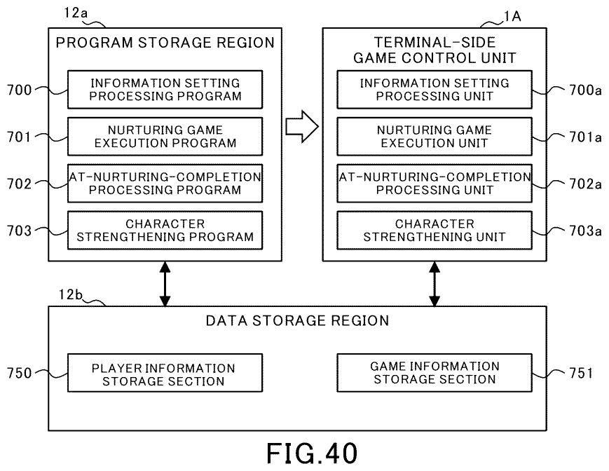

FIG. 40 is a drawing for illustrating the configuration of the memory 12 in the player terminal 1 and functions of the player terminal 1 as a computer. A program storage region 12a and a data storage region 12b are provided in the memory 12. When a game is started, the CPU 10 stores terminal-side game control programs (modules) in the program storage region 12a.

The terminal-side game control programs include: an information setting processing program 700; a nurturing game execution program 701; an at-nurturing-completion processing program 702; and a character strengthening program 703. Note that the programs listed in FIG. 40 are examples, and many other programs are provided as the terminal-side game control programs.

In the data storage region 12b, a player information storage section 750 and a game information storage section 751 are provided as storage sections for storing data. Note that many other storage sections are provided in the data storage region 12b. Here, information directly related to a game (hereinafter, referred to as game information), such as the nurturing game, is stored in the game information storage section 751.

Note that various kinds of information while each game, such as the nurturing game, is proceeding are also temporarily stored in the game information storage section 751. Therefore, all information related to a nurtured character nurtured in the nurturing game is stored in the game information storage section 751. In addition, all information other than the game information, such as information concerning the player or other players, setting information of the player terminal 1, and information concerning a character that can be set as a main character, is player information. The player information is stored in the player information storage section 750.

The CPU 10 runs the individual programs stored in the program storage region 12a and updates the data in the individual storage sections of the data storage region 12b. Furthermore, the CPU 10 runs the individual programs stored in the program storage region 12a, thereby causing the player terminal 1 (computer) to function as a terminal-side game control unit 1A. The terminal-side game control unit 1A includes: an information setting processing unit 700a; a nurturing game execution unit 701a; an at-nurturing-completion processing unit 702a; and a character strengthening unit 703a.

More specifically, the CPU 10 runs the information setting processing program 700, thereby causing the computer to function as the information setting processing unit 700a. Similarly, the CPU 10 runs the nurturing game execution program 701, the at-nurturing-completion processing program 702, and the character strengthening program 703, thereby causing the computer to function as the nurturing game execution unit 701a, the at-nurturing-completion processing unit 702a, and the character strengthening unit 703a, respectively.

When various kinds of information settings are made at the player terminal 1, the information setting processing unit 700a stores, in the player information storage section 750, information concerning the settings as player information. In addition, when information in the player information storage section 750 is updated, the information setting processing unit 700a transmits update information to the server 1000.

The nurturing game execution unit 701a executes all processes related to the nurturing game. More specifically, the nurturing game execution unit 701a executes the preparatory-stage process and the nurturing-stage process.

When the nurturing game is completed, the at-nurturing-completion processing unit 702a stores nurtured character information including ability parameters, aptitude parameters, earned skills, inheritance information, and factor information of the nurtured character, character types used to nurture the nurtured character, etc.

The character strengthening unit 703a updates the character level, status level, and hint levels for a character on the basis of an operation performed by the player.

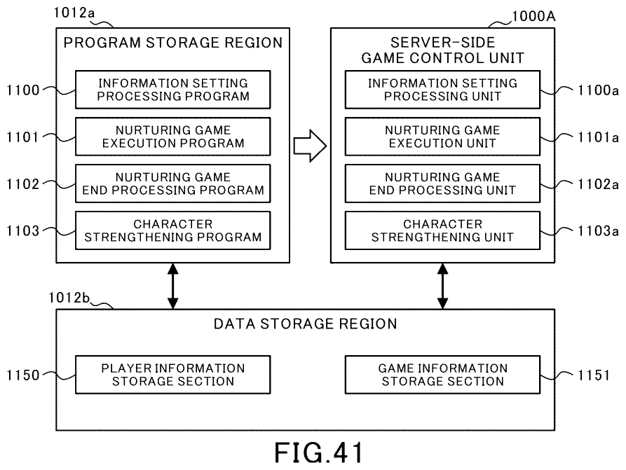

(Functional configuration of server 1000) FIG. 41 is a drawing for illustrating the configuration of the memory 1012 in the server 1000 and functions of the server 1000 as a computer. A program storage region 1012a and a data storage region 1012b are provided in the memory 1012. When a game is started, the CPU 1010 stores server-side game control programs (modules) in the program storage region 1012a.

The server-side game control programs include: an information setting processing program 1100; a nurturing game execution program 1101; a nurturing game end processing program 1102; and a character strengthening program 1103. The programs listed in FIG. 41 are examples, and many other programs are provided as the server-side game control programs.

In the data storage region 1012b, a player information storage section 1150 and a game information storage section 1151 are provided as storage sections for storing data. Note that many other storage sections are provided in the data storage region 1012b. Here, game information of all players is stored in the game information storage section 1151 so as to be tied to the respective player IDs. In addition, player information of all players is stored in the player information storage section 1150 so as to be tied to the respective player IDs.

The CPU 1010 runs the individual programs stored in the program storage region 1012a and updates data in the individual storage sections in the data storage region 1012b. Also, the CPU 1010 runs the individual programs stored in the program storage region 1012a, thereby causing the server 1000 (computer) to function as a server-side game control unit 1000A. The server-side game control unit 1000A includes: an information setting processing unit 1100a; a nurturing game execution unit 1101a; a nurturing game end processing unit 1102a; and a character strengthening unit 1103a.

More specifically, the CPU 1010 runs the information setting processing program 1100, thereby causing the computer to function as the information setting processing unit 1100a. Similarly, the CPU 1010 runs the nurturing game execution program 1101, the nurturing game end processing program 1102, and the character strengthening program 1103, thereby causing the computer to function as the nurturing game execution unit 1101a, the nurturing game end processing unit 1102a, and the character strengthening unit 1103a, respectively.

When various kinds of information settings are made at the player terminal 1, the information setting processing unit 1100a updates the player information in the player information storage section 1150 on the basis of the update information received from the player terminal 1. In addition, the information setting processing unit 1100a performs time keeping and updates game points of each player.

The nurturing game execution unit 1101a executes all processes related to the nurturing game.

When the nurturing game ends, the nurturing game end processing unit 1102a derives an evaluation score, a nurturing rank, etc. for the nurtured character that has been nurtured. In addition, the nurturing game end processing unit 1102a decides factors to be earned by the nurtured character by lottery. The nurturing game end processing unit 1102a also stores nurtured character information including ability parameters, aptitude parameters, earned skills, inheritance information, and factor information of the nurtured character, character types used to nurture the nurtured character, etc. in the game information storage section 1151 so as to be tied to the player ID.

The character strengthening unit 1103a updates the character level, status level, and hint levels for a character on the basis of an operation performed by the player.

Although the information setting processing unit 700a in the player terminal 1 and the information setting processing unit 1100a in the server 1000 are common in that both units store player information, they differ in specific processing details and the scope of the player information to be stored. In addition, although the nurturing game execution unit 701a, the at-nurturing-completion processing unit 702a, and the character strengthening unit 703a in the player terminal 1 and the nurturing game execution unit 1101a, the nurturing game end processing unit 1102a, and the character strengthening unit 1103a in the server 1000 are common in that all units execute processes related to the nurturing game, they differ in their roles, i.e., the scope of their responsibilities.

Processes to be executed by the aforementioned individual functional units in the player terminal 1 and server 1000 will be described below by using flowcharts. Here, processes related to the nurturing game will be described first, followed by descriptions of a strengthening process for strengthening a character.

### (Processes of Player Terminal 1 and Server 1000) <Processes Related to Nurturing Game>

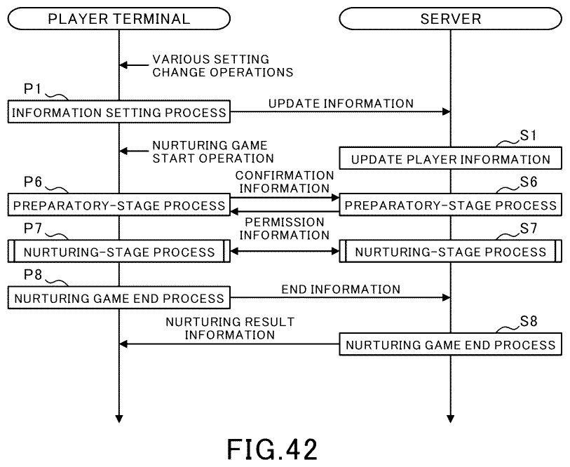

FIG. 42 is a sequence diagram for illustrating processes of the player terminal 1 and the server 1000 related to the nurturing game. Note that, in the following description, processes in the player terminal 1 are denoted as Pn (n is any integer). Furthermore, processes in the server 1000 are denoted as Sn (n is any integer).

When the player performs various setting change operations at the player terminal 1, the information setting processing unit 700a of the player terminal 1 executes an information setting process (P1) for updating the player information storage section 750 on the basis of the player operation inputs. In this information setting process, the update information is transmitted to the server 1000. At the server 1000, upon receiving the update information, the information setting processing unit 1100a updates the player information in the player information storage section 1150 (S1).

Note that the player information updated in P1 and S1 includes, for example, profile information that can be set by the player. Also, for example, when an operation for adding another player as a friend or for unregistering a friend is input as a setting change operation, friend information indicating information concerning friends is updated. Note that, in P1 and S1, each of the information setting processing unit 700a and the information setting processing unit 1100a manages game points to be consumed to execute a nurturing game. If the game points are below the upper limit, the information setting processing units 700a and 1100a perform time keeping and grant a predetermined value of game points to the player every predetermined time.

When a nurturing game start operation for starting a nurturing game is input at the player terminal 1, the nurturing game execution unit 701a executes the preparatory-stage process (P6). In addition, during this preparatory-stage process, communication processes are executed between the player terminal 1 and the server 1000. At the server 1000, the nurturing game execution unit 1101a executes the preparatory-stage process (S6) on the basis of information received from the player terminal 1.

When the preparatory-stage process (P6) ends, the nurturing game execution unit 701a executes the nurturing-stage process (P7). In addition, during this nurturing-stage process, communication processes are executed between the player terminal 1 and the server 1000. At the server 1000, the nurturing game execution unit 1101a executes the nurturing-stage process (S7) on the basis of information received from the player terminal 1. In reality, the player terminal 1 and the server 1000 have individual roles assigned thereto for proceeding with the nurturing main game such that the player terminal 1 is in charge of the nurturing-stage process (P7) and the server 1000 is in charge of the nurturing-stage process (S7). It should be noted, however, that some or all of the processes described below in the nurturing-stage process (P7) in the player terminal 1 may be executed in the nurturing-stage process (S7) in the server 1000. Also, some or all of the processes described below in the nurturing-stage process (S7) in the server 1000 may be executed in the nurturing-stage process (P7) in the player terminal 1.

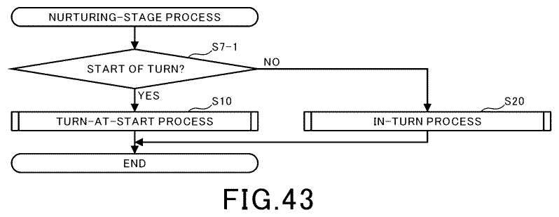

FIG. 43 is a flowchart for illustrating the nurturing-stage process in the server 1000. The nurturing game execution unit 1101a of the server 1000 executes the turn-at-start process (S10) if the player is at the start of a turn (YES in S7-1) or an in-turn process (S20) if the player is not at the start of a turn.

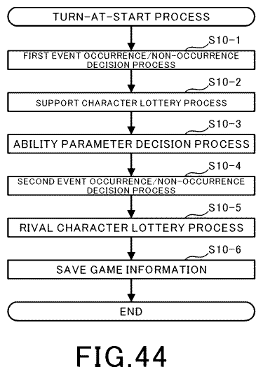

FIG. 44 is a flowchart for illustrating the turn-at-start process in the server 1000. As shown in FIG. 44, first the nurturing game execution unit 1101a of the server 1000 executes a first event occurrence/non-occurrence decision process (S10-1). More specifically, when a turn is started, a random number is randomly acquired, and whether or not to cause a first event to occur and the content of the first event are decided on the basis of the acquired random number and the first event table. Then, the nurturing game execution unit 1101a executes a support character lottery process (S10-2 ). More specifically, the nurturing game execution unit 1101a decides, by lottery, whether or not to place support characters in each of the training courses with reference to the placement probability table shown in FIG. 27. This process is executed for each of the support characters.

Note that when it is decided that a support character is placed in a training course, the nurturing game execution unit 1101a may execute a process for tying the support character ID or the support card (used game medium) ID corresponding to the support character to the training ID corresponding to the training course (parameter-changing element).

Next, the nurturing game execution unit 1101a executes an ability parameter decision process (S10-3). In the ability parameter decision process, increase values of ability parameters of the main character in the case where each type of training is successfully executed are decided. More specifically, with reference to the training level table shown in FIG. 28A, the increase-fixed value tables shown in FIGS. 28B and 28C, and the bonus addition rate table shown in FIG. 28D, the nurturing game execution unit 1101a decides, for all training courses, increase values of ability parameters of the main character in the case where training is successfully executed. In addition, with reference to a physical strength table (not shown in the figure), the nurturing game execution unit 1101a decides the amount of decrease in the physical strength or the amount of recovery of the physical strength in the case where each of the training courses is executed. Also, the nurturing game execution unit 1101a calculates a failure rate of training for each of the training courses on the basis of the physical strength of the main character.

Then, the nurturing game execution unit 1101a executes a second event occurrence/non-occurrence decision process (S10-4). More specifically, the nurturing game execution unit 1101a decides, by lottery, whether or not to cause a second event to occur with reference to the second event table shown in FIG. 29. More specifically, after the support character lottery process (S10-2), a random number is randomly acquired, and whether or not to cause a second event to occur is decided on the basis of the acquired random number and the second event table. Here, for example, the nurturing game execution unit 1101a draws a granting lottery for deciding whether or not to allow granting of a support event (special gift) set in advance in each of the support cards tied to the training course.

In addition, the nurturing game execution unit 1101a executes a rival character lottery process (S10-5). More specifically, the nurturing game execution unit 1101a decides, by lottery, whether or not to place a rival character in each suitable race with reference to the placement probability table shown in FIG. 32.

The nurturing game execution unit 1101a saves game information, including information concerning the lottery results in S10-1 to S10-5, in the game information storage section 1151 so as to allow the player terminal 1 to receive the game information (S10-6).

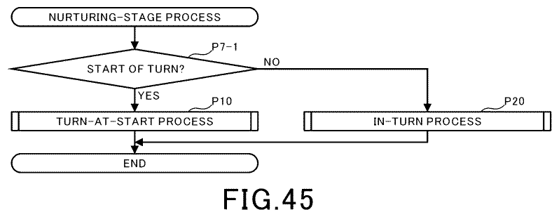

FIG. 45 is a flowchart for illustrating the nurturing-stage process in the player terminal 1. The nurturing game execution unit 701a of the player terminal 1 executes the turn-at-start process (P10) if the player is at the start of a turn (YES in P7-1) or the in-turn process (P20) if the player is not at the start of a turn.

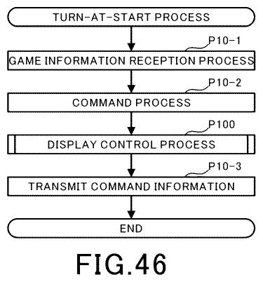

FIG. 46 is a flowchart for illustrating the turn-at-start process in the player terminal 1. As shown in FIG. 46, first the nurturing game execution unit 701a accesses the game information storage section 1151 of the server 1000 and receives, from the server 1000, game information including information concerning the lottery results in S10-1 to S10-6 (P10-1).

Then, the nurturing game execution unit 701a executes a command process for allowing the player to select various kinds of commands related to the nurturing-stage process (P10-2). More specifically, on the basis of the current turn number and with reference to, for example, the elective table shown in FIG. 19, the nurturing game execution unit 701a executes a process for allowing the player to select various kinds of commands, such as the rest operation section 215, the training operation section 216, the skill operation section 217, the outing operation section 218, the individual race operation section (specific command) 219, the shop operation section 220, and the item operation section 221. The nurturing game execution unit 701a also executes a process for allowing the player to select a plurality of individual race selection operation sections (sub-commands) 261 tied to the individual race operation section 219.

In addition, in the command process, the nurturing game execution unit 1101a allows the player to select the commands for the speed operation section 241, the stamina operation section 242, the power operation section 243, the spirit operation section 244, the wisdom operation section 245 corresponding to the respective training courses. The nurturing game execution unit 701a executes a process for allowing the player to select one of the plurality of commands.

When completing the command process, the nurturing game execution unit 701a executes a display control process (P100).

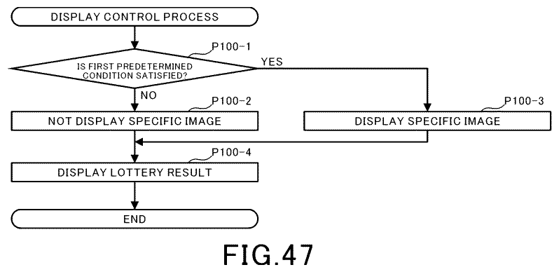

FIG. 47 is a flowchart for illustrating the display control process. As shown in FIG. 47, the nurturing game execution unit 701a executes a first predetermined condition determination process for determining whether or not a first predetermined condition is satisfied (P100-1). The first predetermined condition determination process is a process for determining whether or not placement of a rival character has been decided on the basis of the result of the rival character lottery process in S10-5. The nurturing game execution unit 701a determines that the first predetermined condition is satisfied in the case where placement of a rival character has been decided, and determines that the first predetermined condition is not satisfied in the case where placement of a rival character has not been decided. Also, the first predetermined condition determination process is a process for determining whether or not a specific race is included in the races that can be selected in the current turn. A specific race is a race that allows the aforementioned special item to be earned, for example, when a time-limited event is held. That is, in the first predetermined condition determination process, it is determined whether or not the first predetermined condition is satisfied on the basis of the types of races (sub-commands) that can be selected in the current turn. The nurturing game execution unit 701a determines that the first predetermined condition is satisfied in the case where a specific race is included in the races that can be selected, and determines that the first predetermined condition is not satisfied in the case where no specific races are included in the races.

In the case where the first predetermined condition is not satisfied (NO in P100-1), the nurturing game execution unit 701a hides the rival character report indicator 321 (specific image) and performs control such that the rival character report indicator 321 is not displayed on the display 26 (P100-2).

On the other hand, in the case where the first predetermined condition is satisfied (YES in P100-1), the nurturing game execution unit 701a performs control such that the rival character report indicator 321 (specific image) is displayed on the display 26 (P100-3). More specifically, the nurturing game execution unit 701a executes a process for displaying the rival character report indicator 321 tied to the individual race operation section (specific command) 219 on the basis of the first predetermined condition being satisfied. Here, the nurturing game execution unit 701a decides whether or not to superimpose the rival character report indicator 321 on the individual race operation section 219 on the basis of the lottery result of the rival character lottery process in S10-5 executed in the server 1000 in each of the turns.

In addition, on the basis of the first predetermined condition being satisfied, the nurturing game execution unit 701a executes a process for displaying the rival character report indicator 321 so as to be tied to the individual race selection operation section (sub-command) 261 corresponding to at least one individual race. More specifically, the nurturing game execution unit 701a decides whether or not to display the rival character report indicator 321 for each of the race categories (sub-commands) in the individual race selection operation sections 261 on the basis of parameters (e.g., aptitude parameters related to the racetrack aptitude and the distance aptitude) of the main character.

Also, on the basis of the lottery result of the support character lottery process in S10-2 executed in the server 1000, the nurturing game execution unit 701a displays the lottery result on the display 26 (P100-4). Here, the nurturing game execution unit 701a displays, on the display 26, information concerning a support card (used game medium) tied to each of the training courses (parameter-changing elements) and the result of the granting lottery of a support event (special gift).

Referring back to FIG. 46, when various kinds of commands are selected by the player after the display control process, the nurturing game execution unit 701a transmits command information indicating the selected command to the server 1000 (P10-3).

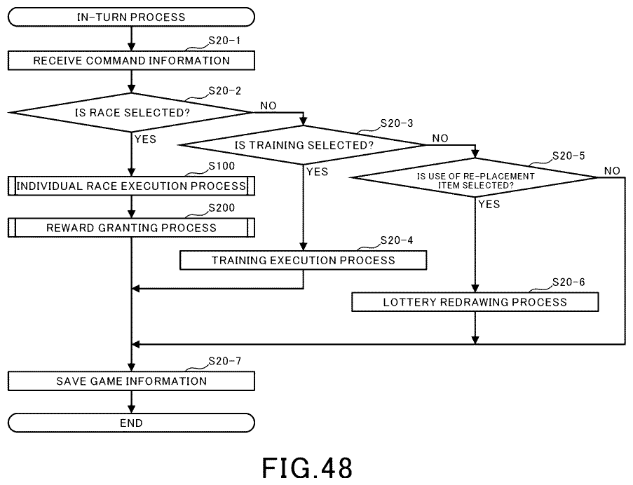

FIG. 48 is a flowchart for illustrating the in-turn process in the server 1000. As shown in FIG. 48, when the command information is transmitted from the player terminal 1, the nurturing game execution unit 1101a receives the transmitted command information (S20-1).

Upon receiving the command information, the nurturing game execution unit 1101a determines whether or not the command of the individual race operation section 219 has been selected by the player (S20-2). When the command of the individual race operation section 219 is selected (YES in S20-2), the nurturing game execution unit 1101a executes an individual race execution process for causing the main character to run in an individual race (predetermined game) (S100).

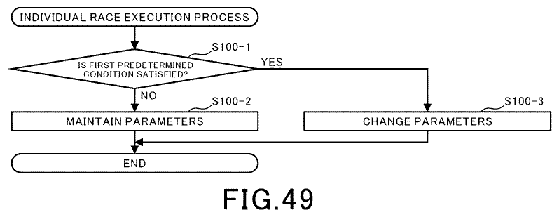

FIG. 49 is a flowchart for illustrating the individual race execution process. As shown in FIG. 49, the nurturing game execution unit 1101a determines whether or not the first predetermined condition is satisfied in the individual race in which the main character is made to run (S100-1). In the case where the first predetermined condition is not satisfied (NO in S100-1), the nurturing game execution unit 1101a executes a process for maintaining the set values of parameters of the NPCs set in the individual race in which the main character is made to run (S100-2).

On the other hand, in the case where the first predetermined condition is satisfied (YES in S100-1), the nurturing game execution unit 1101a executes a process for changing the parameters of an NPC having the same character ID as the rival character among the NPCs set in the individual race in which the main character is made to run (S100-3). For example, the nurturing game execution unit 1101a multiplies the ability parameters of a normal NPC having the same character ID as the rival character by a predetermined number (e.g., 1.1), thereby causing the NPC with the changed parameters to run in the individual race as a rival character. In other words, the nurturing game execution unit 1101a executes an individual race, if not satisfying the first predetermined condition, by using NPCs having default parameters (predetermined parameters), and executes an individual race, if satisfying the first predetermined condition, by using an NPC having changed default parameters.

Referring back to FIG. 48, when the individual race execution process ends, the nurturing game execution unit 1101a executes a reward granting process for granting a reward to the player on the basis of the game result of the individual race (S200).

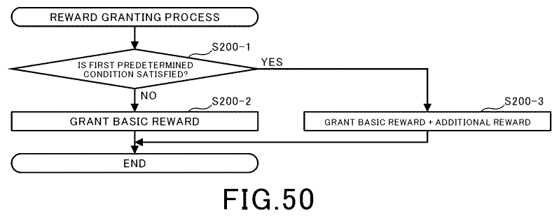

FIG. 50 is a flowchart for illustrating the reward granting process. As shown in FIG. 50, the nurturing game execution unit 1101a determines whether or not the first predetermined condition is satisfied in the individual race in which the main character has been made to run (S200-1). In the case where the first predetermined condition is not satisfied (NO in S200-1), the nurturing game execution unit 1101a grants a basic reward (first reward) to the player (S200-2). A basic reward is a reward that can be obtained by the player, regardless of whether or not the player has won against the rival character.

On the other hand, in the case where the first predetermined condition is satisfied (YES in S200-1), the nurturing game execution unit 1101a grants the player an additional reward (second reward), in addition to the basic reward (S200-3). That is, in the case where an individual race satisfying the first predetermined condition is executed, the player is granted an additional reward on the basis of the game result of the individual race. An additional reward is a reward that can be earned when the main character runs in an individual race in which the main character competes a rival character for a win. Note that an event, such as a second event, may be made to occur as an additional reward, regardless of whether an item has been granted.

Referring back to FIG. 48, in the case where the individual race operation section 219 is not selected (NO in S20-2), the nurturing game execution unit 1101a determines whether or not the command of the training operation section 216 has been selected by the player (S20-3). In the case where the command of the training operation section 216 has been selected (YES in S20-3), the nurturing game execution unit 1101a executes a training execution process (S20-4).

More specifically, the nurturing game execution unit 1101a determines whether or not any of the training courses including the speed operation section 241, the stamina operation section 242, the power operation section 243, the spirit operation section 244, and the wisdom operation section 245 has been selected. The nurturing game execution unit 1101a determines whether or not training has been successful for the selected training course. In the case where training has been successful, the nurturing game execution unit 1101a executes a process for increasing numerical values of, for example, ability parameters of the main character according to the training course. More specifically, in the case of successful training, the nurturing game execution unit 1101a executes a process for increasing the numerical values of ability parameters of the main character on the basis of a support card tied to the training course selected by the player and whether or not a support event has been granted. In addition, in the case of failing training, the nurturing game execution unit 1101a executes a process for decreasing the numerical values of, for example, ability parameters of the main character according to the training course. Thus, the nurturing game execution unit 1101a changes parameters of the main character according to the training course and a determination that the training course is successful.

On the other hand, in the case where the training operation section 216 is not selected (NO in S20-3), the nurturing game execution unit 1101a determines whether or not a command for using a character re-placement item has been selected (S20-5). Here, the nurturing game execution unit 1101a executes a second predetermined condition determination process for determining whether or not a character re-placement item has been used. The nurturing game execution unit 701a determines that a second predetermined condition is satisfied in the case where it is determined that a character re-placement item has been used, and determines that the second predetermined condition is not satisfied in the case where it is determined that no character re-placement items have been used.

In the case where the command for using a character re-placement item has been selected (YES in S20-5), the nurturing game execution unit 1101a executes the lottery redrawing process (S20-6). More specifically, in the case where a character re-placement item has been used, the nurturing game execution unit 1101a executes a process for redrawing a lottery for tying a support card to a training course while maintaining whether or not there is a second event of the support card. More specifically, when a character re-placement item is used, a lottery for selecting one random number is redrawn, and placement of each of the support characters in a training course is decided again on the basis of the redrawn random number and the placement probability table shown in FIG. 27. At this time, if the placement position of a support character in a training course after the lottery is redrawn is the same as the placement position of the support character in a training course before the lottery is redrawn (i.e., placement position decided through the support character lottery process (S10-2)), a lottery for selecting a random number is redrawn again. Then, on the basis of the random number redrawn again and the placement probability table shown in FIG. 27, the placement of the support character in a training course is decided again. This process is repeated until the placement position of the support character in a training course after the lottery is redrawn is different from the placement position of the support character in a training course before the lottery is redrawn (i.e., placement position decided through the support character lottery process (S10-2)). In addition, when a character re-placement item is used, a lottery for selecting whether or not to cause a second event to occur is redrawn on the basis of the random number selected by lottery through the second event occurrence/non-occurrence decision process (S10-4) and the second event table. Here, because a lottery is redrawn on the basis of the same random number as the one used in the second event occurrence/non-occurrence decision process (S10-4) and the same second event table, the second event for which a lottery is redrawn after the character re-placement item is used has the same result as the second event the occurrence of which has been decided through the second event occurrence/non-occurrence decision process (S10-4). On the other hand, in the case where commands other than the individual race operation section 219, the training operation section 216, and the use of the character re-placement item are selected (NO in S20-5), various processes corresponding to the commands are executed, though a detailed description is omitted.

Also, the nurturing game execution unit 1101a saves, in the game information storage section 1151, game information including information concerning the race result of the individual race execution process executed in S100, information concerning the reward result of the reward granting process executed in S200, information concerning the training result executed in S20-4, information concerning the result of the second predetermined condition determination process executed in S20-5, and information concerning the lottery redrawing result of the lottery redrawing process executed in S20-6 so as to allow the player terminal 1 to receive the game information (S20-7).

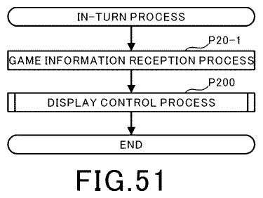

FIG. 51 is a flowchart for illustrating the in-turn process in the player terminal 1. As shown in FIG. 51, first the nurturing game execution unit 701a accesses the game information storage section 1151 of the server 1000 and receives, from the server 1000, game information including information concerning the race result, the reward result, the training result, the second predetermined condition determination result, and the lottery redrawing result (P20-1).

After receiving the game information, the nurturing game execution unit 701a executes the display control process (P200).

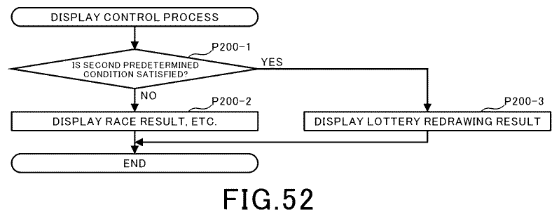

FIG. 52 is a flowchart for illustrating the display control process. As shown in FIG. 52, the nurturing game execution unit 701a determines whether or not the second predetermined condition is satisfied (P200-1). In the case where the second predetermined condition is not satisfied (NO in P200-1), the nurturing game execution unit 701a displays, on the display 26, the race result, the reward result, the training result, etc. on the basis of the results of the individual race execution process in S100, the training execution process in S20-4, and other various processes executed in the server 1000 (P200-2).

On the other hand, in the case where the second predetermined condition is satisfied (YES in P200-1), the nurturing game execution unit 701a displays the lottery redrawing result on the display 26 on the basis of the lottery result of the lottery redrawing process in S20-6 executed in the server 1000 (P200-3). More specifically, the nurturing game execution unit 701a displays, on the display 26, information concerning a support card tied to each of the training courses and whether or not to cause a support event tied to the support card to occur.

Referring back to FIG. 42, when the aforementioned nurturing-stage process ends, the nurturing game execution unit 701a executes the nurturing game end process (P8) in the player terminal 1. In the nurturing game end process, the nurturing game execution unit 701a stores, in the game information storage section 751, information concerning the nurtured character nurtured in the nurturing game. In addition, the nurturing game execution unit 701a transmits end information to the server 1000. This end information contains information concerning the nurtured character, etc. At the server 1000, upon receiving the end information, the nurturing game end processing unit 1102a executes the nurturing game end process (S8).

The aforementioned nurturing game is realized through these processes. Note that the aforementioned processes in the player terminal 1 and the server 1000 are merely examples. Also, each of the aforementioned processes may be executed only in the player terminal 1 or may be executed only in the server 1000.

### <Strengthening Process>

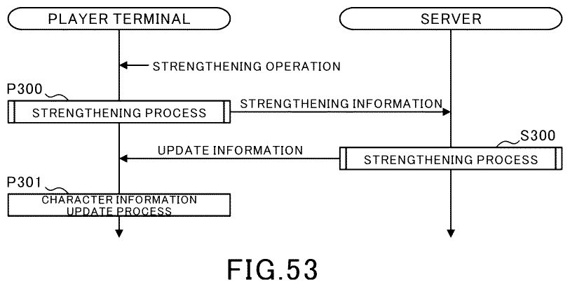

FIG. 53 is a sequence diagram for illustrating processes related to strengthening of a character executed in the player terminal 1 and the server 1000. When a strengthening operation for strengthening a character level, a status level, or a hint level (operation on the character level strengthening confirmation screen, the status level strengthening confirmation screen, and the final confirmation screen) is input, the strengthening process (P300) is executed in the player terminal 1.

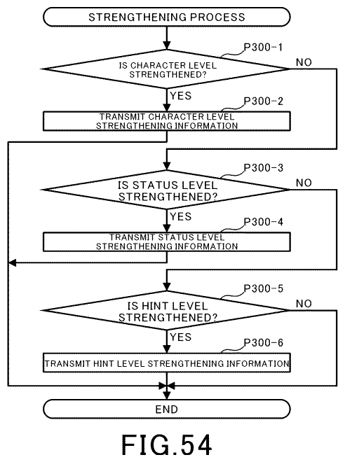

FIG. 54 is a flowchart for illustrating the strengthening process in the player terminal 1. When a strengthening operation is input, the character strengthening unit 703a determines whether or not the input strengthening operation is an operation for requesting strengthening of the character level (P300-1). When an operation for requesting strengthening of the character level is input (YES in P300-1), the character strengthening unit 703a transmits character level strengthening information to the server 1000 (P300-2).

In addition, when a strengthening operation for requesting strengthening of the status level is input (YES in P300-3), the character strengthening unit 703a transmits status level strengthening information to the server 1000 (P300-4).

Also, when a strengthening operation for requesting strengthening of a hint level is input (YES in P300-5), the character strengthening unit 703a transmits hint level strengthening information to the server 1000 (P300-6).

Referring back to FIG. 53, upon receiving strengthening information (character level strengthening information, status level strengthening information, or hint level strengthening information), the strengthening process (S300) is executed in the server 1000.

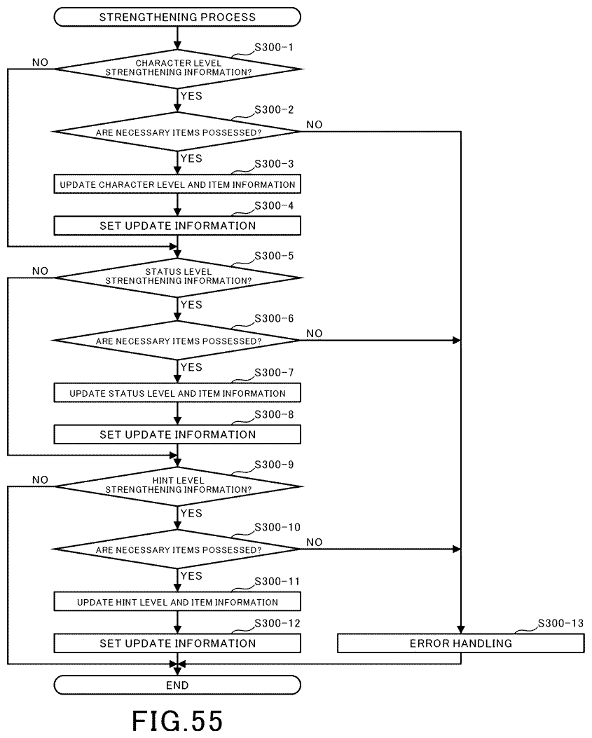

FIG. 55 is a flowchart for illustrating the strengthening process in the server 1000. Upon receiving the character level strengthening information (YES in S300-1), the character strengthening unit 1103a determines whether or not character level strengthening items needed to strengthen the character level are possessed (S300-2). In the case where necessary character level strengthening items are possessed (YES in S300-2), the character strengthening unit 1103a updates the player information stored in the player information storage section 1150 (S300-3). Here, the character level of the character and the number of character level strengthening items possessed by the player are updated. In addition, the character strengthening unit 1103a sets update information indicating the player information updated in S300-3 such that the player terminal 1 can receive the update information (S300-4).

Also, upon receiving the status level strengthening information (YES in S300-5), the character strengthening unit 1103a determines whether or not status level strengthening items needed to strengthen the status level are possessed (S300-6). In the case where necessary status level strengthening items are possessed (YES in S300-6), the character strengthening unit 1103a updates the player information stored in the player information storage section 1150 (S300-7). Here, the status level of the character and the number of status level strengthening items possessed by the player are updated. In addition, the character strengthening unit 1103a sets update information indicating the player information updated in S300-7 such that the player terminal 1 can receive the update information (S300-8).

Also, upon receiving the hint level strengthening information (YES in S300-9), the character strengthening unit 1103a determines whether or not hint level strengthening items needed to strengthen a hint level are possessed (S300-10). In the case where necessary hint level strengthening items are possessed (YES in S300-10), the character strengthening unit 1103a updates the player information stored in the player information storage section 1150 (S300-11). Here, the hint level of the character and the number of hint level strengthening items possessed by the player are updated. Also, the character strengthening unit 1103a sets update information indicating the player information updated in S300-11 such that the player terminal 1 can receive the update information (S300-12).

Note that the number of various kinds of items possessed by the player are synchronized between the player terminal 1 and the server 1000. If the necessary number of items are not possessed, the strengthening operation is not accepted in the player terminal 1. Therefore, transmission of strengthening information from the player terminal 1 to the server 1000, despite the necessary number of items not being possessed, does not occur. It should be noted, however, that in the event of a communication failure or the like between the player terminal 1 and the server 1000, there may occur a discrepancy between the player information stored in the player information storage section 750 of the player terminal 1 and the player information stored in the player information storage section 1150 of the server 1000.

If no necessary items are possessed when strengthening information is received (NO in S300-2, NO in S300-6, and NO in S300-10), the character strengthening unit 1103a executes error handling without updating the player information (S300-13).

Referring back to FIG. 53, when the player terminal 1 receives the update information, the character strengthening unit 703a updates the player information in the player information storage section 750. By doing so, the updated character level, status level, and the hint level of each possessed skill of the character are maintained both in the player terminal 1 and the server 1000 as statuses of the character.

As described above, according to this embodiment, the player can strengthen, outside the nurturing game, the hint level tied to a possessed skill of the character. By strengthening a hint level outside the nurturing game, the player can start a nurturing game with the strengthened hint level. By doing so, when a possessed skill is to be earned during the nurturing game, the necessary consumption value of skill points is reduced. Consequently, the player is more readily to select a support card for purposes other than, for example, a hint event, which increases the degrees of freedom in selecting a support card. As a result, it is possible to nurture a nurtured character having various abilities, thereby further motivating the player to play a game.

Although an aspect of an embodiment has been described with reference to the accompanying drawings, it goes without saying that the present invention is not limited to the aforementioned embodiment. It would be obvious that a person skilled in the art could conceive of various modifications and amendments within the scope recited in the claims, and it will be understood that those modifications and amendments obviously belong to the technical scope.

The gameplay and the processes in the player terminal 1 and the server 1000 described in the aforementioned embodiment are merely examples. In any case, an information processing program is acceptable if it causes a computer (at least one of the player terminal 1 and server 1000 in the embodiment) to execute the following processes.

### (Processes Executed by Computer)

Process (e.g., P6 or S6 in the embodiment) for setting, as a character to be nurtured, a character selected by a player from among at least one character tied to ability information (e.g., skill in the embodiment) that can be earned by consuming points (e.g., skill points in the embodiment) and initial-consumption-point information (e.g., hint level in the embodiment) indicating a consumption value of the points for earning the ability information.

Process (e.g., P7 or S7 in the embodiment) for executing a nurturing game, said process including a process for changing a parameter (e.g., ability parameter, aptitude parameter, or skill in the embodiment) of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured.

Process (e.g., P300 or S300 in the embodiment) for updating the initial-consumption-point information tied to the character when a specific condition (use of a hint level strengthening item) set in advance is satisfied outside the nurturing game so that the consumption value of the points needed to earn the ability information is smaller than before the specific condition is satisfied.

Note that the aforementioned embodiment has been described by way of an example of the ability information where a skill is earned by consuming skill points. It should be noted, however, that the ability information is not limited to a skill. For example, the ability information may be the initial value of an ability parameter, such as speed and stamina, tied to the character.

In addition, the aforementioned embodiment has been described by way of an example of the specific condition where the consumption value of points needed to earn the ability information becomes smaller as a result of a hint level strengthening item being used. That is, the aforementioned embodiment has been described by way of an example where the process for executing a nurturing game includes a process for granting a specific item (hint level strengthening item), and the specific condition is the use of the specific item. It should be noted, however, that the specific condition is not limited to the use of a specific item.

For example, in the case where the player can possess a character that has been won in a lottery, the specific condition may be such that the number of identical possessed characters is a predetermined number or more and that the identical characters are used as materials. In this case, when the specific condition is satisfied, the hint levels of, for example, all the possessed skills may be increased together, or alternatively, the player may be able to select a possessed skill the hint level of which is to be strengthened.

In addition, in the aforementioned embodiment, the hint level of a predetermined possessed skill may be strengthened as a result of, for example, the character level or the status level being strengthened. Moreover, the specific condition may be such that the number of times the nurturing game has been executed with a character as the main character or the number of nurtured characters that have been created is a predetermined number or more.

Also, in the aforementioned embodiment, a process (e.g., S300-7 in the embodiment) for increasing the ability information that is tied to the character and that can be earned by consuming the points is executed when a predetermined condition (e.g., use of a status level strengthening item in the embodiment) different from the specific condition is satisfied outside the nurturing game. It should be noted, however, that the function for strengthening the character level and the status level is not essential in the aforementioned embodiment.

Note that the information processing program for executing the processes in the aforementioned embodiment and various modifications may be stored in a computer-readable, non-transitory storage medium and may be provided as a storage medium. Furthermore, it is also acceptable to provide a game terminal device including this storage medium. In addition, the aforementioned embodiment and various modifications may also be an information processing method that realizes each of the functions and the steps shown in the flowcharts.

What is claimed is:

1. A non-transitory computer readable medium storing a program for causing a computer to execute:
a process for setting, as a character to be nurtured, a character selected by a player from among at least one character tied to ability information that can be earned by consuming points and initial-consumption-point information indicating a consumption value of the points for earning the ability information;
a process for executing a nurturing game, including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.

2. The non-transitory computer readable medium according to claim 1,
wherein, in the process for updating the initial-consumption-point information, the updated initial-consumption-point information is maintained as a status of the character.

3. The non-transitory computer readable medium according to claim 1,
wherein the process for executing a nurturing game includes a process for granting a specific item, and the specific condition is the use of the specific item.

4. The non-transitory computer readable medium according to claim 1, the program further causing the computer to execute:
a process for increasing the ability information that is tied to the character and that can be earned by consuming the points when a predetermined condition different from the specific condition is satisfied outside the nurturing game.

5. An information processing method executed by at least one computer, the at least one computer executing:
a process for setting, as a character to be nurtured, a character selected by a player from among at least one character tied to ability information that can be earned by consuming points and initial-consumption-point information indicating a consumption value of the points for earning the ability information;
a process for executing a nurturing game, including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.

6. An information processing system comprising at least one computer, the at least one computer executing:
a process for setting, as a character to be nurtured, a character selected by a player from among at least one character tied to ability information that can be earned by consuming points and initial-consumption-point information indicating a consumption value of the points for earning the ability information;
a process for executing a nurturing game, including a process for changing a parameter of the character to be nurtured on the basis of an operation performed by the player, a process for granting the points during the nurturing game, and a process for allowing earning of the ability information tied to the character to be nurtured by consuming the granted points on the basis of the initial-consumption-point information tied to the character to be nurtured; and
a process for updating the initial-consumption-point information tied to the character when a specific condition set in advance is satisfied outside the nurturing game so that the consumption value of the points needed to earn the ability information is smaller than before the specific condition is satisfied.
